(19) United States
(12) Patent Application Publication
(10) Pub. No.: US 2022/0241804 A1
(43) Pub. Date: Aug. 4, 2022

(54) LIQUID SPRAY SYSTEM

(71) Applicant: Graco Minnesota Inc., Minneapolis, MN (US)

(72) Inventors: Todd A. Anderson, Annandale, MN (US); Jacob K. Krech, Andover, MN (US)

(21) Appl. No.: 17/594,757

(22) PCT Filed: May 1, 2020
(86) PCT No.: PCT/US2020/030996

§ 371 Date: Oct. 28, 2021

Related U.S. Application Data
(60) Provisional application No. 62/842,884, filed on May 3, 2019.

(51) Int. Cl. B05B 5/16; B05B 12/00

(52) U.S. Cl. CPC B05B 5/1641; B05B 12/006; B05B 5/1666; B05B 5/1633

(57) ABSTRACT

An electrostatic spray system (10) includes a supply module (14) configured to store a supply of charged liquid for spraying by an electrostatic sprayer (26). A feed module (12) is connected to the supply module to fill the supply tank (44) of the supply module as needed during spraying to provide a continuous supply of liquid for the electrostatic sprayer. The feed module is controlled such that the feed module is electrically isolated from a main reservoir (18) connected to earth ground potential when the feed module is providing liquid to the supply module, and the feed module is electrically isolated from the supply module when the feed module is receiving liquid from the main reservoir. The feed module transfers the liquid from the main reservoir to the supply module without electrically connecting the supply module to the main reservoir (18).

### CROSS-REFERENCE TO RELATED APPLICATION(S)

This application claims the benefit of U.S. Provisional Application No. 62/842,884 filed May 3, 2019 for “ELECTROSTATIC SPRAY SYSTEM,” the disclosure of which is hereby incorporated in its entirety.

### BACKGROUND

This disclosure relates to fluid spraying. More particularly, this disclosure relates to electrostatic spraying.

Electrostatic sprayers are used to spray a charged liquid, such as paint or water, onto a grounded object. The liquid is atomized as it is ejected from the spray gun and is charged as it moves past an electrode of the spray gun. The charged liquid is attached to the grounded object that the liquid is sprayed onto, thereby providing a more even coating to the object.

Water-based liquids, such as paints, can create a conduction path between the spray gun and the main fluid supply. However, because the main fluid supply is grounded, the spray gun and charged fluid must be isolated from that main fluid supply. As such, the supply tank directly connected to the spray gun must be electrically isolated from the main fluid supply. To refill the supply tank with additional fluid the user shuts down the electrostatic sprayer and discharges any charge prior to accessing the supply tank. The user then refills the supply tank and restarts the spraying system to resume electrostatic spraying.

### SUMMARY

According to one aspect of the disclosure, a liquid supply system configured to provide a continuous supply of charged liquid to a downstream location and receive a supply of liquid from a grounded liquid source includes a feed module configured to store a supply of liquid and a supply module configured to receive the liquid from the feed module. The supply module is configured to output a continuous flow of charged liquid. The liquid supply system is configured to transition between a fill state and a supply state. The feed module is electrically connected to a grounded liquid source and electrically isolated from the supply module with the liquid supply system is in the fill state. The feed module is electrically connected to the supply module and electrically isolated from the grounded liquid source with the liquid supply system in the supply state.

According to another aspect of the present disclosure, a method of providing a continuous fluid supply for electrostatic spraying includes transitioning a liquid supply system from a supply state to a fill state based on a first signal generated by a status sensor associated with a feed reservoir of the feed module, filling the feed reservoir with liquid from the liquid source, and transitioning from the fill state to the supply state based on a second signal generated by the status sensor; providing liquid to the supply reservoir from the feed reservoir while in the supply state; and providing charged liquid downstream from the supply reservoir both while in the fill state and the supply state. Transitioning from the supply state to the fill state includes generating a downstream air gap between the feed reservoir and a supply reservoir of a supply module, thereby breaking a conduction path therebetween and stopping liquid flow therebetween; and removing an upstream air gap between the feed reservoir and the grounded liquid source, forming a conduction path therebetween and allowing liquid flow therebetween. Transitioning from the fill state to the supply state includes generating the upstream air gap between the feed reservoir and the liquid source, thereby breaking the conduction path therebetween and stopping liquid flow therebetween; and removing the downstream air gap between the feed reservoir and the supply reservoir, thereby forming a conduction path therebetween and allowing liquid flow therebetween.

According to yet another aspect of the disclosure, a fluid supply system for an electrostatic spray system includes a feed module, a supply module, a feed line extending therebetween, and control circuitry. The feed module includes a storage tank; an inlet line extending from a supply valve to the storage tank; a feed valve configured to control liquid flow from the storage tank; and a first level sensor configured to generate storage level information regarding a liquid level in the storage tank. The supply module includes a supply tank; a second level sensor configured to generate supply level data regarding a liquid level in the supply tank. The feed line extends from the feed valve to the supply tank. The control circuitry is configured to initiate a fill cycle based on the supply level data from the second level sensor and further configured to initiate a refill cycle. The supply module is electrically isolated from the feed module during the refill cycle, and wherein the supply module is electrically connected to the feed module during the fill cycle.

According to yet another aspect of the disclosure, an electrostatic spray system includes an electrically grounded liquid reservoir; one or more electrostatic spray guns configured to spray charged liquid onto a surface; a fluid isolation system configured to transfer fluid from the liquid reservoir to the electrostatic spray gun; and control circuitry. The fluid isolation system includes a feed module connected to the liquid reservoir by a reservoir line and a supply module connected to the feed module by a feed line. The feed module includes a supply valve disposed at a junction of the reservoir line and an inlet line; a storage tank connected to the inlet line to receive liquid; a feed valve configured to control liquid flow from the storage tank to the feed line; and a first level sensor configured to generate feed level data regarding a liquid level in the storage tank. The supply module includes a supply tank connected to the feed line to receive liquid from the feed line; and a second level sensor configured to generate supply level data regarding a liquid level in the supply tank. The control circuitry is configured to: initiate a fill cycle based on the supply level data by opening the feed valve and allow liquid to flow from the storage tank to the supply tank through the feed valve, thereby creating a conduction path and charging the liquid in the feed module; stop the fill cycle by closing the feed valve, thereby generating an air gap in the feed line; initiate a refill cycle by opening the supply valve to allow liquid to flow to the storage tank from the reservoir, thereby creating a conduction path between the storage tank and the reservoir; and stop the refill cycle based on the feed level data by closing the supply valve, thereby generating an air gap in the feed line.

According to yet another aspect of the present disclosure, a method of providing a continuous fluid supply for electrostatic spraying includes initiating, via control circuitry, a fill cycle of a storage tank of a feed module based on supply level data from a first level sensor of the storage tank by opening a feed valve to allow liquid to flow from the storage tank to a feed hose extending to a supply tank of a supply module, thereby creating a conduction path between charged liquid in the supply module and the liquid in the feed module; stopping, via the control circuitry, the fill cycle based on the supply level data by closing the feed valve, thereby generating an air gap in the feed line; initiating, via the control circuitry, a refill cycle by opening a supply valve of the feed module to allow liquid to flow into the storage tank from an electrically grounded reservoir, thereby creating a conduction path between the storage tank and the reservoir; and stopping, via the control circuitry, the refill cycle based on feed level data from a second level sensor of the storage tank by closing the supply valve, thereby generating an air gap in the feed line. The control circuitry controls actuation of the feed valve and the supply valve such that the storage module is electrically isolated from the electrically grounded reservoir throughout both the fill cycle and the refill cycle.

According to yet another aspect of the disclosure, a fluid supply system for an electrostatic spray system includes a first supply module configured to receive liquid from a main reservoir and provide the liquid to an electrostatic sprayer and a second supply module configured to receive liquid from the main reservoir and provide the liquid to the electrostatic sprayer. The first supply module includes a first fill line extending from a reservoir line to a first isolation pump; a first inlet valve disposed between the reservoir line and the first fill line, the first inlet valve configured to control flow from the reservoir line into the first fill line; a first vent valve fluidly connected to the first fill line; a first feed valve disposed downstream of the first isolation pump; a first feed line extending from the first feed valve to a first spray valve; a first gap controller fluidly connected to the first fill line at a location upstream of the first isolation pump; a second gap controller fluidly connected to the first feed line at a location upstream of the first spray valve; and a second vent valve fluidly connected to the first feed line. The second supply module includes a second fill line extending from the reservoir line to a second isolation pump; a second inlet valve disposed between the reservoir line and the second fill line, the second inlet valve configured to control flow from the reservoir line into the second fill line; a third vent valve fluidly connected to the second fill line; a second feed valve disposed downstream of the second isolation pump; a second feed line extending from the second feed valve to a second spray valve; a third gap controller fluidly connected to the second fill line at a location upstream of the second isolation pump; a fourth gap controller fluidly connected to the second feed line at a location upstream of the second spray valve; and a fourth vent valve fluidly connected to the first feed line. Control circuitry is configured to control formation of air gaps in the first feed line, the second feed line, the first fill line, and the second fill line to electrically isolate the main reservoir and the electrostatic sprayer, and wherein at least one of the first isolation pump and the second isolation pump is electrically connected to the electrostatic sprayer.

### BRIEF DESCRIPTION OF THE DRAWINGS

FIG. 1 is a schematic diagram of an electrostatic spray system.

FIG. 2 is a schematic diagram of a feed module of an electrostatic spray system.

FIG. 3 is a schematic diagram of a supply module of an electrostatic spray system.

FIG. 4A is a schematic diagram of an electrostatic spray system in a first state.

FIG. 4B is a schematic diagram of an electrostatic spray system in a second state.

FIG. 4C is a schematic diagram of an electrostatic spray system in a third state.

FIG. 4D is a schematic diagram of an electrostatic spray system in a fourth state.

FIG. 4E is a schematic diagram of an electrostatic spray system in a fifth state.

FIG. 4F is a schematic diagram of an electrostatic spray system in a sixth state.

FIG. 4G is a schematic diagram of an electrostatic spray system in a seventh state.

FIG. 4H is a schematic diagram of an electrostatic spray system in an eighth state.

FIG. 4I is a schematic diagram of an electrostatic spray system in a ninth state.

FIG. 4J is a schematic diagram of an electrostatic spray system in a tenth state.

FIG. 4K is a schematic diagram of an electrostatic spray system in an eleventh state.

FIG. 4L is a schematic diagram of an electrostatic spray system in a twelfth state.

FIG. 5A is an isometric view of an isolation pump.

FIG. 5B is a cross-sectional view of the isolation pump shown in FIG. 5A taken along line B-B in FIG. 5A.

FIG. 6 is a cross-sectional view of a gap controller.

FIG. 7A is a schematic diagram of an electrostatic spray system in a supply state.

FIG. 7B is a schematic diagram of an electrostatic spray system in a fill state.

FIG. 8 is a cross-sectional view of a feed pump.

FIG. 9 is a cross-sectional view of a supply assembly.

FIG. 10A is a cross-sectional view of a pneumatic sensor in a first position.

FIG. 10B is a cross-sectional view of the pneumatic sensor in a second position.

FIG. 11 is a diagram of a pneumatic control circuit.

### DETAILED DESCRIPTION

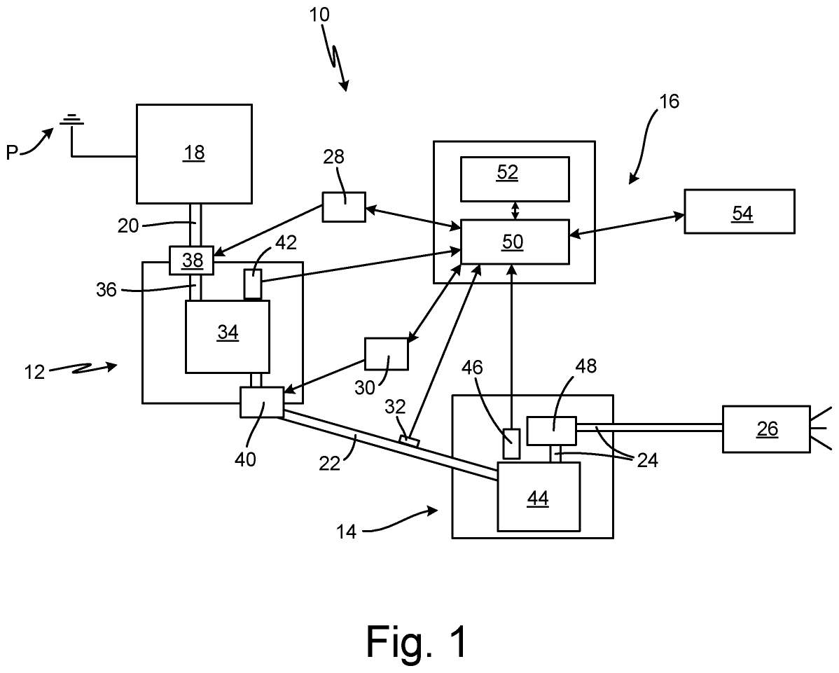

FIG. 1 is a schematic diagram of electrostatic spray system 10. Electrostatic spray system 10 includes feed module 12, supply module 14, control module 16, main reservoir 18, reservoir line 20, feed line 22, supply line 24, electrostatic sprayer 26, actuator 28, actuator 30, and feed line sensor 32. Feed module 12 includes storage tank 34, inlet line 36, inlet valve 38, feed valve 40, and level sensor 42. Supply module 14 includes supply tank 44, level sensor 46, and pump 48. Control module 16 includes control circuitry 50, memory 52, and user interface 54.

Electrostatic spray system 10 is configured to atomize and spray a liquid, such as water and water-based coatings, and charge the liquid droplets to a desired potential. For example, electrostatic spray system 10 can be configured to spray with a 60 kV charge. The charged droplets are directed towards an object to coat the object with the droplets. Electrostatic spray system 10 provides a continuous supply of the liquid to electrostatic sprayer 26 for application while isolating the liquid in main reservoir 18 from the liquid being sprayed to prevent shorting to earth ground.

In some examples, electrostatic spray system 10 can be utilized for spray chilling, where charged droplets are sprayed onto an object in a cooled environment to accelerate cooling of the object. For example, electrostatic spray system 10 can be utilized to rapidly cool foodstuffs during processing. For example, the spray chilling system can rapidly cool a meat carcass after the animal is harvested/slaughtered. The spray chilling system conveys foodstuff through chilling tunnel in and reduces the core temperature of the foodstuff via a chilled air flow and charged fluid sprays. The fluid can be of any type suitable for spraying onto foodstuffs during processing, such as water or water-based solutions such as a solution of sodium chloride or other allowed additives in water. The spray chilling system can include multiple ones of electrostatic spray system 10 arranged along the travel path of the foodstuff through the cooling tunnel. Each one of electrostatic spray system 10 can supply spray fluid to one or more electrostatic sprayers 26 within the spray chilling system. The spray chilling system can be configured to simultaneously chill multiple foodstuffs, such as multiple carcasses.

Main reservoir 18 stores a bulk supply of the liquid for application by electrostatic spray system 10. Main reservoir 18 is connected to earth ground potential P. Reservoir line 20 extends from main reservoir 18 to feed module 12 to provide liquid from main reservoir 18 to feed module 12. Feed module 12 is configured to store a refill supply of liquid that can be provided to supply module 14 as needed to maintain the supply of liquid in supply module 14. Feed line 22 extends between feed module 12 and supply module 14 to provide the liquid to supply module 14 from feed module 12. Supply line 24 extends from supply module 14 to electrostatic sprayer 26 to provide the spray liquid to electrostatic sprayer 26 from supply module 14 during spraying. Because the spray liquid is charged, the liquid in supply module 14 is also charged due to the conductive nature of the liquid. Feed module 12, supply module 14, and feed line 22 form a fluid isolation system that provides a continuous supply of charged liquid to electrostatic sprayer 26.

Feed module 12 includes a non-conductive enclosure to isolate components of feed module 12 from earth ground. Inlet valve 38 is disposed between reservoir line 20 and inlet line 36. Inlet valve 38 is controllable between an open state, where liquid from main reservoir 18 can flow through inlet valve 38 into feed module 12 from main reservoir 18, and a closed state, where inlet valve 38 prevents the liquid from main reservoir 18 from entering feed module 12. Inlet line 36 extends from inlet valve 38 to storage tank 34 to provide the liquid from reservoir to storage tank 34. Storage tank 34 can be considered to form a feed reservoir. Inlet line 36 provides a static connection between inlet valve 38 and storage tank 34, as inlet line 36 is connected to each of inlet valve 38 and storage tank 34 during both a fill cycle and a refill cycle, as discussed in further detail below.

Level sensor 42 is configured to sense the liquid level in storage tank 34 and to provide the storage level data regarding that liquid level to control module 16. Level sensor 42 can take the form of any configuration suitable for generating data regarding the amount of liquid remaining within storage tank 34. For example, level sensor 42 can be an ultrasonic level sensor, a fiber optic level sensor, a scale configured to weigh storage tank 34, a float in storage tank 34, or can be of any other form suitable for generating data regarding the amount of liquid remaining in storage tank 34. Level sensor 42 can also be referred to as a status sensor as level sensor 42 can indicate a status of feed module 12.

Level sensor 42 is electrically isolated from the liquid flowing through electrostatic spray system 10. As such, level sensor 42 is configured to not provide a path to earth ground. In examples where level sensor 42 is an ultrasonic level sensor, level sensor 42 can be mounted on a non-conductive extension projecting from supply tank 44 to electrically isolate the ultrasonic level sensor from the liquid. The ultrasonic level sensor is electrically isolated by the air gap between the sensor and the liquid. In examples where level sensor 42 includes fiber optic sensors, control module 16 can include one or more optical amplifiers. In examples where level sensor 42 is mechanical, such as a float or scale, level sensor 42 can include non-conductive components, such as a plastic scale plate or a plastic float.

Feed valve 40 is disposed at the outlet of feed module 12 and is controllable between an open state and a closed state. Feed line 22 extends from feed valve 40 to supply module 14. With feed valve 40 in the open state, the liquid can flow out of feed module 12 to feed line 22 and downstream through feed line 22 to supply module 14. With feed valve 40 in the closed state, the liquid is prevented from exiting feed module 12 and is retained in storage tank 34. Feed line 22 provides a static connection between feed valve 40 and supply tank 44, as feed line 22 is connected to each of feed valve 40 and supply tank 44 during both a fill cycle and a refill cycle, as discussed in further detail below.

Feed line sensor 32 is disposed on feed line 22 and is configured to generate feed flow data regarding any liquid within feed line 22. For example, feed line sensor 32 can be configured to provide one or more of a flow rate, a flow status (such as whether liquid is currently flowing in feed line 22), and/or a liquid status (such as whether liquid is currently present in feed line 22), among other options. In one example, feed line sensor 32 is a fiber optic sensor mounted to feed line 22. Feed line 22 can be made from a suitably transparent material to facilitate external mounting of a fiber optic sensor on feed line 22. It is understood, however, that feed line sensor 32 can be of any type suitable for generating feed flow data regarding the liquid in feed line 22. Feed line sensor 32 can provide the feed flow data to control module 16.

Supply module 14 includes a non-conductive housing to isolate the various components of supply module 14 from earth ground potential. Feed line 22 extends into supply module 14 to supply tank 44 of supply module 14. Supply tank 44 is configured to store a supply of the liquid for spraying by electrostatic sprayer 26. Supply tank 44 can be considered to for a supply reservoir. The liquid in supply module 14 is charged for spraying by electrostatic sprayer 26. It is understood that the liquid can be charged to the desired spray potential in any desired manner. In some examples, the liquid can be charged by an electrode of electrostatic sprayer 26. In other examples, the liquid can be charged at supply tank 44.

Level sensor 46 is configured to sense the liquid level in supply tank 44 and to generate supply level data regarding that liquid level. Level sensor 46 can communicate that supply level information to control module 16. Level sensor 46 can take the form of any configuration suitable for generating data regarding the amount of liquid remaining within supply tank 44. For example, level sensor 46 can be an ultrasonic level sensor, can be a fiber optic level sensor, can be a scale configured to weigh supply tank 44, can be a mechanical float, or can be of any other form suitable for generating data regarding the amount of liquid remaining in supply tank 44. Level sensor 46 can also be referred to as a status sensor as level sensor 46 generates data regarding a status of supply module 14. Similar to level sensor 42, level sensor 46 is electrically isolated from the liquid flowing through electrostatic spray system 10. As such, level sensor 46 is configured to not provide a path to earth ground.

Supply line 24 extends from supply tank 44 out of feed module 12 and to electrostatic sprayer 26. Pump 48 is disposed on supply line 24 and is configured to pump the liquid from supply tank 44 to electrostatic sprayer 26 under pressure.

Control module 16 is configured to control the flow of liquid between main reservoir 18 and supply module 14 during spraying to provide a continuous supply of liquid for spraying by electrostatic sprayer 26 while electrically isolating supply module 14 from main reservoir 18. Control circuitry 50 can include one or more processors, configured to implement functionality and/or process instructions. For example, control circuitry 50 can be capable of processing instructions stored in memory 52. Examples of control circuitry 50 can include any one or more of a microprocessor, a controller, a digital signal processor (DSP), an application specific integrated circuit (ASIC), a field-programmable gate array (FPGA), or other equivalent discrete or integrated logic circuitry.

In some examples, control circuitry 50 can include communications circuitry configured to facilitate wired or wireless communications by control module 16. For example, the communications circuitry can facilitate radio frequency communications and/or can facilitate communications over a network, such as a local area network, wide area network, and/or the Internet.

Memory 52, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 52 is a temporary memory, meaning that a primary purpose of memory 52 is not long-term storage. Memory 52, in some examples, is described as volatile memory, meaning that memory 52 does not maintain stored contents when power to control module 16 is turned off. Examples of volatile memories can include random access memories (RAM), dynamic random access memories (DRAM), static random access memories (SRAM), and other forms of volatile memories. In some examples, memory 52 is used to store program instructions for execution by control circuitry 50. For example, memory 52 can store instructions that, when executed by control circuitry 50, cause control module 16 to open and close inlet valve 38 and feed valve 40 to provide the continuous supply of liquid for spraying. Memory 52, in one example, is used by software or applications running on control circuitry 50 to temporarily store information during program execution.

Memory 52, in some examples, also includes one or more computer-readable storage media. Memory 52 can be configured to store larger amounts of information than volatile memory. Memory 52 can further be configured for long-term storage of information. In some examples, memory 52 includes non-volatile storage elements. For example, memory 52 can include non-volatile storage elements such as flash memories or forms of electrically programmable memories (EPROM) or electrically erasable and programmable (EEPROM) memories.

User interface 54 can be any graphical and/or mechanical interface that enables user interaction with electrostatic spray system 10. For example, user interface 54 can implement a graphical user interface displayed at a display device of user interface 54 for presenting information to and/or receiving input from a user. User interface 54 can include graphical navigation and control elements, such as graphical buttons or other graphical control elements presented at the display device. User interface 54, in some examples, includes physical navigation and control elements, such as physically-actuated buttons or other physical navigation and control elements. In general, user interface 54 can include any input and/or output devices and control elements that can enable user interaction with electrostatic spray system 10.

Actuator 28 is connected to inlet valve 38 to control actuation of inlet valve 38. In some examples, actuator 28 is a solenoid actuator configured to direct compressed air to inlet valve 38 to actuate inlet valve 38 between the respective open and closed states. As such, inlet valve 38 can be a pneumatically-operated valve. It is understood, however, that actuator 28 can be of any configuration suitable for actuating inlet valve 38.

Actuator 30 is connected to feed valve 40 to control actuation of feed valve 40. In some examples, actuator 30 is a solenoid actuator configured to direct compressed air to feed valve 40 to actuate feed valve 40 between the respective open and closed states. As such, feed valve 40b can be a pneumatically-operated valve. It is understood, however, that actuator 30 can be of any configuration suitable for actuating feed valve 40.

During operation, the user activates electrostatic spray system 10. Initially, supply tank 44 is filled with an initial supply of liquid for spraying. The liquid is charged to the desired spray potential. The liquid can be charged in any desired manner, such as by an electrode of electrostatic sprayer 26 or at supply tank 44. The charged liquid is pumped to electrostatic sprayer 26 through supply line 24 by pump 48. The charged liquid is sprayed on the desired surface by electrostatic sprayer 26.

As the liquid is being applied, level sensor 46 monitors the liquid remaining in supply tank 44. Level sensor 46 generates and provides supply level data to control module 16. Control module 16 is configured to initiate a fill cycle when the liquid level in supply tank reaches a refill level. Control module 16 can compare the supply level indicated by the supply level data to the refill level to determine when to initiate the fill cycle.

Feed module 12 is in a rest state prior to control module 16 initiating the fill cycle. In the rest state, supply tank 44 is filled with liquid and each of inlet valve 38 and feed valve 40 are in the closed state. Feed module 12 is electrically isolated from main reservoir 18 by a first air gap disposed in inlet line 36 between the liquid in storage tank 34 and inlet valve 38. Feed module 12 is electrically isolated from supply module 14 by a second air gap disposed in feed line 22.

Control circuitry 50 can generate a fill command and send the fill command to actuator 30 to initiate the fill cycle. The fill command activates actuator 30 to cause feed valve 40 to shift to the open state. For example, actuator 30 can be a solenoid valve and feed valve 40 can be a pneumatically-actuated valve. The fill command can cause the solenoid valve to shift and direct compressed air to feed valve 40 to actuate feed valve 40.

With feed valve 40 in the open state, the liquid held in storage tank 34 flows out of storage tank 34 through feed valve 40. The liquid flows through feed line 22 to storage tank 34 and begins to fill storage tank 34. As the liquid fills storage tank, a conduction path is created between the charged liquid in supply module 14 and the liquid in feed module 12 by the liquid flowing in feed line 22. As such, various components of feed module 12, such as feed valve 40, will be charged during at least a portion of the refill sequence. As discussed above, however, the charge will not short to earth ground as supply module 14 includes a non-conductive housing isolating the components of supply module 14 from earth ground potential.

During the fill cycle, the first air gap between inlet valve 38 and the liquid in storage tank 34 is maintained. As such, the liquid in feed module 12, which is charged during the fill cycle, is electrically isolated from earth ground potential, at inlet valve 38, during the fill cycle. The first air gap ensures that the liquid in supply module 14 is electrically isolated from inlet valve 38, and thus from the liquid in reservoir line 20. In some examples, an additional sensor can be mounted to inlet line 36 to provide information to control module 16 regarding any liquid in inlet line 36. The control module 16 can utilize the information regarding inlet line 36 to determine if inlet valve 38 is suitably isolated from the liquid in supply module 14 prior to commencing the fill cycle.

The liquid flows downstream from storage tank 34 to supply tank 44 via feed line 22. Feed line 22 can be a gravity feed tube such that gravity causes the liquid to flow from storage tank 34 to supply tank 44. Control module 16 can confirm that the liquid is flowing to supply module 14 from feed module 12 based on any one or more of the storage level data from level sensor 42 indicating a drop in the liquid level in storage tank 34, the supply level data from level sensor 46 indicating a rise in the liquid level in supply tank 44, and the feed flow data from feed line sensor 32 indicating liquid in feed line 22.

As supply tank 44 fills during the fill cycle, level sensor 46 provides supply level data to control module 16. Control module 16 can recall a full supply level from memory 52 and compare that full supply level to the amount of liquid actually in supply tank 44, which is based on the supply level data from level sensor 46. Control module 16 can determine that the fill cycle is complete based on the comparison indicating that the actual amount of liquid in supply tank 44 has reached the full supply level. Control module 16 can stop the fill cycle based on that determination.

To stop the fill cycle, control module 16 can generate a stop fill command and provide the stop fill command to actuator 30. The stop command deactivates actuator 30 to cause feed valve 40 to return to the closed state. In other examples, the fill command can cause feed valve 40 to open for a set period of time. In such an example, actuator 30 causes feed valve 40 to return to the closed state, thereby ending the fill cycle, based on the expiration of the set time period.

With feed valve 40 in the closed state, liquid is prevented from flowing from feed module 12 to supply module 14. Feed line 22 is made from a non-conductive material. The material and/or a coating on the interior of feed line 22 is formed from a material that causes water and water-based liquids to bead/shed off of the interior of feed line 22. For example, feed line 22 can be made from fluorinated ethylene propylene (FEP) or can be coated with a hydrophobic coating. It is understood, however, that feed line 22 can take the form of any non-conductive material having suitably low friction and/or hydrophobic properties to prevent an undesired conduction path from forming in feed line 22. As such, any liquid in feed line 22 will bead/shed to supply module 14. The second air gap is thereby formed in feed line 22 to electrically isolate feed module 12 from supply module 14.

Supply module 14 is isolated from earth ground potential throughout the fill cycle. As such, the user can continue to spray the charged liquid via electrostatic sprayer 26 throughout the fill cycle. After the fill cycle is complete, feed module 12 proceeds through a refill cycle to prepare for the next fill cycle.

During the refill cycle, storage tank 34 is filled with liquid from main reservoir 18 in preparation for the next fill cycle. Because main reservoir 18 is connected to earth ground potential, the liquid in supply module 14 and various components of supply module 14, such as feed valve 40, are electrically connected to earth ground potential during the refill cycle. The second air gap in feed line 22 electrically isolates supply module 14 from earth ground potential during the refill cycle.

Prior to commencing the refill cycle, control module 16 can verify that the second air gap has been formed in feed line 22. For example, the feed flow data from feed line sensor 32 can indicate whether liquid is present in feed line 22. In some examples, control module 16 will not initiate the refill cycle unless the feed flow data verifies that the second air gap has been formed. In other examples, a time delay can be implemented between the end of the fill cycle and the start of the refill cycle. The time delay ensures that the second air gap forms in feed line 22 prior to initiating the refill cycle.

To initiate the refill cycle, control module 16 generates a refill command and provides the refill command to actuator 28. The refill command activates actuator 28 to cause inlet valve 38 to shift to the open state. For example, actuator 28 can be a solenoid valve and inlet valve 38 can be a pneumatically-actuated valve. The refill command can cause the solenoid valve to shift and direct compressed air to inlet valve 38 to actuate inlet valve 38.

With inlet valve 38 in the open state, the liquid from main reservoir 18 flows into supply module 14 through inlet line 36. The liquid flows to and begins to fill storage tank 34. Level sensor 42 senses the rising liquid level in storage tank 34 and generates and provides storage level data to control module 16. Control module 16 can recall a full storage level from memory 52 and compare that full storage level to the amount of liquid actually in storage tank 34, which is based on the storage level data from level sensor 42. Control module 16 can determine that the refill cycle is complete based on the comparison indicating that the amount of liquid in supply tank 44 has reached the full storage level. Control module 16 can stop the refill cycle based on that determination.

To stop the refill cycle, control module 16 can generate a stop refill command and provide the stop refill command to actuator 28. The stop refill command deactivates actuator 28 to cause inlet valve 38 to return to the closed state. With inlet valve 38 closed, the liquid from main storage tank 34 is prevented from entering supply module 14.

The first air gap is reformed in inlet line 36 between the liquid feed module 12 and inlet valve 38. The first air gap electrically isolates inlet valve 38 from the liquid in supply module 14. Inlet line 36 is made from a non-conductive material. The material and/or a coating on the interior of inlet line 36 can be formed from a material that causes water and water-based liquids to bead/shed off of the interior of inlet line 36. For example, inlet line 36 can be made from fluorinated ethylene propylene (FEP) or can be coated with a hydrophobic coating. It is understood, however, that inlet line 36 can take the form of any non-conductive material having suitably low friction and/or hydrophobic properties to prevent a liquid conduction path from forming between the inlet valve 38 and the liquid in feed module 12. Inlet valve 38 is mounted such that the first air gap is of sufficient length to electrically isolate the liquid and inlet valve 38. For example, the length of the first air gap can be at least 1 inch for every 10 KV of charge. In a 60 KV system, the length of the first air gap is at least 6 inches.

At the conclusion of the refill cycle storage tank 34 is filled and inlet valve 38 is returned to the closed state. Feed module 12 reenters the rest state and is ready for control module 16 to initiate another fill cycle.

Electrostatic spray system 10 provides significant advantages. Electrostatic spray system 10 provides a continuous supply of spray liquid to electrostatic sprayer 26. As such, the user does not need to shut downs the system to refill supply tank 44 during the spray process. Providing a continuous supply of spray liquid thereby increases efficiency. Electrostatic spray system 10 electrically isolates any charged liquid from earth ground potential throughout both the fill cycle and the refill cycle. The charged liquid is electrically isolated by shifting the location of non-conductive air gaps between a location upstream of the liquid in storage tank 34, in inlet line 36, during the fill cycle, and a location between feed module 12 and supply module 14, in feed line 22, during the refill sequence. During the fill sequence, the liquid in both feed module 12 and supply module 14 is charged due to the conductive path formed by the liquid flowing through feed line 22. The first air gap in inlet line 36 electrically isolates the charged liquid from earth ground potential, at inlet valve 38, during the fill sequence. During the refill sequence, the liquid in supply module 14 remains charged, while the liquid in feed module 12 is connected to earth ground potential via at main reservoir 18. The second air gap in feed line 22 electrically isolates the charged liquid supply module 14 from the liquid in feed module. As such, the liquid in supply module 14 can remain charged throughout both the fill cycle and the refill cycle to allow continuous spraying at electrostatic sprayer 26. Feed module 12 is configured to drain to supply module 14 quicker than electrostatic sprayer 26 can spray the liquid. Feed module 12 can provide a continuous supply of liquid to supply module 14 without requiring the stoppage of any spray activity.

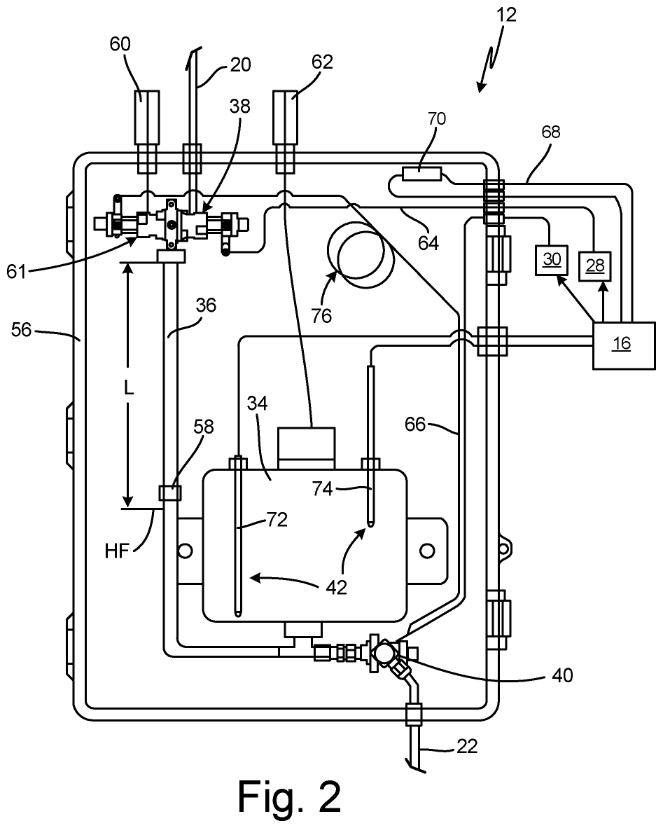

FIG. 2 is a schematic diagram of feed module 12. Feed module 12 includes storage tank 34, inlet line 36, inlet valve 38, feed valve 40, level sensor 42, feed housing 56, line sensor 58, line vent 60, vent valve 61, tank vent 62, first control line 64, second control line 66, third control line 68, and door lock 70. Level sensor 42 includes first sensor 72 and second sensor 74. Second control line 66 includes coil 76. Control module 16, reservoir line 20, feed line 22, actuator 28, and actuator 30 are shown.

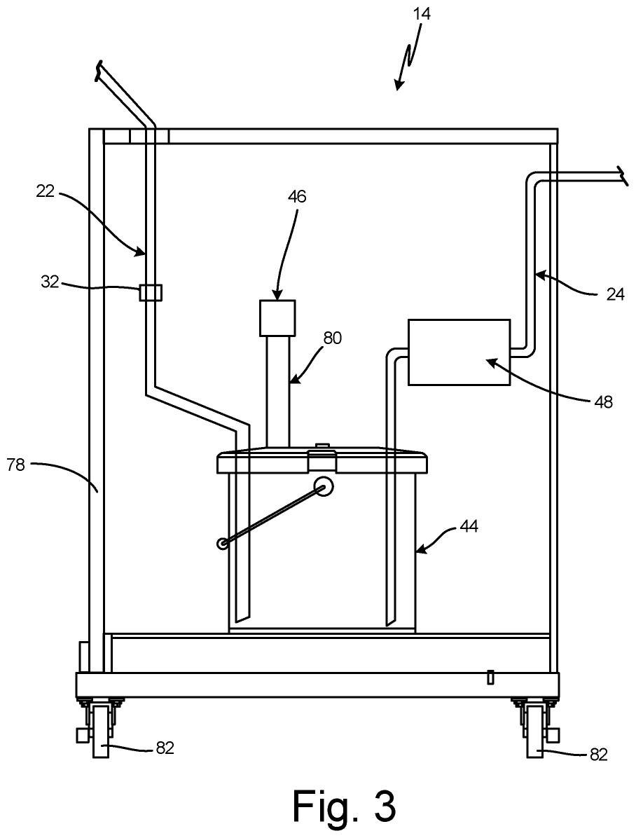

Feed module 12 is configured to store a supply of liquid for filling supply module 14 (FIGS. 1 and 3) during electrostatic spraying. Reservoir line 20 extends to feed module 12 from a main liquid supply, such as main reservoir 18 (FIG. 1). The main reservoir is connected to earth ground potential. Feed module 12 is configured to electrically isolate the liquid in feed module 12 from earth ground potential prior to dumping the liquid to supply module 14 to feed module 12.

Feed housing 56 is formed from a non-conductive material, such as plastic, and houses the various components of feed module 12. Door lock 70 is disposed in feed module 12 and configured to lock an access door of feed module 12 when electrostatic spray system 10 (FIG. 1) is in operation. Third control line 68 extends to door lock 70 and is configured to provide fluid to door lock 70 to activate door lock 70. In some examples, the fluid can be compressed air, such that third control line 68 is a pneumatic line.

Inlet valve 38 is disposed at the intersection between reservoir line 20 and inlet line 36. Inlet valve 38 controls the flow of liquid into feed module 12 from main reservoir 18. First control line 64 extends from actuator 28 to inlet valve 38. First control line 64 is configured to convey control fluid, such as compressed air, to and from inlet valve 38 to actuate inlet valve 38 between the open and closed states. In the example shown, actuator 28 is a solenoid valve. It is understood, however, that actuator 28 can be of any type suitable for selectively directing control fluid to inlet valve 38 to actuate inlet valve 38.

Inlet line 36 extends from inlet valve 38 to storage tank 34. Line sensor 58 is disposed on inlet line 36 between inlet valve 38 and storage tank 34. Line sensor 58 is configured to generate line flow data regarding liquid in inlet line 36. For example, line sensor 58 can be a fiber optic sensor configured to sense the presence of liquid in inlet line 36. In some examples, line sensor 58 can be positioned on inlet line 36 proximate the high-fill level HF of storage tank 34. As such, line sensor 58 can provide a redundant data set with data generated by level sensor 42 for sensing when storage tank 34 is full. In another example, line sensor 58 can be placed on inlet line 36 above the high-fill level of storage tank 34. In such an example, line sensor 58 can provide information to control module 16 (FIG. 1) regarding the presence or absence of the first air gap in inlet line 36.

Storage tank 34 is configured to store a supply of liquid for filling supply module 14. Tank vent 62 is connected to storage tank 34 and is configured to vent the interior of storage tank 34 to atmosphere. In the example shown, tank vent 62 is connected to a top of storage tank 34. Tank vent 62 is configured to allow air to vent between the atmosphere and the interior of storage tank 34, while preventing any liquid from flowing out of tank vent 62. For example, tank vent 62 can include floats that allow air to pass but rise with any fluid to seal the vent path, among other configurations.

Level sensor 42 is mounted to storage tank 34 and configured to generate storage level data. First sensor 72 extends into storage tank 34 to a point near a bottom of storage tank 34. First sensor 72 is a fiber optic sensor configured to sense the presence of liquid in storage tank 34. In the example shown, first sensor 72 is a low-level sensor that is configured to first sense liquid when storage tank 34 begins to fill and to last sense liquid when storage tank 34 empties. First sensor 72 provides feedback to control module 16 that liquid is beginning to fill storage tank 34 during a refill cycle and provides feedback to control module 16 that liquid is finishing draining from storage tank 34 during a fill cycle.

Second sensor 74 extends into storage tank 34 to a point proximate the high-fill level HF of storage tank 34. Second sensor 74 is a fiber optic sensor configured to sense the presence of liquid in storage tank 34. In the example shown, second sensor 74 is a high-level sensor configured to last sense liquid when storage tank 34 fills and to first sense the absence of liquid when storage tank 34 empties. Second sensor 74 provides feedback to control module 16 that storage tank 34 is full during the refill sequence and that storage tank 34 is draining during the fill sequence. For example, control module 16 can cause inlet valve 38 to close based on second sensor 74 sensing the liquid level reaching the high-fill level HF.

While level sensor 42 is described as a fiber optic sensor having first sensor 72 and second sensor 74, it is understood that level sensor 42 can be of any configuration suitable for generating data regarding the amount of liquid in storage tank 34. For example, level sensor 42 can be a scale, a mechanical float, an ultrasonic level sensor electrically isolated from the liquid in feed module 12, or can be of any other type suitably configured for generating data regarding the amount of liquid in storage tank 34.

Line vent 60 is connected to inlet line 36 and is configured to provide a vent path for air to enter and exit inlet line 36. Line vent 60 is configured to allow air to vent between the atmosphere and the interior of inlet line 36, while preventing liquid from flowing out of feed module 12 through line vent 60. For example, line vent 60 can include floats that allow air to pass but rise with any fluid to seal the vent path, among other configuration. Vent valve 61 is configured to control opening of line vent 60.

Feed valve 40 is disposed downstream of storage tank 34 and is configured to control the flow of liquid out of fill module 12 to feed line 22. Feed line 22 extends downstream from feed valve 40 to supply module 14.

Second control line 66 extends from actuator 30 to feed valve 40 and vent valve 61. Coil 76 is formed by a portion of second control line 66 downstream of feed valve 40 and upstream of vent valve 61. Second control line 66 is configured to convey control fluid, such as compressed air, to and from feed valve 40 to actuate feed valve 40 between the open and closed states. Second control line 66 further conveys the control fluid to and from vent valve 61 to actuate vent valve 61 between an open state, allowing venting through line vent 60, and a closed state, preventing venting through line vent 60. The control fluid first encounters feed valve 40, as feed valve 40 is disposed further upstream along second control line 66 than vent valve 61. The control fluid flows further downstream through coil 76 to vent valve 61. The control fluid causes vent valve 61 to shift open, thereby opening a vent path through line vent 60 and connecting inlet line 36 with the atmosphere. Coil 76 is sized to delay the flow of control fluid between feed valve 40 and vent valve 61, thereby causing a delay between feed valve 40 opening and vent valve 61 opening. In the example shown, actuator 30 is a solenoid valve. It is understood, however, that actuator 30 can be of any type suitable for selectively directing control fluid to feed valve 40 and line vent 60.

During operation, feed module 12 is initially in a rest state. In the rest state storage tank 34 is filled with liquid and both inlet valve 38 and feed valve 40 are maintained in the respective closed states. A first air gap is generated between the liquid in inlet line 36 at high-fill line HF and inlet valve 38. The length L of the first air gap can be of any suitable length based on the spray charge. Length L is based on one inch of air gap distance for every 10 KV of charge. Electrostatic spray system 10 is configured to spray at 60 KV of charge. As such, length L is greater than six inches to isolate inlet valve 38 from the liquid in feed module 12. For example, length L can be about 6.75-7 inches based on a spray charge of 60 KV.

Feed module 12 remains in the rest state until control module 16 determines that supply module 14 requires a fill. In some examples, control module 16 verifies the formation of the first air gap in inlet line 36 prior to initiating the fill cycle. Control module 16 can verify the formation of the first air gap based on the data generated by line sensor 58.

Control module 16 initiates the fill sequence by activating actuator 30 so actuator 30 directs compressed air, or another suitable control fluid, to second control line 66. The compressed air flows to feed valve 40 and actuates feed valve 40 to the open state. With feed valve 40 in the open state, the liquid in supply tank 44 flows out of supply tank 44, through feed valve 40 and into feed line 22. The liquid flows through feed line 22 to supply module 14 to refill supply module 14.

The compressed air flows further downstream through second control line 66 through coil 76 and to line vent 60. The compressed air actuates vent valve 61 to an open state, thereby opening a vent path between inlet line 36 and the atmosphere through line vent 60. Because of coil 76 causing a delay between the compressed air reaching and actuating feed valve 40 and reaching and actuating vent valve 61, line vent 60 opens after feed valve 40 open to preserve the air gap in inlet line 36. This ensures that any residual pressure that may remain in inlet line 36 from the fill cycle is relieved through feed valve 40 prior to line vent 60 opening, thereby ensuring that the liquid in inlet line 36 does not flow up within inlet line 36 and instead drains as desired.

Level sensor 42 detects the drop in liquid in supply tank 44 and can provide the supply level information to control module 16. Second sensor 74 initially senses the drop in liquid level in storage tank 34, which indicates that the liquid is draining as expected. The liquid continues to drain and first sensor 72 can detect when the liquid level in supply tank 44 is approaching empty. Additionally and/or alternatively, line sensor 58 can be disposed on inlet line 36 to sense the flow of liquid within inlet line 36 and can further communicate that flow information to control module 16. Line sensor 58 sensing flow in inlet line 36 indicates that the liquid is draining through feed valve 40.

The liquid continues to drain through feed valve 40 until control module 16 ends the fill cycle. Actuator 30 is deactivated and the compressed air in second control line 66 is vented. Each of line vent 60 and feed valve 40 shift to their respective closed states. With feed valve 40 in the closed state, liquid in supply module 14 is prevented from flowing to feed line 22 and the fill cycle is complete. With feed valve 40 closed, the second air gap forms in feed line to electrically isolate supply module 14 from feed module 12.

After completing a fill cycle, feed module 12 can proceed through a refill cycle. Control module 16 activates actuator 28, and actuator 28 directs compressed air through first control line 64 to inlet valve 38. The compressed air causes inlet valve 38 to shift from the closed state to the open state. With inlet valve 38 in the open state, the liquid in reservoir line 20 flows from reservoir line 20 into feed module 12 through inlet valve 38, thereby eliminating the first air gap. The liquid flows through inlet line 36 and into storage tank 34. The liquid in feed module 12 is connected to earth ground potential during the refill cycle due to the elimination of the first air gap in inlet line 36.

The liquid level in storage tank 34 and inlet line 36 rise. Level sensor 42 senses the rising liquid level and provide storage level information to control module 16. Control module 16 can end the refill cycle based on the storage level information from level sensor 42 indicating that the actual fluid level in storage tank 34 has reached a desired level, such as the high-fill level HF. It is understood, however, that control module 16 can end the refill cycle based on any desired factor, such as time, for example.

To end the refill cycle, control module 16 deactivates actuator 28, and the compressed air in first control line 64 is vented. Inlet valve 38 shifts to the closed state, thereby shutting off the flow of liquid into feed module 12. The first air gap is reformed in inlet line 36 between inlet valve 38 and the liquid in inlet line 36. With the refill cycle complete, fill module 12 enters the rest state and is ready to proceed through another fill cycle.

Feed module 12 provides significant advantages. Inlet valve 38 and feed valve 40 are controlled to ensure that feed module 12 is electrically connected to only one of supply module 14 and main reservoir 18. Feed module 12 is configured to be charged during the fill cycle and connected to earth ground potential during the refill cycle. Fill module 12 controls formation of the first and second air gaps to ensure that supply module 14 is electrically isolated from earth ground potential throughout the spray process. Feed module 12 can provide a continuous supply of liquid to supply module 14 without requiring any stop in spraying.

FIG. 3 is a schematic diagram of supply module 14. Supply module 14 includes feed line sensor 32, supply tank 44, level sensor 46, pump 48, supply housing 78, extension tube 80, and wheels 82. Feed line 22 and supply line 24 are shown.

Supply module 14 is configured to store a supply of charged liquid for application by electrostatic sprayer 26 (FIG. 1) during electrostatic spraying. Supply housing 78 is formed from non-conductive material, such as plastic, and houses various components of supply module 14. Wheels 82 are mounted to supply housing 78. Wheels 82 provide mobility to supply module 14 to facilitate spraying across a variety of applications.

Feed line 22 extends to supply module 14 from feed module 12 (FIGS. 1 and 2) to provide liquid to supply module 14 to fill supply tank 44 during spraying. Feed line 22 extends into supply tank 44 to provide the liquid from supply module 14 directly to supply tank 44. Supply tank 44 is disposed within supply housing 78. Feed line sensor 32 is disposed on the portion of feed line 22 within supply tank 44. It is understood, however, that feed line sensor 32 can be disposed at any desired location along feed line 22. Feed line sensor 32 is configured to generate feed flow data regarding the liquid supplied to supply tank 44 through feed line 22. Feed line sensor 32 can be configured to provide one or more of a flow rate, a flow status (such as whether liquid is currently flowing in feed line 22), and/or a liquid status (such as whether liquid is currently present in feed line 22), among other options. In one example, feed line sensor 32 is a fiber optic sensor. It is understood, however, that feed line sensor 32 can be of any type suitable for generating fluid data regarding the liquid in feed line 22. Feed line sensor 32 can provide the feed flow data to control module 16 (best seen FIG. 1).

Supply line 24 extends from supply tank 44 and out of supply housing 78 to the electrostatic sprayer 26. Pump 48 is disposed on supply line 24 and is configured to pump liquid downstream to electrostatic sprayer 26 from supply tank 44.

Level sensor 46 is configured to generate supply level data regarding the liquid level in supply tank 44 and is further configured to provide the supply level data to control module 16. In the example shown, level sensor 46 is an ultrasonic level sensor. Level sensor 46 is electrically isolated from charged components of feed module 12. Extension tube 80 extends from the top of supply tank 44. Extension tube 80 is configured to electrically isolate level sensor 46 from the liquid in supply module 14 to electrically isolate level sensor 46 from the charged components of supply module 14. Extension tube 80 is hollow such that level sensor 46 can determine the liquid level in supply tank 44 through extension tube 80. In some examples, extension tube 80 extends from a lid of supply tank 44. For example, supply tank 44 can be a 5-gallon bucket and extension tube 80 can extend from the lid of the 5-gallon bucket. Extension tube 80 can extend any suitable distance based on the spray charge. The distance is based on one inch of air gap distance for every 10 KV of charge. Electrostatic spray system 10 can be configured to spray at 60 KV of charge. As such, extension tube 80 can support level sensor 46 at least six inches away from any charged components.

Level sensor 46 is shown as an ultrasonic level sensor 46 mounted on extension tube 80. It is understood, however, that level sensor 46 can be of any suitable configuration for generating data regarding the amount of liquid in supply tank 44 without shorting the charge. For example, level sensor 46 can include one or more of fiber optic sensors, a mechanical float, a scale, or can be of any other suitable configuration.

During operation, feed module 12 stores liquid for application by electrostatic sprayer 26 (FIG. 1). The liquid is charged during spraying, such as by an electrode of the electrostatic sprayer 26 or at supply tank 44, among other options. Pump 48 draws the liquid from storage tank 34 and pumps the liquid downstream to electrostatic sprayer 26. Level sensor 46 generates supply level data regarding the liquid level in storage tank 34. Level sensor 46 provides the supply level data to control module 16. The liquid level continues to drop until control module 16 initiates a fill cycle based on the supply level data.

During the fill cycle, the liquid flows through feed line 22 to supply tank 44. The liquid flowing through feed line 22 into supply tank 44 forms a conduction path between feed module 12 and supply module 14. Feed line sensor 32 can provide information to control module 16 regarding the liquid in feed line 22.

Level sensor 46 provides supply level data as supply tank 44 fills. Control module 16 can verify that supply tank 44 is filling based on the data provided by either one of feed line sensor 32 and level sensor 46. Control module 16 stops the fill cycle based on the supply level data indicating that the supply tank 44 is filled to a sufficient level. It is understood, however, that control module 16 can stop the fill cycle based on any desired factor, such as the feed flow data from feed line sensor 32 indicating that no liquid is flowing in feed line 22, which would indicate that storage tank 34 (FIGS. 1 and 2) is empty, or based on the passage of a set time period, among other options. With the fill cycle complete, supply module 14 is again electrically isolated from feed module 12 by the air gap formed in feed line 22.

Supply module 14 provides significant advantages. Supply module 14 is mobile and can be moved to a variety of work environments and locations. Supply housing 78 is formed of non-conductive material and isolates other components of supply module 14 from earth ground. Level sensor 46 provides the supply level information throughout spraying such that the actual liquid level in supply tank 44 is known. Control module 16 can automatically initiate a fill sequence based on the liquid level data. The refill sequence can proceed simultaneously with electrostatic spraying, increasing the efficiency of any spray process and decreasing the labor associated with spraying. The user does not need to shut down or stop any spraying to refill supply module 14.

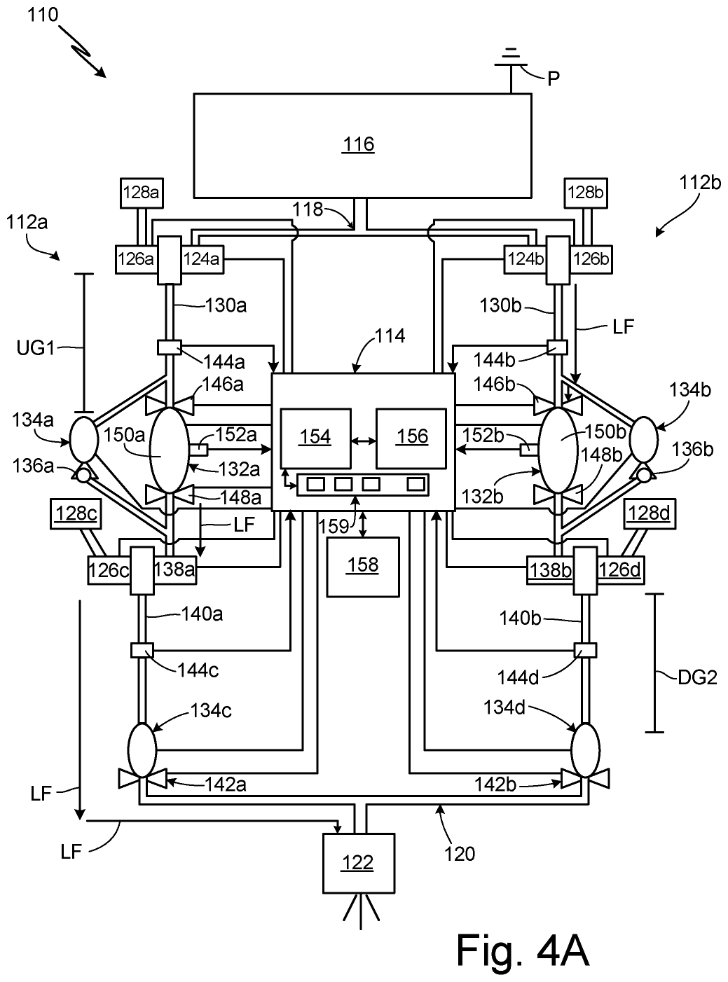

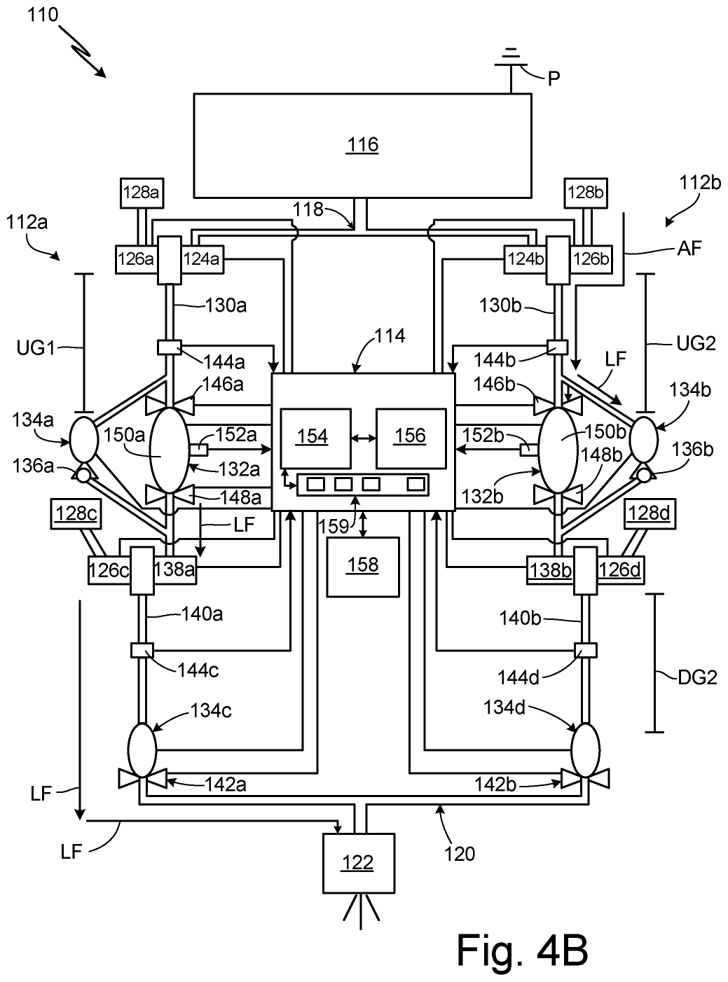

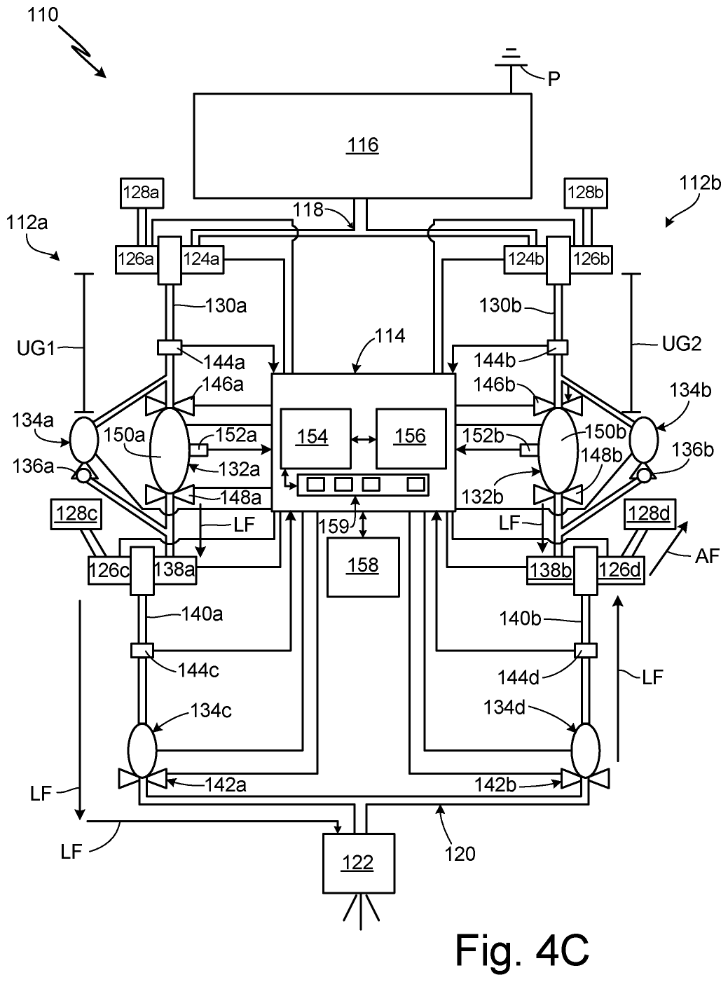

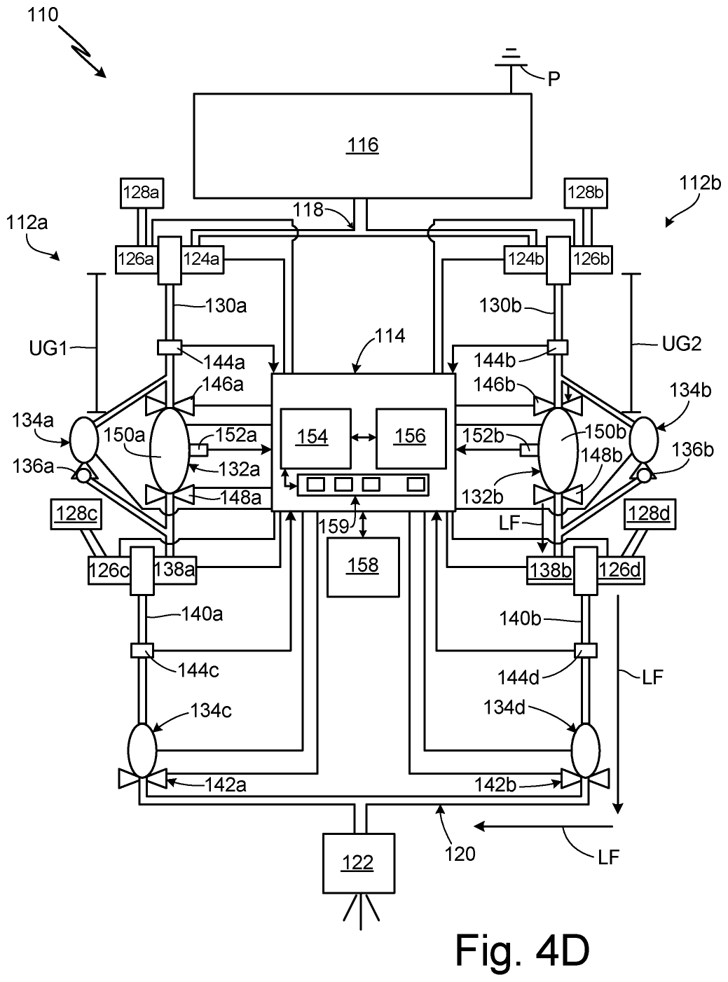

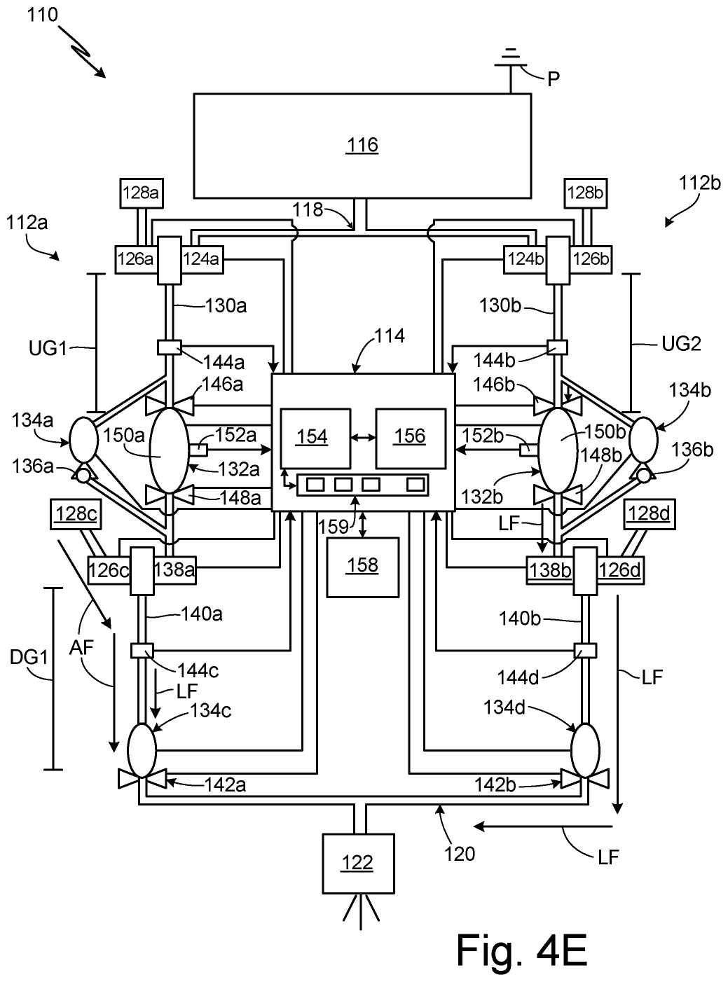

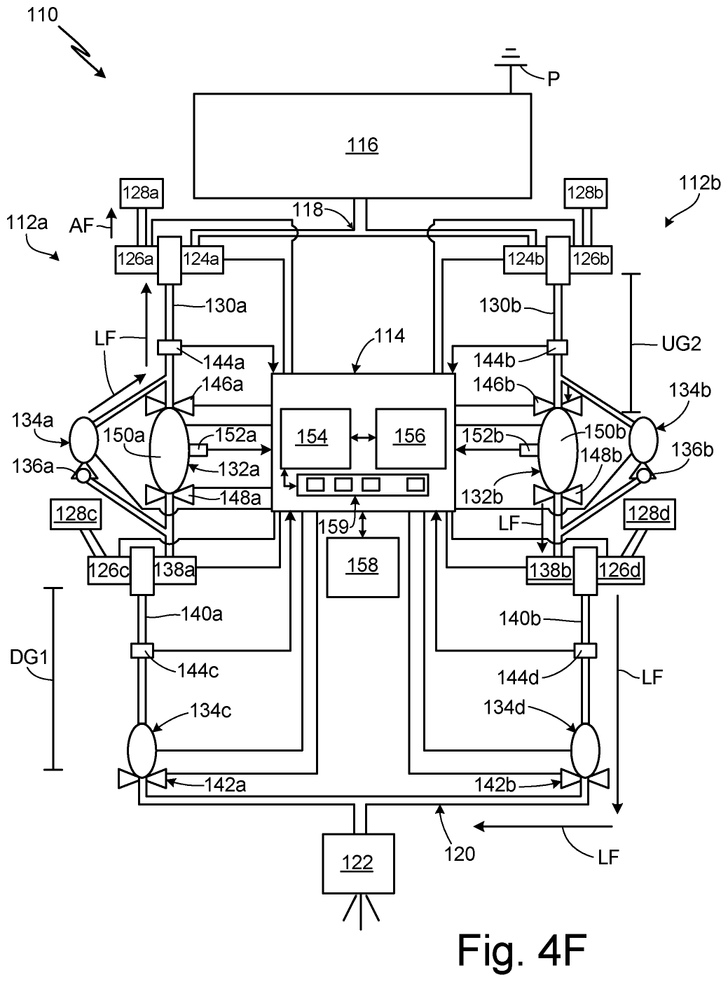

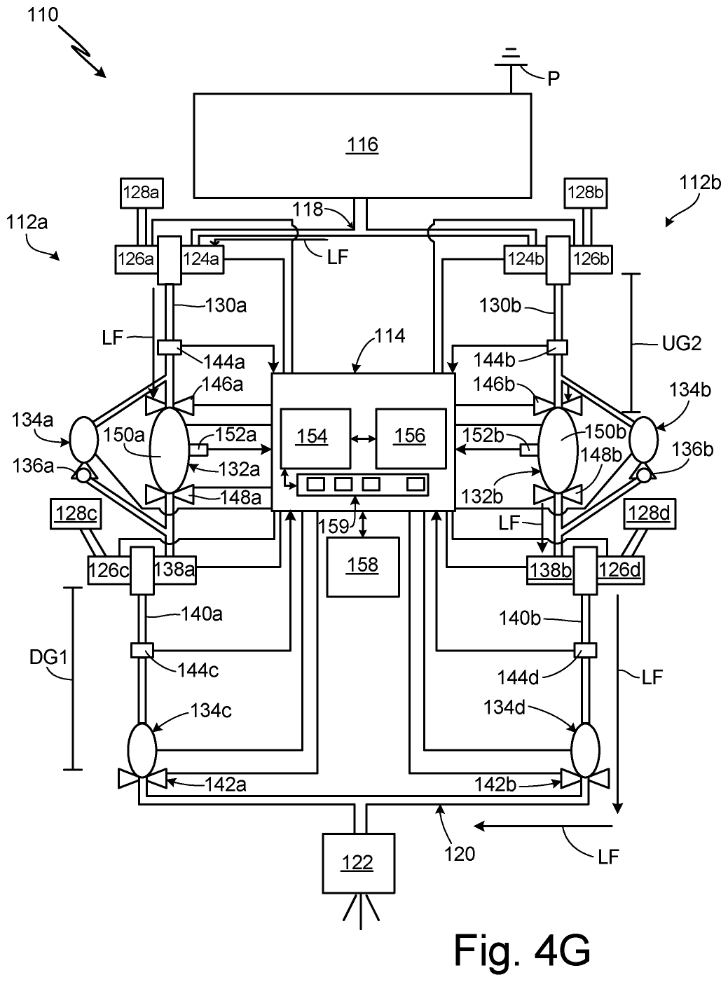

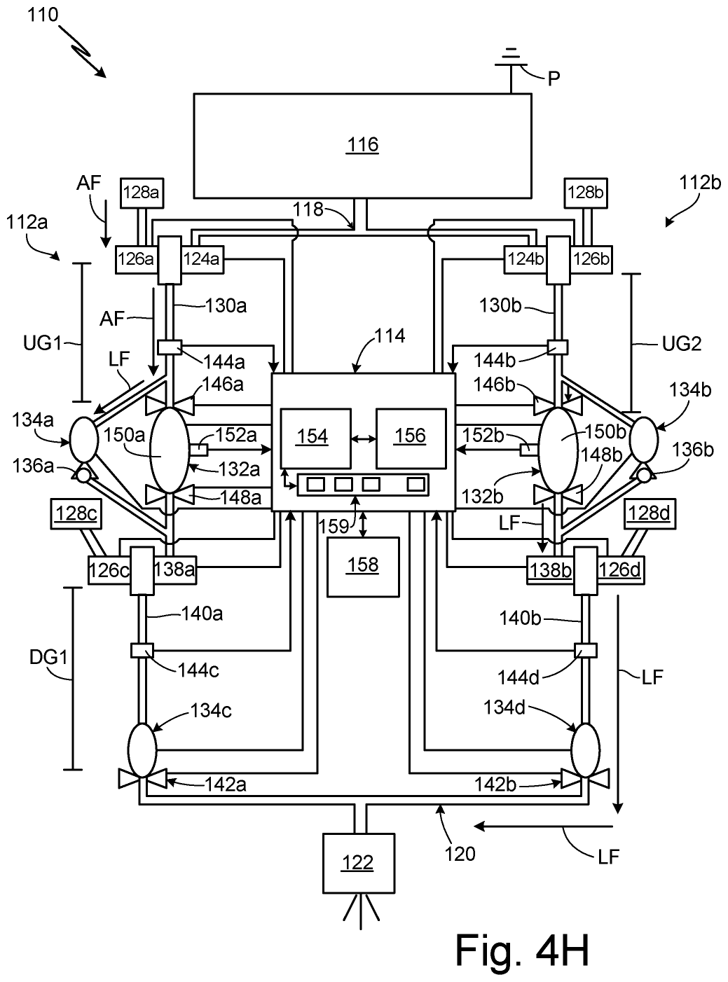

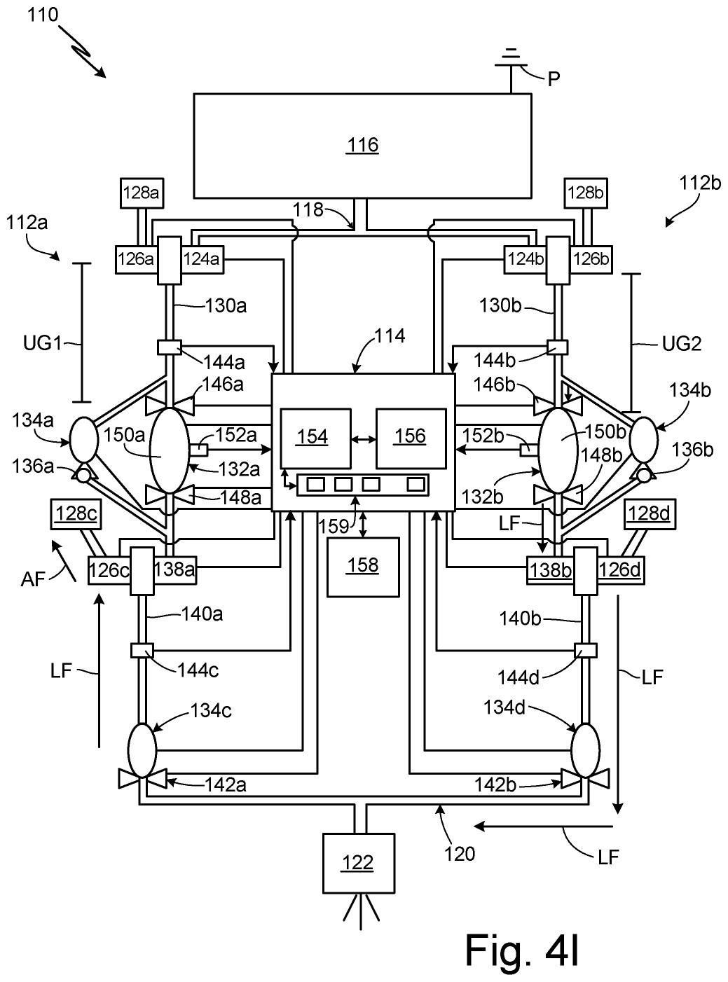

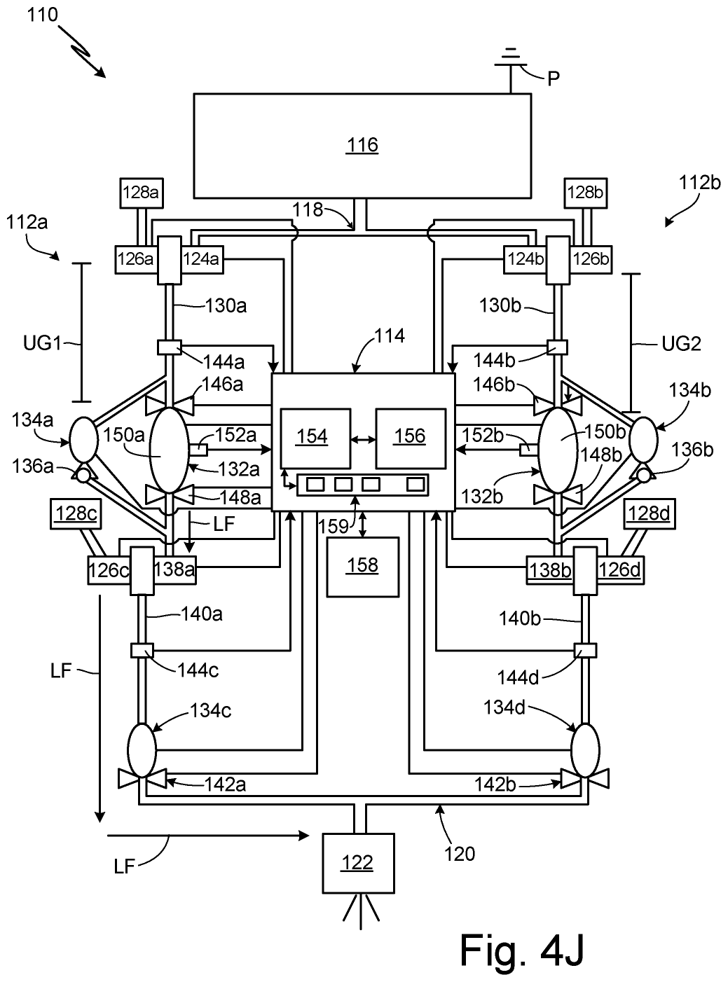

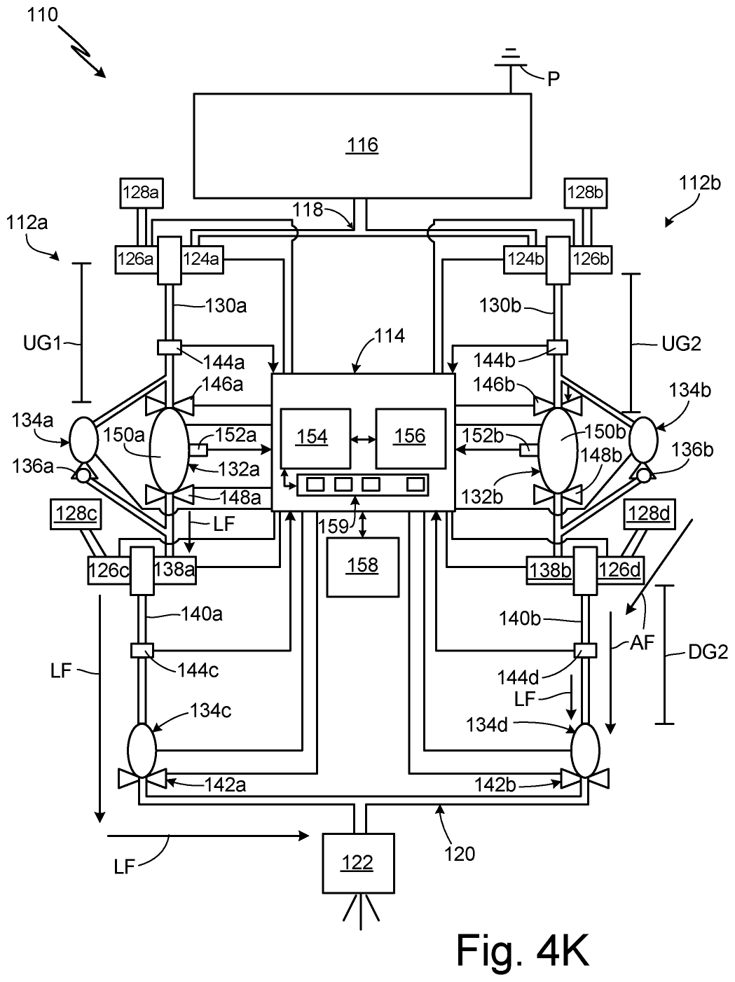

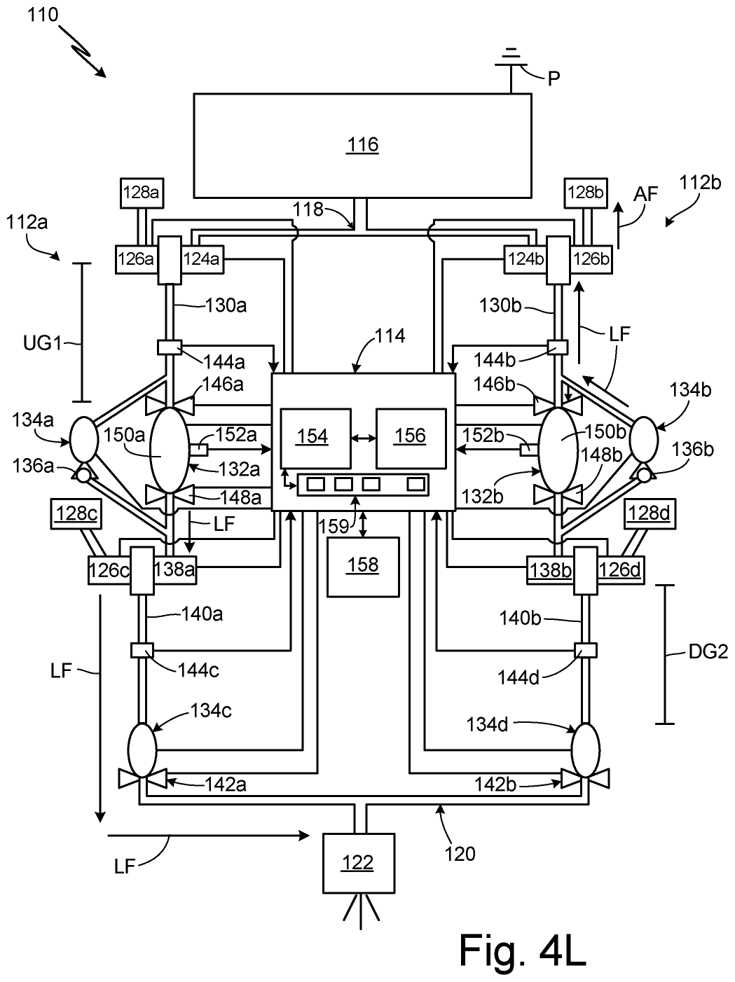

FIG. 4A is a schematic diagram of electrostatic spray system 110 in a first state. FIG. 4B is a schematic diagram of electrostatic spray system 110 in a second state. FIG. 4C is a schematic diagram of electrostatic spray system 110 in a third state. FIG. 4D is a schematic diagram of electrostatic spray system 110 in a fourth state. FIG. 4E is a schematic diagram of electrostatic spray system 110 in a fifth state. FIG. 4F is a schematic diagram of electrostatic spray system 110 in a sixth state. FIG. 4G is a schematic diagram of electrostatic spray system 110 in a seventh state. FIG. 4H is a schematic diagram of electrostatic spray system 110 in an eighth state. FIG. 4I is a schematic diagram of electrostatic spray system 110 in a ninth state. FIG. 4J is a schematic diagram of electrostatic spray system 110 in a tenth state. FIG. 4K is a schematic diagram of electrostatic spray system 110 in an eleventh state. FIG. 4L is a schematic diagram of electrostatic spray system 110 in a twelfth state. FIGS. 4A-4L will be discussed together.

Electrostatic spray system 110 includes supply modules 112a, 112b; control module 114; main reservoir 116; reservoir line 118; supply line 120; and electrostatic sprayer 122. Supply module 112a includes inlet valve 124a; vent valves 126a, 126c; vents 128a, 128c; fill line 130a, isolation pump 132a; gap controllers 134a, 134c; check valve 136a; feed valve 138a; feed line 140a; spray valve 142a; and line sensors 144a, 144c. Isolation pump 132a includes pump inlet valve 146a, pump outlet valve 148a, liquid chamber 150a, and status sensor 152a. Supply module 112b includes inlet valve 124b; vent valves 126b, 126d; vents 128b, 128d; fill line 130b, isolation pump 132b; gap controllers 134b, 134d; check valve 136b; feed valve 138b; feed line 140b; spray valve 142b; and line sensors 144b, 144d. Isolation pump 132b includes pump inlet valve 146b, pump outlet valve 148b, liquid chamber 150b, and status sensor 152b. Control module 104 includes control circuitry 154, memory 156, user interface 158, and actuators 159. Liquid flows are indicated by arrows LF and air flows are indicated by arrows AF in FIGS. 4A-4L.

Electrostatic spray system 110 is configured to atomize and spray a liquid, such as water and water-based coatings, and charge the liquid droplets to a desired potential. For example, electrostatic spray system 110 can be configured to spray with a 60 kV charge. The charged droplets are directed towards an object to coat the object with the droplets. Electrostatic spray system 110 provides a continuous supply of the liquid to electrostatic sprayer 122 for application while isolating the liquid in main reservoir 116 from the liquid being sprayed to prevent shorting to earth ground.

Supply modules 112a, 112b are configured to alternatingly supply liquid to electrostatic sprayer 122 for spraying. Control module 114 is substantially similar to control module 16 (FIG. 1). Control module 114 is configured to operate in accordance with techniques disclosed herein. As discussed in more detail below, control module 114 is configured to control components of supply modules 112a, 112b such that one supply module 112a, 112b provides liquid to electrostatic sprayer 122 while being electrically isolated from main reservoir 116, while the other of supply module 112a, 112b is being refilled with liquid from main reservoir 116. It is understood that control module 114 can control the positions of various valves described herein in accordance with techniques described herein and that such control can include intermediate control of an actuator 159, such as a solenoid valve configured to direct compressed air.

Main reservoir 116 stores a bulk supply of the liquid for application by electrostatic spray system 110. Main reservoir 116 is connected to earth ground potential P. Reservoir line 118 extends from main reservoir 116 to supply modules 112a, 112b to provide liquid from main reservoir 116 to supply modules 112a, 112b. Supply modules 112a, 112b are configured to supply liquid to electrostatic sprayer 122 for spraying. Supply modules 112a, 112b are alternatingly connected to electrostatic sprayer 122 to supply the liquid to electrostatic sprayer 122. Supply modules 112a, 112b can include non-conductive enclosures to electrically isolate components of supply modules 112a, 112b from earth ground.

Inlet valves 124a, 124b are disposed between reservoir line 118 and fill lines 130a, 130b, respectively. Inlet valves 124a, 124b are controllable between respective open states, where liquid from main reservoir 116 can flow through inlet valves 124a, 124b into fill lines 130a, 130b and thus to isolation pumps 132a, 132b, and closed states, where inlet valves 124a, 124b prevent the liquid from flowing into fill lines 130a, 130b from main reservoir 116. In the example shown, inlet valves 124a, 124b are pneumatically-actuated valves. It is understood, however, that inlet valves 124a, 124b can be of any desired configuration for controlling the flow of liquid between main reservoir 116 and isolation pumps 132a, 132b.

Vent valves 126a, 126b are disposed at the upstream end of fill lines 130a, 130b proximate inlet valves 124a, 124b. Vent valves 126a, 126b are configured to shift between respective open states and closed states. Vents 128a, 128b are configured to allow air to flow into and out of fill lines 130a, 130b. With vent valves 126a, 126b in the open state, vents 128a, 128b are fluidly connected to fill lines 130a, 130b to allow air to flow into and out of fill lines 130a, 130b through vent valves 126a, 126b. With vent valves 126a, 128b in the closed state, vents 128a, 128b are fluidly disconnected from fill lines 130a, 130b to prevent air from flowing into and out of fill lines 130a, 130b. In some examples, vents 128a, 128b can be connected to atmosphere, such that air is vented from fill lines 130a, 130b to atmosphere and atmospheric air is drawn into fill lines 130a, 130b through vents 128a, 128b. In other examples, vents 128a, 128b are configured to store the air. For example, vents 128a, 128b can be flexible bladders, elongate tubes, or of any other configuration suitable for storing the air. In some examples, such as where vents 128a, 128b are connected to atmosphere, a desiccant drier can be utilized to dry the air prior to the air entering the fill lines 130a, 130b.

Fill lines 130a, 130b extend from inlet valves 124a, 124b to pump inlet valves 146a, 146b. Fill lines 130a, 130b are made from non-conductive materials. The material and/or a coating on the interior of fill lines 130a, 130b can be formed from a material that causes water and water-based liquids to bead/shed off of the interior of fill lines 130a, 130b. For example, fill lines 130a, 130b can be made from FEP and/or can be coated with a hydrophobic coating.

Pump inlet valves 146a, 146b control the flow of liquid into liquid chambers 150a, 150b of isolation pumps 132a, 132b. Pump outlet valves 148a, 148b are disposed on the downstream side of liquid chambers 150a, 150b, respectively, and are configured to control liquid flow out of liquid chambers 150a, 150b. Each of pump inlet valves 146a, 146b and pump outlet valves 148a, 148b are actively controlled valves. In some examples, pump inlet valves 146a, 146b and pump outlet valves 148a, 148b are pneumatically actuated. It is understood, however, that inlet valves 146a, 146b and pump outlet valves 148a, 148b can be of any type suitable for being actively controlled without forming a conduction path that could cause shorting to earth ground.

Isolation pumps 132a, 132b are configured to alternatingly provide liquid to electrostatic sprayer 122 for spraying. As such, electrostatic spray system 110 is configured to provide a continuous supply of liquid for spraying by electrostatic sprayer 122. Each isolation pump 132a, 132b is independently controllable and is configured to drive liquid downstream out of liquid chamber 150a, 150b through pump outlet valve 148a, 148b and to electrostatic sprayer 122 during spraying. Status sensors 152a, 152b are connected to isolation pumps 132a, 132b, respectively, and are configured to sense the volume of liquid within liquid chambers 150a, 150b and to generate status data based on that sensed volume. Status sensors 152a, 152b are configured to provide that status data to control module 114. Status sensors 152a, 152b can be of any configuration suitable for generating status data while electrically isolating from earth ground potential. For example, status sensors 152a, 152b can be generate pneumatic signals and/or fiber optic signals.

Gap controller 134a is fluidly connected to fill line 130a at a location upstream of isolation pump 132a. Gap controller 134b is fluidly connected to fill line 130b at a location upstream of isolation pump 132b. As discussed in more detail below, gap controllers 134a, 134b are configured to generate upstream air gaps in fill lines 130a, 130b to electrically isolate isolation pumps 132a, 132b from main reservoir 116 when the isolation pump 132a, 132b associated with that fill line 130a, 130b is providing liquid to electrostatic sprayer 122. Gap controllers 134a, 134b are further configured to remove the upstream air gaps and drive liquid into fill lines 130a, 130b when the isolation pump 132a, 132b associated with that fill line 130a, 130b is proceeding through a fill cycle.

In one example, gap controllers 134a, 134b include diaphragms configured to expand and contract a liquid chamber to control formation of the upstream air gaps. For example, the diaphragms can be pulled to expand the liquid chamber and draw liquid out of fill lines 130a, 130b and into gap controllers 134a, 134b, thereby generating the upstream air gap. The diaphragms can be pushed to contact the liquid chamber and push liquid out of gap controllers 134a, 134b into fill lines 130a, 130b, thereby removing the upstream air gaps. While gap controllers 134a, 134b are described as including diaphragms, it is understood that gap controllers 134a, 134b can be of any type suitable for drawing liquid out of fill lines 130a, 130b to create the upstream air gaps and for pushing the fluid back into fill lines 130a, 130b to remove the upstream air gaps. For example, gap controllers 134a, 134b can include pistons. The liquid chambers of gap controllers 134a, 134b can be sized to ensure that the air gap is of a suitable size to prevent formation of a conduction path. For example, the liquid chambers can be sized to have a volume approximately equal to the volume of fill lines 130a, 130b.

While gap controllers 134a, 134b are shown as connected to fill lines 130a, 130b by branch lines extending off of fill lines 130a, 130b, it is understood that gap controllers 134a, 134b can be placed at any desired location relative to fill lines 130a, 130b suitable for generating and removing the upstream air gaps. For example, gap controllers 134c, 134d can be in-line on fill lines 130a, 130b between inlet valves 124a, 124b and isolation pumps 132a, 132b.

Check valves 136a, 136b are disposed on the downstream side of gap controllers 134a, 134b, respectively. Check valves 136a, 136b prevent backflow into gap controllers 134a, 134b while allowing liquid in gap controllers 134a, 134b to leak downstream out of gap controllers 134a, 134b. Check valves 136a, 136b ensure that gap controllers 134a, 134b draw

Feed valves 138a, 138b are disposed downstream of isolation pumps 132a, 132b, respectively. Feed valves 138a, 138b are actively controlled valves that control flow of liquid from fill lines 130a, 130b into feed lines 140a, 140b. Feed valves 138a, 138b can be controlled between respective open states, allowing flow into feed lines 140a, 140b, and closed states, preventing flow into feed lines 140a, 140b. Feed valves 138a, 138b can be of any type suitable for being actively controlled while preventing shorting to earth ground. For example, feed valves 138a, 138b can be pneumatically-actuated valves.

Vent valves 126c, 126d are disposed at the upstream end of feed lines 140a, 140b proximate feed valves 138a, 138b. Vent valves 126c, 126d are configured to shift between respective open states and closed states. Vents 128c, 128d are configured to allow flow of air into and out of feed lines 140a, 140b. With vent valves 126c, 126d in the open state, vents 128c, 128d are fluidly connected to feed lines 140a, 140b to allow air to flow into and out of feed lines 140a, 140b through vent valves 126c, 126d. With vent valves 126c, 126d in the closed state, vents 128c, 128d are fluidly disconnected from feed lines 140a, 140b to prevent air from flowing into and out of feed lines 140a, 140b. In some examples, vents 128c, 128d can be connected to atmosphere, such that air is vented from feed lines 140a, 140b to atmosphere and atmospheric air is drawn into feed lines 140a, 140b through vents 128c, 128d. In other examples, vents 128c, 128d are configured to store the air. For example, vents 128c, 128d can be flexible bladders, elongate tubes, or of any other configuration suitable for storing the air. In some examples, such as where vents 128c, 128d are connected to atmosphere, a desiccant drier can be utilized to dry the air prior to the air entering the feed lines 140a, 140b.

Feed lines 140a, 140b extend from feed valves 138a, 138b to gap controllers 134c, 134d, respectively. Feed lines 140a, 140b are made from non-conductive materials. The material and/or a coating on the interior of feed lines 140a, 140b can be formed from a material that causes water and water-based liquids to bead/shed off of the interior of feed lines 140a, 140b. For example, feed lines 140a, 140b can be made from FEP and/or can be coated with a hydrophobic coating.

Gap controllers 134c, 134d are substantially similar to gap controllers 134a, 134b. Gap controllers 134c, 134d are configured to generate downstream air gaps in feed lines 140a, 140b to electrically isolate supply line 120 from feed valves 138a, 138b. Gap controllers 134c, 134d are further configured to fill feed lines 140a, 140b with liquid to when the isolation pump 132a, 132b associated with that feed line 140a, 140b is proceeding through a spray cycle.

In one example, gap controllers 134c, 134d can include diaphragms configured to expand and contract a liquid chamber to control formation of the air gaps. For example, the diaphragms can be pulled to expand the liquid chamber and draw liquid out of feed lines 140a, 140b and into gap controllers 134c, 134d, thereby generating the downstream air gaps in feed lines 140a, 140b. The diaphragms can be pushed to contact the liquid chamber and push liquid out of gap controllers 134c, 134d into feed lines 140a, 140b, thereby removing the downstream air gaps. While gap controllers 134c, 134d are described as including diaphragms, it is understood that gap controllers 134c, 134d can be of any type suitable for drawing liquid out of feed lines 140a, 140b to create the downstream air gaps and for pushing the fluid back into feed lines 140a, 140b to remove the downstream air gaps. For example, gap controllers 134c, 134d can include pistons.

While gap controllers 134c, 134d are shows as in-line between feed valves 138a, 138b and spray valves 142a, 142b, it is understood that gap controllers 134c, 134d can be placed at any desired location relative to feed lines 140a, 140b that is suitable for generating and removing the downstream air gaps. For example, gap controllers 134c, 134d can be connected to feed lines 140a, 140b by branch lines extending off of feed lines 140a, 140b.

Spray valves 142a, 142b are disposed on the downstream sides of gap controllers 134c, 134d, respectively. Spray valves 142a, 142b are actively controlled between respective open states, to allow liquid flow through gap controllers 134c, 134d to supply line 120, and closed states, to prevent liquid flow through gap controllers 134c, 134d to supply line 120. For example, spray valves 142a, 142b can be pneumatically-actuated valves. Supply line 120 extends from spray valves 142a, 142b to electrostatic sprayer 122 to provide liquid to electrostatic sprayer 122 for spraying.

Line sensors 144a, 144b are disposed on fill lines 130a, 130b, respectively, and are configured to generate and provide flow data regarding any liquid in fill lines 130a, 130b to control module 114. Line sensors 144c, 144d are disposed on feed lines 140a, 140b, respectively, and are configured to generate and provide flow data regarding any liquid in feed lines 140a, 140b to control module 114. Line sensors 144a-144d can be of any type suitable for sensing liquid in fill lines 130a, 130b and/or feed lines 140a, 140b while maintain electrical isolation from earth ground. For example, line sensors 144a-144b can be configured to provide one or more of a flow rate, a flow status (such as whether liquid is currently flowing in fill lines 130a, 130b and/or feed lines 140a, 140b), and/or a liquid status (such as whether liquid is currently present in fill lines 130a, 130b and/or feed lines 140a, 140b), among other options. In one example, line sensors 144a-144d are fiber optic sensors. Fill lines 130a, 130b and feed lines 140a, 140b can be made from a suitably transparent material to facilitate external mounting of fiber optic sensors. It is understood, however, that line sensor 144a-144d can be of any type suitable for generating flow data regarding the liquid in fill lines 130a, 130b and feed lines 140a, 140b. Line sensors 144a-144d can provide the flow data to control module 114.

During operation, supply modules 112a, 112b are controlled such that one supply module 112a, 112b is providing liquid to electrostatic sprayer 122 while the other supply module 112a, 112b is refilling with liquid in preparation for supplying the liquid to electrostatic sprayer 122. The supply module 112a, 112b that is providing liquid to electrostatic sprayer 122 is electrically isolated from main reservoir 116 by an upstream air gap within fill line 130a, 130b. The supply module 112a, 112b that is being filled with liquid is electrically isolated from charged fluid by a downstream air gap within feed line 140a, 140b.

An example of electrostatic spray system 110 providing a continuous supply of liquid to electrostatic sprayer 122 will be discussed in detail. As shown in FIG. 4A, supply module 112a is initially in a spray cycle and supply module 112b is initially in a fill cycle. A first upstream air gap UG1 is disposed in fill line 130a between isolation pump 132a and inlet valve 124a. Inlet valve 124a is closed to prevent liquid from reservoir line 118 from entering fill line 130a. Gap controller 134a is in a pulled state such that any fluid that was in fill line 130a is removed from fill line 130a and is stored in the liquid chamber of gap controller 134a. The first upstream air gap UG1 was formed by gap controller 134a when gap controller 134a transitioned to the pulled state. Vent valve 126a is open to allow the air to flow into fill line 130a and form the first upstream air gap UG1. Pump outlet valve 148a, feed valve 138a, and spray valve 142a are all open to fluidly connect isolation pump 132a with supply line 120 and thus with electrostatic sprayer 122.

Control module 114 actuates isolation pump 132a to cause isolation pump 132a to drive the liquid out of liquid chamber 150a. For example, control module 114 can cause a solenoid to shift positions such that the solenoid directs compressed air to isolation pump 132a to drive the fluid displacement member of isolation pump 132a. The liquid is driven downstream through feed line 140a to supply line 120. Gap controller 134c is initially in a pushed state and is maintained idle during the spray cycle. The liquid flows through gap controller 134c between feed line 140a and supply line 120. The liquid flows downstream through supply line 120 and is sprayed by electrostatic sprayer 122. During the spray cycle, isolation pump 132a is electrically charged due to the liquid connection between isolation pump 132a and electrostatic sprayer 122. However, the first upstream air gap UG1 isolates any charged components from shorting to earth ground.

Spray module 112b is initially in the refill cycle. A second downstream air gap DG2 is disposed in feed line 140b between gap controller 134d and feed valve 138b. Feed valve 138b is closed to prevent liquid from entering feed line 140b. Gap controller 134d is in a pulled state such that any fluid that was in feed line 140b was removed from feed line 140b and is stored in the liquid chamber of gap controller 134d. Gap controller 134d thereby formed the second downstream air gap DG2 when gap controller 134d transitioned to the pulled state. Vent valve 126d is open to allow the air to flow into feed line 140b and form the second downstream air gap DG2. Pump outlet valve 148b, feed valve 138b, and spray valve 142b are all closed to maintain the second downstream air gap DG2 and electrically isolate isolation pump 132a from supply line 120. The second downstream air gap DG2 electrically isolates those components connected to earth ground potential from charged components.

Gap controller 134b is in the pushed state such that the air that has previously formed a second upstream air gap UG2 in fill line 130b has been removed from fill line 130b. For example, the air can be stored in vent 128b or can be vented to atmosphere through vent 128b. During the fill cycle, vent valve 126b is closed, inlet valve 124b is open, and pump inlet valve 146b is open. The upstream liquid pressure within reservoir line 118 drives the liquid through inlet valve 124b, fill line 130b, and pump inlet valve 146b and into liquid chamber 150b. The liquid fills liquid chamber 150b until isolation pump 132b is full. Status sensor 152b can sense when liquid chamber 150b of isolation pump 132b is full and can provide that status data to control module 114. Control module 114 can stop the liquid flow to isolation pump 132b and cause supply module 112b to enter a primed state based on status sensor 152b indicating that isolation pump 132b is full.

In FIG. 4B, control module 114 causes formation of the second upstream air gap UG2 to electrically isolate isolation pump 132b from main reservoir 116. Isolation pump 132b is still electrically isolated from the charged liquid by the second downstream air gap DG2. Supply module 112a continues to supply liquid to electrostatic sprayer 122 as supply module 112b is primed.

To prime supply module 112b, control module 114 causes inlet valve 124b to shift to the closed state and causes vent valve 126b to shift to the open state. For example, control module 114 can cause an actuator 159, such as a solenoid valve, to shift positions and direct compressed air to and/or from vent valve 126b and inlet valve 124b to cause the shift. In some examples, vent valve 126b and inlet valve 124b share a common spool that is shifted between positions to connect one of reservoir line 118 or vent 128b with fill line 130b. With inlet valve 124b in the closed state, fill line 130b is fluidly isolated from reservoir line 118 such that the liquid from main reservoir 116 cannot flow into fill line 130b. With vent valve 126b in the open state, vent 128b is fluidly connected to fill line 130b.

Control module 114 generates a pull command to cause gap controller 134b to transition from the pushed state to the pulled state. For example, control module 114 can provide the pull command to an actuator 159, such as a solenoid valve, to cause the actuator 159 to shift positions and direct compressed air to gap controller 134b to cause gap controller 134b to transition to the pulled state. The displacement member of gap controller 134b, such as a diaphragm or piston, is retracted to increase the volume of the liquid chamber of gap controller 134b. Gap controller 134b pulls the liquid in fill line 130b into the liquid chamber, thereby removing the liquid from fill line 130b. As the liquid is pulled into gap controller 134b, air is drawn into fill line 130b from vent 128b. The air fills fill line 130b, thereby generating the second upstream air gap UG2 within fill line 130b between isolation pump 132b and inlet valve 124b. Second upstream air gap UG2 electrically isolates isolation pump 132b from main reservoir 116. In addition, gap controller 134b actively pulling the liquid out of fill line 130b and actively pulling the air into fill line 130b prevents an undesired conduction path from forming in fill line 130b. Line sensor 144b is configured to sense when fill line 130b is devoid of liquid and can provide that flow data to control module 114.

With electrostatic spray system 110 in the state shown in FIG. 4B, isolation pump 132b is electrically isolated from main reservoir 116 by the second upstream air gap UG2, isolation pump 132b is electrically isolated from electrostatic sprayer 122 by the second downstream air gap DG2, isolation pump 132a is electrically isolated from main reservoir 116 by the first upstream air gap UG1, and isolation pump 132a is electrically connected to electrostatic sprayer 122 by the liquid conduction path through feed line 140a and supply line 120.

With isolation pump 132b electrically isolated from main reservoir 116, control module 114 causes electrostatic spray system 110 to enter the state shown in FIG. 4C. Control module 114 generates a push command and causes gap controller 134d to transition from the pulled state to the pushed state. For example, control module 114 can provide the push command to an actuator 159, such as a solenoid valve, to cause the actuator 159 to shift positions and direct compressed air to gap controller 134d to cause gap controller 134d to transition to the pushed state. The fluid displacement member of gap controller 134d drives the liquid contained within its liquid chamber up through feed line 140b, thereby driving the second downstream air gap DG2 out of feed line 140b. The air forming the second downstream air gap DG2 flows through vent valve 126d and to vent 128d, where the air can be stored for later use or vented to atmosphere. Removal of the second downstream air gap DG2 can be confirmed by line sensor 144d sensing that liquid is present in feed line 140b. Line sensor 144d can communicate that flow data to control module 114.

With the second downstream air gap DG2 removed from feed line 140b, control module 114 causes each of pump outlet valve 148b and feed valve 138b to shift to their respective open states. Control module 114 can also activate isolation pump 132b, such as by causing an actuator 159 to direct compressed air to isolation pump 132b. Activating isolation pump 132b causes isolation pump 132b to drive liquid out of liquid chamber 150b and through feed line 140b to spray valve 142b. As such, a conduction path is created from isolation pump 132b through feed line 140b and to spray valve 142b. Supply module 112b is thus in a primed state and ready to provide liquid to electrostatic sprayer 122.

Supply module 112a continues to supply liquid to electrostatic sprayer 122 until status sensor 152a senses that the volume of liquid in isolation pump 132a is at or near empty. Status sensor 152a can provide that status data to control module 114. In FIG. 4D, isolation pump 132a is empty and supply module 112b begins supplying liquid to electrostatic sprayer 122. Control module 114 causes spray valve 142b to shift to an open state, thereby opening a fluid path between feed line 140b and supply line 120. Compressed air is directed to isolation pump 132b to cause isolation pump 132b to drive the liquid downstream through supply line 120 to electrostatic sprayer 122. Control module 114 also causes spray valve 142a to shift to a closed state, thereby preventing liquid in supply line 120 from backflowing into feed line 140a.

With spray valve 142a closed and spray module 112b providing liquid to electrostatic sprayer 122, control module 114 causes electrostatic supply system 110 to enter the state shown in FIG. 4E. Feed valve 138a shifts to a closed state, thereby closing the fluid path between isolation pump 132a and feed line 140a. Vent valve 126c shifts to an open state, thereby opening a fluid path between feed line 140a and vent 128c. For example, control module 114 can cause one or more actuators 159, such as solenoid valves, to shift position to direct compressed air to and/or from feed valve 138a and vent valve 126c to cause feed valve 138a and vent valve 126c to change states.

Control module 114 generates a pull command to cause gap controller 134c to transition from the pushed state to the pulled state. For example, control module 114 can provide the pull command to an actuator 159, such as a solenoid valve, to cause the actuator 159 to shift positions and direct compressed air to gap controller 134c to cause gap controller 134c to transition to the pulled state. The displacement member of gap controller 134c, such as a diaphragm or piston, is retracted, which increases the volume of the liquid chamber of gap controller 134c. Gap controller 134c pulls the liquid in feed line 140a into the liquid chamber, thereby removing the liquid from feed line 140a. As the liquid is pulled into gap controller 134c, air is drawn into feed line 140a from vent 128c. The air fills feed line 140a, thereby generating the first downstream air gap DG1 within feed line 140a. First downstream air gap DG1 electrically isolates isolation pump 132a from charged components of electrostatic spray system 110, such as supply line 120 and spray valve 142a. In addition, gap controller 134c actively pulling the liquid out of feed line 140a and actively pulling the air into feed line 140a ensures that liquid is fully evacuated from feed line 140a, thereby preventing an undesired conduction path from forming in feed line 140a. Line sensor 144c can sense when feed line 140c is devoid of liquid and can provide that flow data to control module 114.

With electrostatic spray system 110 in the state shown in FIG. 4E, isolation pump 132a is electrically isolated from main reservoir 116 by the first upstream air gap UG1, isolation pump 132a is electrically isolated from electrostatic sprayer 122 by the first downstream air gap DG1, isolation pump 132b is electrically isolated from main reservoir 116 by the second upstream air gap UG2, and isolation pump 132b is electrically connected to electrostatic sprayer 122 by the liquid conduction path through feed line 140b and supply line 120.

In FIG. 4F, control module 114 causes supply module 112a to enter the fill state and refill isolation pump 132a with liquid from main reservoir 116. Control module 114 generates a push command to cause gap controller 134a to transition from the pulled state to the pushed state. For example, control module 114 can provide the push command to an actuator 159, such as a solenoid valve, to cause the actuator 159 to shift positions and direct compressed air to gap controller 134a to drive gap controller 134a to the pushed state. Gap controller 134a drives the liquid contained within its liquid chamber up through fill line 130a, thereby removing the first upstream air gap UG1. The air forming the first upstream air gap UG1 flows through vent valve 126a and to vent 128a, where the air can be stored for later use or vented to atmosphere. Removal of the first upstream air gap UG1 can be confirmed by line sensor 144a sensing that liquid is present in fill line 130a. Line sensor 144a can communicate that flow data to control module 114. A conduction path is thereby formed between isolation pump 132a and earth ground potential. Isolation pump 132a remains electrically isolated from the charged fluid by the first downstream air gap DG1.

In FIG. 4G, isolation pump 132a is refilled with liquid from main reservoir 116 while isolation pump 132b continues to supply liquid to electrostatic sprayer 122 for spraying. Control module 114 causes inlet valve 124a to shift to an open state and vent valve 126a to shift to a closed state. A fluid path is thereby opened between main reservoir 116 and isolation pump 132. Control module 114 also causes pump inlet valve 146a to shift to an open state. The upstream liquid pressure within reservoir line 118 drives the liquid through inlet valve 124a, fill line 130a, and pump inlet valve 146a and into liquid chamber 150a. The liquid fills liquid chamber 150a until isolation pump 132a is full. Status sensor 152a can sense when liquid chamber 150a is full and can provides that status data to control module 114. Control module 114 can end the fill cycle of isolation pump 132a based on the data from status sensor 152a indicated that the liquid chamber 150a is full.

In FIG. 4H, control module 114 causes electrical isolation of isolation pump 132a from main reservoir 116 before generating any conduction path between isolation pump 132a and any charged liquid. Control module 114 causes pump inlet valve 146a to shift to a closed state, such as by commanding an actuator 159, such as a solenoid valve, to shift positions to direct compressed air to or from pump inlet valve 146a to cause pump inlet valve 146a to shift states.

Control module 114 further generates a pull command to cause gap controller 134a to transition from the pushed state to the pulled state. For example, control module 114 can provide the pull command to an actuator 159, such as a solenoid valve, to cause the actuator 159 to shift positions and direct compressed air to gap controller 134a to cause gap controller 134a to transition to the pulled state. The displacement member of gap controller 134a, such as a diaphragm or piston, is retracted, which increases the volume of the liquid chamber of gap controller 134a. Gap controller 134a pulls the liquid in fill line 130a into the liquid chamber of gap controller 134a, thereby removing the liquid from fill line 130a. As the liquid is pulled into gap controller 134a, air is drawn into fill line 130a from vent 128a. The air fills fill line 130a, thereby generating the first upstream air gap UG1 within fill line 130a. First upstream air gap UG1 electrically isolates isolation pump 132a from earth ground. In addition, gap controller 134a actively pulling the liquid out of fill line 130a and actively pulling the air into fill line 130a ensures that liquid is fully evacuated from fill line 130a, thereby preventing an undesired conduction path from forming in fill line 130a. Line sensor 144a can sense when fill line 130a is devoid of liquid and can provide that flow data to control module 114.

With electrostatic spray system 110 in the state shown in FIG. 4H, isolation pump 132a is filled with liquid, isolation pump 132a is electrically isolated from main reservoir 116 by the first upstream air gap UG1, isolation pump 132a is electrically isolated from electrostatic sprayer 122 by the first downstream air gap DG1, isolation pump 132b is electrically isolated from main reservoir 116 by the second upstream air gap UG2, and isolation pump 132b is electrically connected to electrostatic sprayer 122 by the liquid conduction path through feed line 140b and supply line 120.

In FIG. 4I, supply module 112a is primed such that supply module 112a is ready to provide liquid to electrostatic sprayer 122 for spraying. Isolation pump 132a and isolation pump 132b are electrically isolated from main reservoir 116 by the first upstream air gap UG1 and the second upstream air gap UG2, respectively. Control module 114 generates a push command and causes gap controller 134c to transition from the pulled state to the pushed state. For example, control module 114 can provide the push command to an actuator 159, such as a solenoid valve, to cause the actuator 159 to shift positions and direct compressed air to gap controller 134c to cause gap controller 134c to transition to the pushed state. Gap controller 134c drives the liquid contained within its liquid chamber up through feed line 140a, thereby removing the first downstream air gap DG1. The air forming the first downstream air gap DG1 flows through vent valve 126c and to vent 128c, where the air can be stored for later use or vented to atmosphere. Removal of the first downstream air gap DG1 can be confirmed by line sensor 144c sensing that liquid is present in feed line 140a. Line sensor 144c can communicate that flow data to control module 114.

With the first downstream air gap DG1 removed, control module 114 causes each of pump outlet valve 148a and feed valve 138a to shift to their respective open states. Control module 114 can also activate isolation pump 132a to drive liquid out of liquid chamber 150a and through feed line 140a to spray valve 142a. As such, a conduction path is created from isolation pump 132a through feed line 140a and to spray valve 142a. Supply module 112a is thus primed and ready to provide liquid to electrostatic sprayer 122.

In FIG. 4J, supply module 112b continues to supply liquid to electrostatic sprayer 122. Status sensor 152b senses when the liquid volume in isolation pump 132b is at or near empty and provide that flow data to control module 114. With isolation pump 132b emptied, control module 114 causes spray valve 142a to open, thereby opening a fluid path between feed line 140a and supply line 120. Control module 114 also activates isolation pump 132a, such as by causing an actuator 159 to direct compressed air to isolation pump 132a, such that isolation pump 132a drives the liquid downstream through supply line 120 to electrostatic sprayer 122. Control module 114 also causes spray valve 142b to shift to a closed state, thereby preventing liquid in supply line 120 from backflowing into feed line 140b.

With spray valve 142b closed and spray module 112a providing liquid to electrostatic sprayer 122, control module 114 causes electrostatic supply system 110 to enter the state shown in FIG. 4K. Control module 114 causes feed valve 138b to shift to a closed state, thereby closing the fluid path between isolation pump 132b and feed line 140b. Control module 114 also causes vent valve 126d to shift to an open state, thereby opening a fluid path between feed line 140b and vent 128d. For example, control module 114 can cause one or more actuators 159, such as solenoid valves, to shift position and direct compressed air to and/or from feed valve 138b and vent valve 126d to cause feed valve 138b and vent valve 126d to change states.

Control module 114 generates a pull command to cause gap controller 134d to transition from the pushed state to the pulled state. For example, control module 114 can provide the pull command to an actuator 159, such as a solenoid valve, to cause the actuator 159 to shift positions and direct compressed air to gap controller 134d to cause gap controller 134d to transition to the pulled state. The displacement member of gap controller 134d, such as a diaphragm or piston, is retracted, which increases the volume of the liquid chamber of gap controller 134d. Gap controller 134d pulls the liquid in feed line 140b into the liquid chamber, thereby removing the liquid from feed line 140b. As the liquid is pulled into gap controller 134d, air is drawn into feed line 140b from vent 128d. The air fills feed line 140b, thereby generating the second downstream air gap DG2 within feed line 140b. The second downstream air gap DG2 electrically isolates isolation pump 132b from charged components of electrostatic spray system 110, such as supply line 120 and spray valve 142b. In addition, gap controller 134d actively pulling the liquid out of feed line 140b and actively pulling the air into feed line 140b ensures that liquid is fully evacuated from feed line 140b, thereby preventing an undesired conduction path from forming in feed line 140b. Line sensor 144d can sense when feed line 140d is devoid of liquid and can provide that flow data to control module 114.

With electrostatic spray system 110 in the state shown in FIG. 4K, isolation pump 132a is electrically isolated from main reservoir 116 by the first upstream air gap UG1, isolation pump 132a is electrically connected to electrostatic sprayer 122 by the liquid conduction path through feed line 140a and supply line 120, isolation pump 132b is electrically isolated from main reservoir 116 by the second upstream air gap UG2, and isolation pump 132b is electrically isolated from electrostatic sprayer 122 by the second downstream air gap DG2.

In FIG. 4L, control module 114 causes supply module 112b to enter the fill state. Control module 114 generates a push command to cause gap controller 134b to transition from the pulled state to the pushed state. For example, control module 114 can provide the push command to an actuator 159, such as a solenoid valve, to cause the solenoid valve to shift positions and direct compressed air to gap controller 134b to cause gap controller 134b to transition to the pushed state. Gap controller 134b drives the liquid contained within its liquid chamber up through fill line 130b, thereby removing the second upstream air gap UG2 from fill line 130b. The air forming the second upstream air gap UG2 flows through vent valve 126b and to vent 128b, where the air can be stored for later use or vented to atmosphere. Removal of the second upstream air gap UG2 can be confirmed by line sensor 144b sensing that liquid is present in fill line 130b. Line sensor 144b can communicate that flow data to control module 114. As such, a conduction path is formed between isolation pump 132b and earth ground potential at main reservoir 116. Isolation pump 132b is electrically isolated from the charged fluid by the first downstream air gap DG1. Electrostatic spray system 110 can then transition back to the state shown in FIG. 4A, where liquid from main reservoir 116 flows to isolation pump 132b to refill isolation pump 132b and supply module 112a provides liquid to electrostatic sprayer 122.

Electrostatic spray system 110 provides significant advantages. Electrostatic spray system 110 provides a continuous supply of spray liquid to electrostatic sprayer 122. As such, the user does not need to shut downs the system to refill any supply tank during the spray process. Providing a continuous supply of spray liquid increases efficiency and reduces downtime. Electrostatic spray system 110 electrically isolates any charged liquid from earth ground potential throughout the entire spray process. The charged liquid is electrically isolated by shifting the location of non-conductive air gaps between locations upstream and downstream of isolation pumps 132a, 132b. The upstream air gaps electrically isolate isolation pumps 132a, 132b from earth ground potential. The downstream air gaps electrically isolate isolation pumps 132a, 132b from charged liquid. At least one of the upstream and downstream air gaps is present in supply modules 112a, 112b to ensure that no conduction path is generated between the charged liquid and earth ground potential. Gap controllers 134a-134d actively draw liquid out of the various lines, thereby ensuring that residual liquid does not remain in the lines, which could create an undesired conduction path. Control module 114 ensures that the air gaps are maintained such that a conduction path is not created between the electrostatic sprayer 122 and earth ground potential. Electrostatic spray system 110 provides a continuous supply of liquid to electrostatic sprayer 122 without requiring the stoppage of any spray activity.

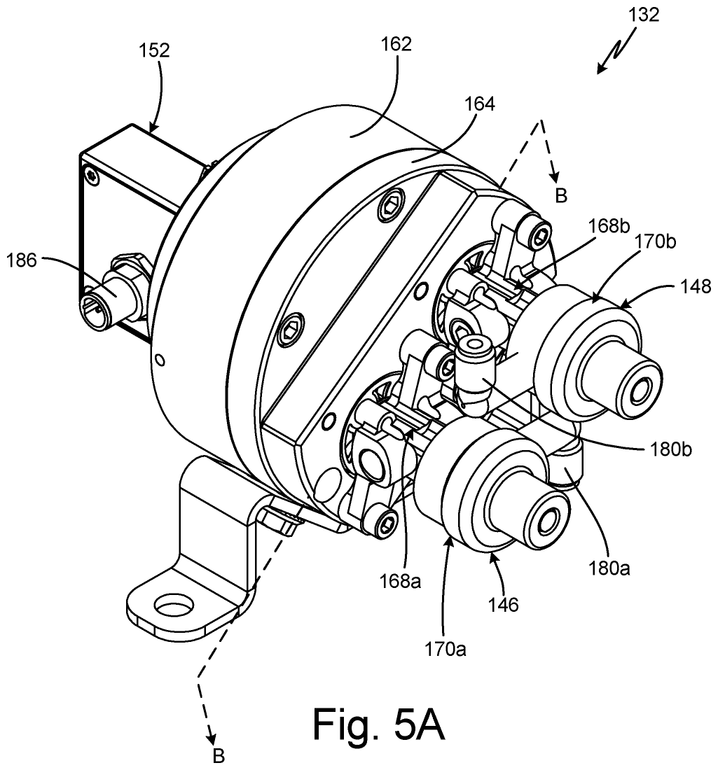

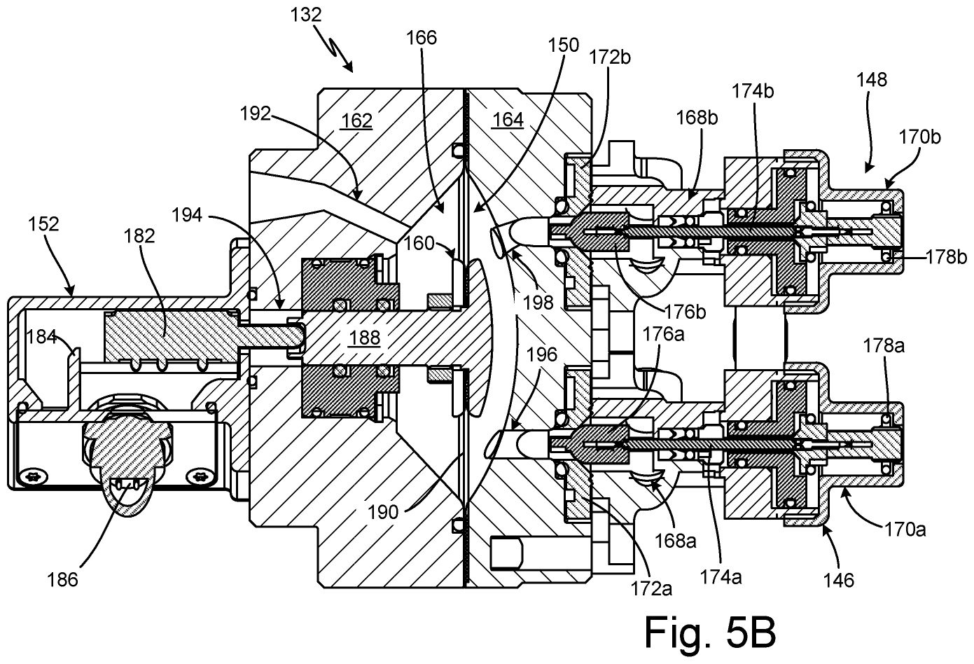

FIG. 5A is an isometric view of isolation pump 132. FIG. 5B is a cross-sectional view of isolation pump 132 taken along line B-B in FIG. 5A. FIGS. 5A and 5B will be discussed together. Isolation pump 132 is substantially similar to isolation pumps 132a, 132b (FIGS. 4A-4L). Isolation pump 132 includes pump inlet valve 146, pump outlet valve 148, liquid chamber 150, status sensor 152, fluid displacement member 160, body 162, cover plate 164, and working fluid chamber 166. Pump inlet valve 146 includes wet portion 168a, dry portion 170a, seat 172a, stem 174a, sealing member 176a, spring 178a, and connector 180a. Pump outlet valve 148a similarly includes wet portion 168b, dry portion 170b, seat 172b, stem 174b, sealing member 176b, spring 178b, and connector 180b. Status sensor 152 includes slide 182, stop 184, and port 186. Fluid displacement member 160 includes shaft 188 and diaphragm 190. Body 162 includes working fluid inlet 192 and shaft bore 194. Cover plate 164 includes material inlet 196 and material outlet 198.

Cover plate 164 is attached to body 162, and diaphragm 190 is disposed between cover plate 164 and body 162. Liquid chamber 150 is disposed between and defined by cover plate 164 and diaphragm 190. Working fluid chamber 166 is disposed between and defined by body 162 and diaphragm 190. Working fluid inlet 192 extends through body 162 and is fluidly connected to working fluid chamber 166. Working fluid inlet 192 is configured to receive a working fluid, such as compressed air, from a fluid source to drive fluid displacement member 160 in a forward/pushed direction towards cover plate 164.

Shaft 188 is attached to and follows diaphragm 190, and shaft 188 extends through shaft bore 194 in body 162. Status sensor 152 is attached to body 162 opposite working fluid chamber 166. Slide 182 is disposed in status sensor 152 and abuts a distal end of shaft 188. Stop 184 delimits an extent of travel for slide 182. Port 186 is configured to receive a sensor, such as a fiber optic member, that generates information regarding the position of slide 182. The information regarding the position of slide corresponds to the displacement of fluid displacement member 160, due to the connection of shaft 188 and slide 182, and thus to the volume of liquid in liquid chamber 150. As such, status sensor 152 can be a linear transducer. Status sensor 152 is configured to maintain the electrical isolation of isolation pump 132a from earth ground potential.

Pump inlet valve 146 is attached to cover plate 164 at material inlet 196. Seat 172a is disposed between wet portion 168a and cover plate 164a. Stem 174a extends from wet portion 168a and into dry portion 170a. Sealing member 176a is attached to stem 174a in wet portion 168a and is disposed adjacent seat 172a. Sealing member 176a is configured to engage with seat 172a when pump inlet valve 146 is in a closed position and is configured to be displaced from seat 172a, creating a flow path into liquid chamber 150a, when pump inlet valve 146 is in an open position. Connector 180a extends from dry portion 170a and is configured to be connected to an actuation line that provides compressed air to pump inlet valve 146 to actuate pump inlet valve 146. Connector 180a provides the compressed air to and vents the compressed air from dry portion 170a to drive stem 174a and sealing member 176a between the closed and open positions. Spring 178a is disposed in dry portion 170a and is configured to drive stem 174a and sealing member 176a to the closed position when the compressed air is removed from dry portion 170a. While pump inlet valve 146 is shown as a needle valve, it is understood that pump inlet valve 146 can be any desired valve capable of being actively controlled between the open position and the closed position.

Pump outlet valve 148 is attached to cover plate 164 at material outlet 198. Seat 172b is disposed between wet portion 168b and cover plate 164b. Stem 174b extends from wet portion 168b and into dry portion 170b, and sealing member 176b is attached to stem 174b and disposed adjacent seat 172b. Sealing member 176b is configured to engage with seat 172b when pump outlet valve 148 is in a closed position and is configured to be displaced from seat 172b when pump outlet valve 148 is in an open position. Connector 180b extends from dry portion 170b and is configured to be connected to an actuation line that provides compressed air to pump outlet valve 148 to actuate pump outlet valve 148. Connector 180b provides the compressed air to and vents the compressed air from dry portion 170b to drive stem 174b and sealing member 176b between the closed and open positions. Spring 178b is disposed in dry portion 170b and is configured to drive stem 174b and sealing member 176b to the closed position when the compressed air is removed from dry portion 170b. While pump outlet valve 148 is shown as a needle valve, it is understood that pump outlet valve 148 can be any desired valve capable of being actively controlled between the open position and the closed position.

In some examples, pump outlet valve 148 is identical to pump inlet valve 146, except pump outlet valve 148 is connected to material outlet 198, such that wet portion 168b receives material from liquid chamber 150, while pump inlet valve 146 is connected to material inlet 196, such that wet portion 168a provides material to liquid chamber 150. While pump outlet valve 148 and pump inlet valve 146 can be identical, thereby facilitating easy replacement of parts while requiring fewer unique parts, it is understood that each of pump inlet valve 146 and pump outlet valve 148 can be of any desired configuration and can be or identical or differing configurations.

When isolation pump 132a is refilled, compressed air is provided to dry portion 170a of pump inlet valve 146, causing stem 174a and sealing member 176a to shift away from seat 172a. Compressed air is vented from dry portion 170b of pump outlet valve 148 to cause pump outlet valve 148 to shift to the closed positon. Sealing member 176a disengaging from seat 172a opens an inlet flowpath between sealing member 176a and seat 172a. The upstream pressure in main reservoir 116 (FIGS. 4A-4L) drives the liquid into liquid chamber 150 through pump inlet valve 146 and material inlet 196. The liquid pressure of the liquid flowing into liquid chamber 150 drives fluid displacement member 160 rearward as liquid chamber 150 expands. Fluid displacement member 160 shifting rearward drives shaft 188 rearward due to the connection of shaft 188 with fluid displacement member 160. Shaft 188 simultaneously drives slide 182 rearward. Shaft 188 and slide 182 continue to shift rearward until slide 182 abuts stop 184, which delimits an extent of travel for slide 182 in the rearward direction. Status sensor 152 can be configured to generate a status signal based on the volume of liquid in liquid chamber 150 based on the changing position of slide 182. The sensor mounted at port 186, such as a fiber optic sensor, senses the changing position of slide 182 and generates the status signal based on that changing position. Status sensor 40 can provide status data to control module 114 (FIGS. 4A-4L) to indicate the volume of liquid in liquid chamber 150. Control module 114 can remove the supply of compressed air from pump inlet valve 146 to cause pump inlet valve 146 to shift back to the closed position based on isolation pump 132 being refilled.

The control module can cause isolation pump 132a to drive liquid downstream. Pump inlet valve 146 is in the closed position and pump outlet valve 148 is shifted to the open position. For example, control module 114 can cause an actuator 159 (FIGS. 4A-4L), such as a solenoid valve, to shift positions and direct compressed air to dry portion 170b of pump outlet valve 148, causing stem 174b and sealing member 176b to shift away from seat 172 to an open position. The liquid can thus flow out of liquid chamber 150a through the flowpath created between sealing member 176b and seat 172b.

To drive the liquid out of liquid chamber 150, working fluid, such as compressed air, is provided to working fluid chamber 166 through working fluid inlet 192. The working fluid drives fluid displacement member 160 in the forward direction through liquid chamber 150. The working fluid drives fluid displacement member 160, and fluid displacement member 160 drives the liquid downstream out of liquid chamber 150 and to electrostatic sprayer 122 (FIGS. 4A-4L).

The working fluid drives fluid displacement member 160 in the forward direction. Fluid displacement member 160 pulls shaft 188 through shaft bore 194 due to the connection of shaft 188 and fluid displacement member 160. Shaft 188 pulls slide 182 in the forward direction due to the connection of shaft 188 and slide 182. Status sensor 152 senses the volume of liquid in liquid chamber 150 and can provide that status data to control module 114. When slide 182 reaches a forward extent of travel, indicating that liquid chamber 150 is devoid or nearly devoid of liquid, the control module 114 can initiate a new refill cycle for isolation pump 132a. Status sensor 152 can continuously provide positional information to control module 114 such that the control module 114 provides the fill command based on slide 182 reaching any desired position.

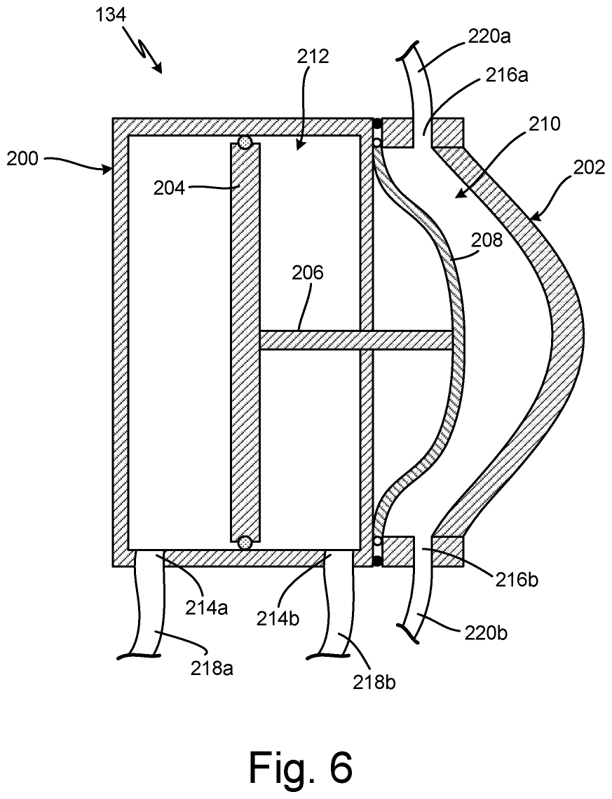

FIG. 6 is a cross-sectional view of gap controller 134. Gap controller 134 is substantially similar to gap controllers 134a-134d (FIGS. 4A-4L). Gap controller 134 includes body 200, cover plate 202, actuator 204, shaft 206, fluid displacement member 208, liquid chamber 210, and drive chamber 212. Body 200 includes drive openings 214a, 214b. Cover plate 202 includes flow openings 216a, 216b.

Cover plate 202 is attached to body 200. Body 200 defines drive chamber 212. Actuator 204 is disposed in drive chamber 212 within body 200 and is configured to reciprocate within drive chamber 212. Shaft 206 extends from actuator 204 and is connected to fluid displacement member 208. Fluid displacement member 208 is retained between cover plate 202 and body 200. Liquid chamber 210 is defined between fluid displacement member 208 and cover plate 202. In the example shown fluid displacement member 208 is a diaphragm. It is understood, however, that fluid displacement member 208 can be of any type suitable for expanding and contracting the volume of liquid chamber 210, such as a piston, for example.

Drive openings 214a, 214b extend through body 200 and are in communication with drive chamber 212. Air line 218a is connected to body 200 at drive opening 214a and is configured to provide compressed air, or another suitable motive fluid, to drive chamber 212 of body 200. Air line 218b is connected to body 200 at drive opening 214b and is configured to provide compressed air, or another suitable motive fluid, to drive chamber 212 of body 200.

Flow openings 216a, 216b extend through cover plate 202 and are in fluid communication with liquid chamber 210. Liquid line 220a is connected to cover plate 202 at flow opening 216a. Liquid line 220b is connected to cover plate 202 at flow opening 216b. A valve, such as check valves 136a, 136b (FIGS. 4A-4L) or spray valves 142a, 142b (FIGS. 4A-4L) can be disposed at flow openings 216b and/or downstream of flow opening 216b.

During operation, compressed air is provided to drive chamber 212 through air line 218a and drive opening 214a to drive actuator 204 in a first direction. Actuator 204 pushes shaft 206 and thus fluid displacement member 208 as actuator 204 moves in the first direction. Fluid displacement member 208 decreases the volume of liquid chamber 210, thereby driving any liquid in liquid chamber 210 out of liquid chamber 210, as discussed in more detail above. Gap controller 134 is configured such that liquid can still flow through liquid chamber 210 between flow openings 216a, 216b when fluid displacement member 208 is fully forward (e.g., in a pushed state). As such, gap controller 134 can be disposed in-line on a flow line such that liquid flowing through the flow line flows through gap controller 134.

To generate the air gaps upstream of gap controller 134, within liquid line 220a, compressed air is provided to drive chamber 212 through air line 218b and drive opening 214b. The compressed air drives actuator 204 in a second direction, opposite the first direction. Actuator 204 pulls shaft 206 and thus fluid displacement member 208 as actuator 204 moves in the second direction. Fluid displacement member 208 increases the volume of liquid chamber 210, thereby pulling any liquid in liquid line 220a into liquid chamber 210, as discussed in more detail above. The air gap is thereby created in liquid line 220a.

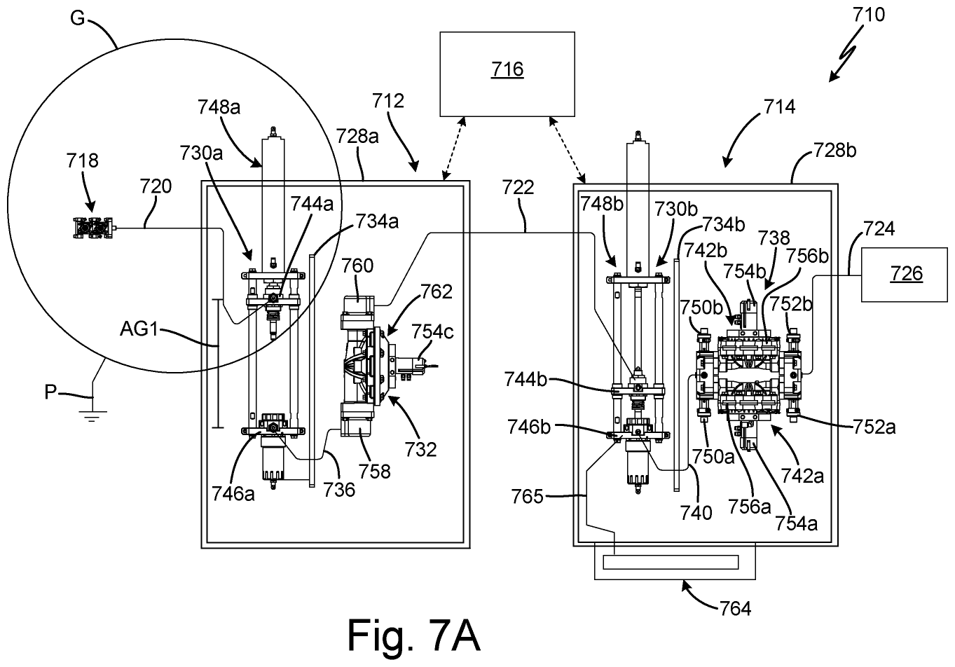

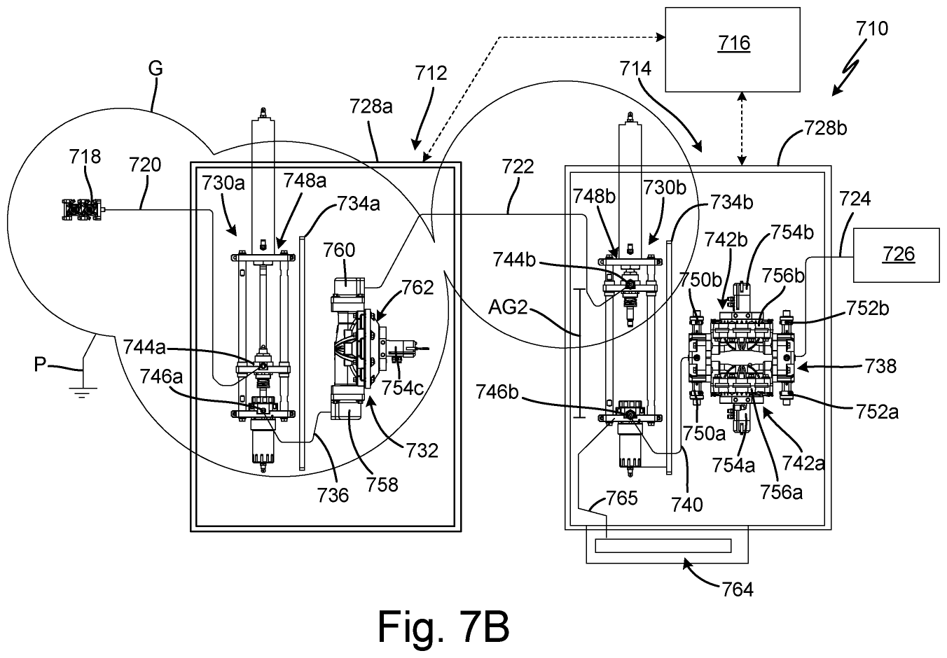

FIG. 7A is a schematic diagram of electrostatic spray system 710 in a first state. FIG. 7B is a schematic diagram of electrostatic spray system 710 in a second state. Electrostatic spray system 710 includes feed module 712, supply module 714, control module 716, liquid source 718, reservoir line 720, feed line 722, supply line 724, electrostatic sprayer 726, and power source 764. Feed module 712 includes feed housing 728a, gap controller 730a, feed pump 732, barrier 734a, and inlet line 736. Supply module 714 includes supply housing 728b, gap controller 730b, supply assembly 738, barrier 734b, and fill line 740. Supply assembly 738 includes isolation pumps 742a, 742b. Gap controllers 730a, 730b respectively include inlet modules 744a, 744b; outlet modules 746a, 746b; and actuators 748a, 748b. Isolation pumps 742a, 742b respectively include fill valves 750a, 750b; dispense valves 752a, 752b; status sensors 754a, 754b; and pump housings 756a, 756b. Feed pump 732 includes status sensor 754c, inlet valve 758, outlet valve 760, and pump housing 762.

Electrostatic spray system 710 is configured to atomize and spray a charged liquid, such as water and water-based coatings. For example, electrostatic spray system 710 can be configured to spray with a charge in the range of 50-120 kilovolts (kV). More specifically, electrostatic spray system can be configured to spray with a charge in the range of 60-100 kV. It is understood, however, that electrostatic spray system 710 can be configured to spray at any desired charge. The charged droplets are directed towards an object to coat the object with the droplets. Electrostatic spray system 710 provides a continuous supply of the liquid to electrostatic sprayer 726 for application, while isolating the charged components from earth ground. In one example, electrostatic spray system 710 can be utilized for generating droplets for spray chilling, such as spray chilling of foodstuffs.

Electrostatic spray system 710 is substantially similar to electrostatic spray system 10 (FIG. 1A) and electrostatic spray system 110 (FIGS. 4A-4L). Gap controllers 730a, 730b generate air gaps AG1, AG2 to electrically isolate charged components from earth ground potential P. Gap controllers 730a, 730b can also be referred to as isolation valves. Grounded components are shown as disposed within grounded region G. Feed module 712 supplies refill liquid to supply module 714. Supply assembly 738 stores supplies of charged liquid and drives the charged liquid to electrostatic sprayers 726. In some examples, the pressure generated by supply assembly 738 causes the liquid spraying at electrostatic sprayers 726. Isolation pumps 742a, 742b of supply assembly 738 alternatingly supply liquid to electrostatic sprayers 726. In the example shown, isolation pumps 742a, 742b are mounted together to form a single assembly. It is understood however, that isolation pumps 742a, 742b can be mounted in any desired configuration. One of isolation pumps 742a, 742b is supplying the liquid while the other one of isolation pumps 742a, 742b is refilled by feed pump 732. Electrostatic spray system 710 provides a continuous liquid flow to electrostatic sprayers 726 for continuous spraying.

Control module 716 is configured to control the flow of liquid between liquid source 718 and supply module 714 during spraying to ensure a continuous supply of charged liquid. Control module 716 can control operation of any one or more of feed pump 732, isolation pumps 742a, 742b, and gap controllers 730a, 730b. Control module 716 can be configured to control operation of electrostatic spray system 710 based on signals generated by status sensors 754a-754c. Control module 716 can be configured to control electrostatic spray system 710 between the first state shown in FIG. 7A, which can also be referred to as a supply state, and the second state shown in FIG. 7B, which can also be referred to as a fill state, based on the signals from one or more of status sensors 754a-754c. Control module 716 is configured to perform any of the functions discussed herein, including receiving an output from any sensor referenced herein, detecting any condition or event referenced herein, and controlling operation of any components referenced herein. Control module 716 can be of any suitable configuration for controlling operation electrostatic spray system 710. For example, control module 716 can be configured to control operation based on pneumatic and/or fiber optic signals. Control module 716 can include pneumatic and/or electronic circuitry. Control module 716 is electrically isolated from feed module 712 and supply module 714.

Control module 716 can include pneumatic circuitry configured to control switching of fill valves 750a, 750b, dispense valves 752a, 752b, and gap controllers 730a, 730b. The pneumatic circuitry can provide signals indicating the states of feed pump 732, isolation pump 742a, and/or isolation pump 742b. Control module 716 can be configured to receive and process fiberoptic signals. Control module 716 can generate data base don fiberoptic signals. Control module 716 can include logic hardware and further firmware, software, and/or other logic instructions. Control module 716 can include control circuitry configured to store software, implement functionality, and/or process instructions. The circuitry can be entirely or partially mounted on one or more boards. In some examples, control module 716 can be implemented as a plurality of discrete circuitry subassemblies. Control module 716 can include a memory that can be described as computer-readable storage media.

Liquid source 718 can receive liquid from and/or store a bulk supply of the liquid for application by electrostatic spray system 710. Liquid source 718 is connected to earth ground potential P. Liquid source 718 provides an upstream water pressure to drive liquid through reservoir line 720 and to feed module 712. Liquid source 718 can be a storage tank, a pressurized tank, the water grid, etc.

Reservoir line 720 extends from liquid source 718 to feed module 712 to provide liquid to feed module 712. Feed module 712 is configured to store a refill supply of liquid that can be provided to supply module 714 as needed to maintain the supply of liquid in supply module 714. Feed line 722 extends between feed module 712 and supply module 714 to provide liquid to supply module 714. Supply line 724 extends from supply module 714 to electrostatic sprayers 726 to provide charged liquid to electrostatic sprayers 726 from supply module 714 during spraying. Because the spray liquid is charged, the liquid in supply module 714 is also charged due to the conductive nature of the liquid.

Power source 764 is mounted to supply module 714 and provides the charge to the liquid. In the example shown, power source 764 is directly electrically connected to outlet module 746b by pathway 765, thereby charging each component electrically connected to outlet module 746b. While power source 764 is shown as mounted to supply module 714, it is understood that power source 764 can be located at any desired location suitable for charging the spray liquid. It is further understood that while the charge is shown as being applied at outlet module 746b, the charge can be applied at any location downstream of the air gap AG2. For example, the charge can be provided at outlet module 760b, at isolation pumps 742a, 742b, at a location intermediate supply assembly 738 and electrostatic sprayer 726, or at electrostatic sprayers 726, among other locations. The conductivity of the liquid charges those components downstream of whichever air gap AG1, AG2 is in place.

Feed housing 728a contains components of feed module 712. Feed housing 728a can be formed from non-conductive material to isolate components of feed module 712 from earth ground potential. Gap controller 730a is disposed at least partially within feed housing 728a and is fluidly connected to liquid source 718 by reservoir line 720 and to feed pump 732 by inlet line 736. Inlet module 744 is connected to inlet line 736 and is thus always electrically connected to earth ground potential P. Outlet module 746a is connected to inlet line 736. Actuator 748a interfaces with inlet module 744a in the example shown. Actuator 748a is configured to displace inlet module 744a relative outlet module 746a to generate and close air gap AG1. Actuator 748a can be pneumatically and/or mechanically powered, among other options.

Gap controller 730a is controllable between an isolated state and a connected state. Gap controller 730a is in the isolated state (FIG. 7A) when inlet module 744a is spaced from outlet module 746a and air gap AG1 is formed therebetween. Gap controller 730a is in a connected state (FIG. 7B) when inlet module 744a is connected to outlet module 746a, forming a fluid path between liquid source 718 and feed pump 732 through gap controller 730a. Feed pump 732 is electrically isolated from earth ground potential P when gap controller 730a is in the isolated state and electrically connected to earth ground potential P when gap controller 730a in the connected state. Barrier 734a is disposed between gap controller 730a and feed pump 732 to further electrically isolate charged and grounded components of feed module 712.

Feed pump 732 is configured to store a supply of liquid and to pump the liquid to isolation pumps 742a, 742b to refill isolation pumps 742a. Inlet line 736 is connected to inlet valve 758. Feed line 722 extends from outlet valve 760 to supply module 714. Inlet valve 758 is disposed on an upstream side of pump housing 762. Outlet valve 760 is disposed on a downstream side of pump housing 762. Feed pump 732 can be an air operated pump. In some examples, feed pump 732 is an air operated diaphragm pump. Status sensor 754c is operatively associated with the fluid displacement member of feed pump 732. Status sensor 754c can be mounted to pump housing 762. Status sensor 754c is configured to generate signals regarding the fluid displacement member of feed pump 732. The signals can provide data regarding an estimated volume of liquid remaining in feed pump 732. For example, status sensor 754c can include a pneumatic sensor configured to indicate when feed pump 732 is one of empty and full. Status sensor 754c can additionally or alternatively include a fiberoptic sensor. The fiber optic sensor can sense displacement of the fluid displacement member. Control module 716 can be configured to determine the volume of liquid remaining in feed pump 732, the volume dispensed during a refill of isolation pump 742a, 742b, and other information regarding feed pump 732 based on the data provided by the fiber optic sensor.

Supply module 714 is configured to provide a continuous supply of charged liquid to electrostatic sprayers. Supply housing 728b at least partially encloses the components of supply module 714. Supply housing 728b can be formed from non-conductive material to electrically isolate components of supply module 714. Barrier 734b is disposed between gap controller 730b and supply assembly 738 to provide electrical isolation when air gap AG2 is present. Gap controller 730b is disposed at least partially within supply housing 728b. Gap controller 730b is substantially similar to gap controller 730a and is configured to selectively generate air gap AG2. Gap controller 730b is controllable between an isolated state and a connected state. Gap controller 730b is configured to form air gap AG2 when in the isolated state and to form a fluid connection between feed pump 732 and isolation pumps 742a, 742b when in the connected state.

Supply assembly 738 is configured to receive liquid from feed pump 732, store a supply of the liquid, and drive the liquid downstream from supply module 714. Isolation pumps 742a, 742b are disposed within supply housing 728b. Isolation pumps 742a, 742b are electrically connected to power source 764 such that isolation pumps 742a, 742b are charged whenever a charge is provided by power source 764. Each component downstream of air gap AG2 is charged whenever a charge is provided to the liquid. Isolation pumps 742a, 742b are not electrically grounded throughout operation. Isolation pumps 742a, 742b are configured to pump the charged liquid downstream to electrostatic sprayers 726. Isolation pumps 742a, 742b are independently controllable to generate the continuous liquid flow. Isolation pumps 742a, 742b can be of any configuration suitable for isolating from earth ground potential and pumping charged fluid. For example, isolation pumps 742a, 742b can be air operated pumps. In some examples, isolation pumps 742a, 742b are air operated diaphragm pumps.

Fill line 740 extends from outlet module 746b to each of fill valves 750a, 750b. Fill valves 750a, 750b are actively controlled valves that are controlled between an open state and a closed state. Dispense valves 752a, 752b are disposed on the downstream side of the fluid chamber of each isolation pump 742a, 742b. Dispense valves 752a, 752b are actively controlled valves that are controlled between an open state and a closed state. Fill valves 750a, 750b and dispense valves 752a, 752b can be actively controlled in any desired manner. In some examples, fill valves 750a, 750b and dispense valves 752a, 752b can be pneumatically actuated. In some examples, fill valves 750a, 750b and dispense valves 752a, 752b are normally closed. Supply line 724 is connected to receive fluid from dispense valves 752a, 752b. Supply line 724 extends to one or more electrostatic sprayers 726.

Status sensors 754a, 754b are associated with isolation pumps 742a, 742b, respectively, and are configured to generate signals regarding the positions of the fluid displacement members of isolation pumps 742a, 742b. For example, each of status sensors 754a, 754b can include a pneumatic sensor and/or a fiberoptic sensor, as discussed in more detail below. In some examples, the pneumatic sensor can indicate when the fluid chamber of isolation pump 742a, 742b is full and/or empty. The fiberoptic sensor can sense displacement of the fluid displacement member and/or a position of the fluid displacement member, which signals can provide the volume of liquid remaining and the volume dispensed. The signals can indicate the state of each isolation pump 742a, 742b. For example, the signals can indicate the state of the pump as the pump transitions between a dispense state, a refill state, and a primed state.

Isolation pump 742a, 742b is in a dispense state when dispense valve 752a, 752b is open and fill valve 750a is closed. Isolation pump 742a, 742b is in a refill state when dispense valve 752a, 752b is closed and fill valve 750a, 750b is open. Isolation pump 742a, 742b is in a primed state when dispense valve 752a, 752b is closed and fill valve 750a, 750b is closed.

During operation, electrostatic spray system 710 provides a continuous supply of conductive liquid from the grounded liquid source 718 to the charged electrostatic sprayers 726 while maintaining electrical isolation between charged components and earth ground potential P. For purposes of example, electrostatic spray system 710 is assumed to initially be in the first state shown in FIG. 7A. Gap controller 730b is in the connected state and gap controller 730a is in the isolated state. As such, each component in the fluid path downstream of air gap AG1 is charged. The components in area G are electrically grounded.

Isolation pumps 742a, 742b are configured to alternatingly pump fluid to electrostatic sprayers 726. In the example shown in FIG. 7A, isolation pump 742a is initially in the dispense state and isolation pump 742b is initially in the primed state. Isolation pump 742a pumps liquid until a refill of isolation pump 742a is initiated, such as based on signals from status sensor 754a. In some examples, the fill valve 750a is actuated to an open state, dispense valve 752a is actuated to a closed state, and dispense valve 752b is actuated to an open state based on isolation pump 742a requiring a refill. Isolation pump 742a is fluidly connected to feed pump 732 and fills with liquid from feed pump 732. Isolation pump 742b is fluidly connected to supply line 724 and pumps fluid to electrostatic sprayers 726. Isolation pump 742a is in the refill state and isolation pump 742b is in the dispense state.

During the refill of isolation pump 742a, the upstream pressure generated by feed pump 732 drives fluid into isolation pump 742a through the open fill valve 750a. Isolation pump 742a continues to fill until isolation pump 742a reaches a full state. For example, status sensor 754a can indicate that isolation pump 742a has completed the refill. When the refill is complete, fill valve 750a is actuated back to the closed state. Isolation pump 742a is thus fluidly disconnected from inlet line 736 and supply line 724. Isolation pump 742a can be primed by pressurizing the liquid in isolation pump 742a with the fluid displacement member of isolation pump 742a. For example, a working fluid source can be fluidly connected to a pressure chamber of isolation pump 742a after isolation pump completes the refill. The working fluid causes the fluid displacement member to exert pressure on the liquid in isolation pump 742a. Priming isolation pump 742a facilitates quick reaction when dispense valve 752a is opened, avoiding pulsation and providing continuous, even flow at electrostatic sprayers 726. Isolation pump 742a is thus in the primed state. It is understood that the liquid can be pressurized by isolation pump 742a with isolation pump 742a in the priming state or once in the dispense state.

Isolation pump 742a remains in the primed state until isolation pump 742b requires a refill. Status sensor 754b generates a signal indicating that isolation pump 742b requires a refill. Isolation pump 742b transitions to the refill state and isolation pump 742a transitions to the dispense state. As isolation pump 742b refills, isolation pump 742a pumps the liquid to electrostatic sprayers 726. Isolation pump 742b fills and enters the primed state prior to isolation pump 742a fully depleting its liquid supply.

Supply assembly 738 proceeds through dispense cycles to provide the continuous flow. During a dispense cycle, each of isolation pump 742a and isolation pump 742b proceed through a refill state. Each isolation pump 742a, 742b completes a dispense cycle for one dispense cycle of supply assembly 738. As such, a dispense cycle of supply assembly 738 includes two dispense cycles by isolation pumps 742a, 742b. Isolation pumps 742a, 742b continue to cycle between states such that one of isolation pumps 742a, 742b is always in the dispense state. Isolation pumps 742a, 742b have a greater fill rate than dispense rate such that isolation pump 742a, 742b proceeds through the refill process and enters the primed state prior to the other one of isolation pumps 742a, 742b proceeding completing a dispense cycle. The continuous flow facilitates continuous spraying by electrostatic sprayers 726.

Electrostatic spray system 710 can operate in supply mode until feed pump 732 requires refill. Feed pump 732 has a volume greater than the volume of any one isolation pump 742a, 742b. Feed pump 732 can have a volume at least two times the volume of an isolation pump 742a, 742b. For example, feed pump 732 can refill each of isolation pump 742a and isolation pump 742b after respective dispense cycles before feed pump 732 requires a refill. It is understood that feed pump 732 can have a volume up to three, four, five, six, or more times greater than the volume of an isolation pump 742a, 742b. Feed pump 732 is sized such that feed pump 732 can provide liquid for multiple dispense cycles of isolation pumps 742a, 742b and such that the fill rate of feed pump 732 is greater than the dispense rate of an isolation pump 742a, 742b. Feed pump 732 can be configured to complete a refill cycle quicker than an isolation pump 742a, 742b completes a dispense cycle.

Electrostatic spray system 710 transitions to the fill state, feed pump 732 is refilled, and electrostatic spray system 710 transitions back to the supply state before isolation pumps 742a, 742b run dry. Feed pump 732 is sized relative isolation pumps 742a, 742b such that feed pump 732 can provide liquid for at least one dispense cycle of supply assembly 738. For example, feed pump 732 can refill isolation pump 742a and then refill isolation pump 742b prior to feed pump 732 requiring a refill. Feed pump 732 requires fewer refills than isolation pumps 742a, 742b. Transitions between the supply state and the fill state are thereby minimized.

Status sensor 754c can indicate that feed pump 732 requires a refill. Status sensor 754c can generate signals based on a position of the fluid displacement member of feed pump 732. In some examples, control module 716 is configured to determine the volume of liquid dispensed by feed pump 732 during each refill cycle of either one of isolation pumps 742a, 742b based on signals from status sensor 754c. Control module 716 can track the volume remaining in feed pump 732 and control filling of feed pump 732 based on that volume information.

Control module 716 can control electrostatic spray system 710 between the fill state and the supply stated based on feed pump 732 requiring a refill. In some examples, control module 716 can control the state of electrostatic spray system 710 based on a comparison of the liquid volume dispensed during each refill of an isolation pump 742a, 742b and the volume remaining in feed pump 732. In some examples, control module 716 can be configured to control electrostatic spray system 710 such that electrostatic spray system 710 transitions to the fill state after a changeover and refill of one of isolation pumps 742a, 742b and prior to feed pump 732 fully emptying. For example, control module 716 can initiate a refill based on the volume of liquid in feed pump 732 being between 1-2 times the volume required to fill an isolation pump 742a, 742b. In some examples, the refill can be initiated based on the volume remaining being less than or equal to the volume required to fill an isolation pump 742a, 742b. In some examples, the refill of feed pump 732 can be initiated based on a cycle count. For example, feed pump 732 can refill after every two, three, four, five, or more refill cycles of isolation pumps 742a, 742b. The cycle count can be generated based on signals from status sensors 754a, 754b, among other options.

To transition to the fill state, air gap AG1 is removed and air gap AG2 is formed to electrically isolate feed pump 732 from charged components. Air gap AG1 is removed after air gap AG2 is formed to prevent a conduction path forming between charged and grounded components. With AG2 formed and AG1 removed, feed pump 732 is electrically connected to earth ground potential P and electrically disconnected from charged components. Area G in FIG. 7B shows the grounded components with electrostatic spray system 710 in the fill state. The pressure upstream of feed module 712 drives the liquid through gap controller 730a and inlet valve 758 and into feed pump 732. The upstream pressure can be generated by the liquid source 718 or intermediate pumping components. It is understood, however, that feed pump 732 can be configured to draw the liquid into feed pump 732, such as by driving a fluid displacement member through a suction stroke.

Gap controller 730b shifts from the connected state shown in FIG. 7A to the isolated state shown in FIG. 7B. Air gap AG2 is formed between inlet module 744b and outlet module 746b, electrically isolating the inlet module 744b and outlet module 746b. Gap controller 730a shifts from the isolated state shown in FIG. 7A to the connected state shown in FIG. 7B. With gap controller 730a in the connected state a fluid path is formed between liquid source 718 and feed pump 732 through gap controller 730. In the example shown, gap controllers 730a, 730b include inlet modules 744a, 744b configured to physically shift relative outlet modules 746a, 746b to generate air gaps AG1, AG2. It is understood, however, that the air gaps AG1, AG2 can be formed in any desired manner. For example, fluid tubes formed from material and/or having a coating on the interior that causes water and water-based liquids to bead/shed off of the interior of the line can be utilized to form the air gasp AG1, AG2. For example, gap controllers 730a, 730b can be tubes formed from fluorinated ethylene propylene (FEP) and/or coated with a hydrophobic coating. Air can be driven through the tube to form air gaps AG1, AG2. Air gaps AG1, AG2 can be formed in any manner suitable for selectively providing a fluid path and an air gap sufficient for electrical isolation.

Feed pump 732 continues to fill until reaching a full state. Status sensor 754c can generate signals to indicate when feed pump 732 reaches the full state. With feed pump 732 full, control module 716 can cause electrostatic spray system 710 to transition from the fill state to the supply state. Air gap AG1 is formed. Air gap AG1 is formed by gap controller 730a transitioning from the connected state shown in FIG. 7B to the isolated state shown in FIG. 7A. Air gap AG1 is formed between inlet module 744a and outlet module 746a, electrically isolating the grounded liquid source 718 from the component downstream of air gap AG1.

Air gap AG2 is removed after air gap AG1 is formed. Gap controller 730b shifts from the isolated state shown in FIG. 7B to the connected state shown in FIG. 7A. Gap controller 730b thereby fluidly connects feed pump 732 and isolation pumps 742a, 742b. The components upstream of gap controller 730b and downstream of air gap AG1 become charged due to the conductive nature of the liquid. Feed pump 732 can be primed to provide immediate pumping pressure whenever the next one of fill valves 750a, 750b opens. Priming feed pump 732 pressurizes the fluid path between feed pump 732 and fill valves 750a, 750b. In some examples, the fluid displacement member of feed pump 732 can be preloaded to prime feed pump 732. For example, an working fluid charge can be provided to a working fluid chamber of feed pump 732 to prime feed pump 732. For example, feed pump 732 can be primed with compressed air. Feed pump 732 is thus in a primed state and ready to drive liquid to isolation pumps 742a, 742b when isolation pump 742a, 742b enters a refill state.

Electrostatic spray system 710 provides a continuous flow of charged fluid for spraying. Electrostatic spray system 710 provides significant advantages. Electrostatic spray system 710 provides a continuous supply of spray liquid to electrostatic sprayers 726. As such, the user does not need to shut down the system to refill a supply tank during the spray process. Providing a continuous supply of spray liquid increases efficiency and decreased downtime. Electrostatic spray system 710 electrically isolates any charged liquid from earth ground potential throughout spraying. The electrical isolation facilitates connection to a grounded source, such as a water grid. The charged liquid is electrically isolated by shifting the location of non-conductive air gaps between a location upstream of a refill reservoir formed by feed pump 732 and a location downstream of the refill reservoir. The downstream air gap AG2 electrically isolates the feed pump 732 from charged fluid when feed pump 732 is refilled from the grounded liquid source 718. The upstream air gap AG1 electrically isolates feed pump 732 from earth ground potential when feed pump 732 is electrically connected to charged fluid.

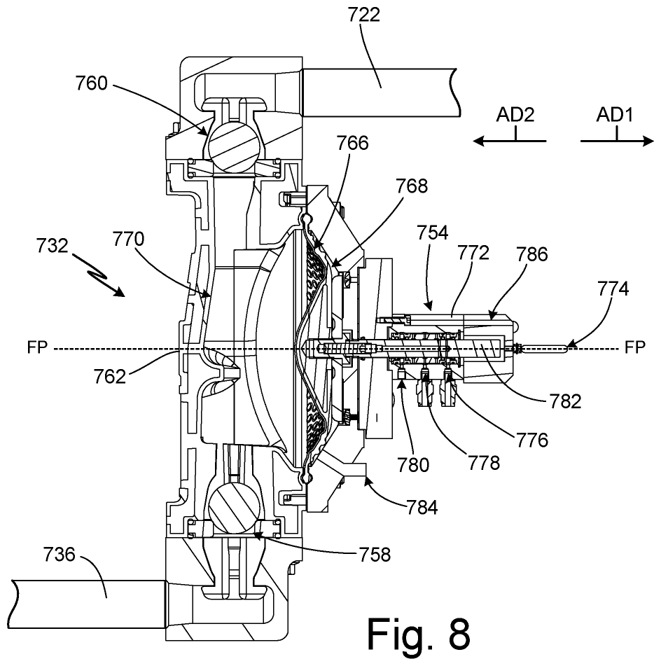

FIG. 8 is a cross-sectional view of feed pump 732. Feed pump 732 includes status sensor 754, inlet valve 758, outlet valve 760, pump housing 762, fluid displacement member 766, pressure chamber 768, pumping chamber 770, and working fluid port 784. Status sensor 754 includes sensor housing 772, displacement sensor 774, pressure port 776, pilot port 778, vent port 780, and sensor shaft 782.

Feed pump 732 is configured to store a supply of liquid in pumping chamber 770 and drive that liquid downstream to refill isolation pumps 742a, 742b. Fluid displacement member 766 is disposed between and fluidly separates pressure chamber 768 and pumping chamber 770. Feed pump 732 is shown in a full state, with pumping chamber 770 at a maximum volume and pressure chamber 768 at a minimum volume. Inlet valve 758 is disposed on an upstream side of pumping chamber 770. Outlet valve 760 is disposed on a downstream side of pumping chamber 770. Pumping chamber 770 forms a reservoir for storing a supply of refill liquid for filling isolation pumps 742a, 742b. Feed pump 732 can be considered to form a feed reservoir of feed module 712. Working fluid port 784 extends through pump housing 762 to pressure chamber 768 and is configured to provide working fluid to and/or allow working fluid to vent from pressure chamber 768.

Fluid displacement member 766 is configured to reciprocate along a pump axis FP-FP. Fluid displacement member 766 is shown as a diaphragm, but it is understood that fluid displacement member 766 can be of any configuration suitable of pumping the charged fluid to isolation pumps 742a, 742b. For example, fluid displacement member 766 can be a piston, among other options.

Status sensor 754 is associated with fluid displacement member 766. Status sensor 754 is configured to provide information regarding the status of feed pump 732, such when feed pump requires refill, has been refilled, the volume of liquid remaining, among other options. The volume of liquid remaining in pumping chamber 770 can be determined based on the signals from status sensor 754. Status sensor 754 is configured to generate signals based on the position of fluid displacement member 766. Status sensor 754 can generate signals based on the position of sensor shaft 782.

Sensor shaft 782 extends rearward from fluid displacement member 766 and into bore 786 disposed in sensor housing 772. Sensor shaft 782 is connected to fluid displacement member 766 such that sensor shaft 782 shifts axially with fluid displacement member 766.

Status sensor 754 can generate pneumatic signals. Pressure port 776 is connected to an air source to provide pilot air to status sensor 754. Pilot port 778 is connected to a pilot line. The status signal can be generated pneumatically based on whether the pilot line is pressurized or depressurized. Vent port 780 is connected to exhaust to vent air from the pilot line. Sensor shaft 782 includes internal pathways to fluidly connect pressure port 776 and pilot port 778 when feed pump 732 is full. The internal pathways fluidly connect pilot port 778 and vent port 780 when feed pump 732 requires refill. Status sensor 754 is configured such that pilot port 778 remains pressurized as sensor shaft 782 shifts in second axial direction AD2 as feed pump 732 dispenses liquid. Pilot port 778 depressurizing can initiate a refill cycle for feed pump 732. Pilot port 778 depressurizing can thereby cause electrostatic spray system 710 to transition from the supply state to the fill state. Electrostatic spray system 710 transitions to the supply state based on pilot port 778 pressurizing.

Status sensor 754 can generate signals based on the linear displacement of sensor shaft 782. Displacement sensor 774 is configured to sense displacement of sensor shaft 782. Displacement sensor 774 is configured to generate data regarding displacement of sensor shaft 782. Displacement of sensor shaft 782 is correlated to the changing volume of pumping chamber 770 as feed pump 732 fills and dispenses liquid. In some examples, displacement sensor can be a fiberoptic position sensor. For example, the fiberoptic sensor can be configured to generate data regarding a distance to an end of sensor shaft 782. It is understood, however, that displacement sensor 774 can be of any configuration suitable for generating data regarding displacement of sensor shaft 782. Displacement sensor 774 can provide data relating to the actual position of fluid displacement member, and thus of the volume of liquid remaining in pumping chamber 770. Control module 716 can control electrostatic spray system 710 based on data from displacement sensor 774. Displacement sensor 774 can generate data regarding intermediate positions of fluid displacement member 766. Control module 716 can determine a volume of liquid remaining in pumping chamber 770 based on the data from displacement sensor 774. Control module 716 can initiate refilling of feed pump 732 prior to feed pump 732 completely emptying.

During operation, a working fluid, such as compressed air, is provided to pressure chamber 768 via working fluid port 784. When a fill valve 750a, 750b of a downstream isolation pump 742a, 742b is opened, the working fluid pressure displaces fluid displacement member 766 into pumping chamber 770, driving liquid downstream from pumping chamber 770 and through outlet valve 760 into the isolation pump. The working fluid pressure in pressure chamber 768 can be maintained when the fill valve closes. Feed pump 732 remains primed for the next opening of a fill valve.

Feed pump 732 continues to dispense fluid until a refill cycle is initiated. During the refill cycle, electrostatic spray system 710 is placed in the fill state shown in FIG. 7B and feed pump 732 is refilled with liquid. The refill cycle can be initiated based on an output by status sensor 754. For example, the refill cycle can be initiated based on the actual volume of pumping chamber 770 reaching a refill volume. For example, the refill volume can be less than or equal to the volume required to refill an isolation pump 742a, 742b.

The refill cycle commences and electrostatic spray system 710 is placed in the fill state shown in FIG. 7B. The pressure chamber 768 is placed in an exhaust state allowing working fluid to be vented from pressure chamber 768. The liquid pressure upstream of feed pump 732 drives the liquid through inlet valve 758 and into pumping chamber 770. The volume of pumping chamber 770 expands and fluid displacement member 766 shifts in first axial direction AD1 through pressure chamber 768. Sensor shaft 782 shifts with fluid displacement member 766.

Electrostatic spray system 710 transitions to the supply state based on the volume of pumping chamber 770 reaching a full volume. Status sensor 754 can generate a pump full signal based on the actual volume reaching the full volume. The pump full signal can be generated pneumatically or fiber optically. The pump full signal can also cause the working fluid to be reapplied to pressure chamber 768. Feed pump 732 is primed to drive liquid to refill isolation pumps 742a, 742b.

With electrostatic spray system 710 in the supply state, feed pump 732 is fluidly connected to isolation pumps 742a, 742b. The working fluid drives fluid displacement member 766 through a pressure stroke to drive the liquid to isolation pumps 742a, 742b. Feed pump 732 continues through the dispense cycle and provides liquid to refill isolation pumps 742a, 742b until the next refill cycle is initiated.

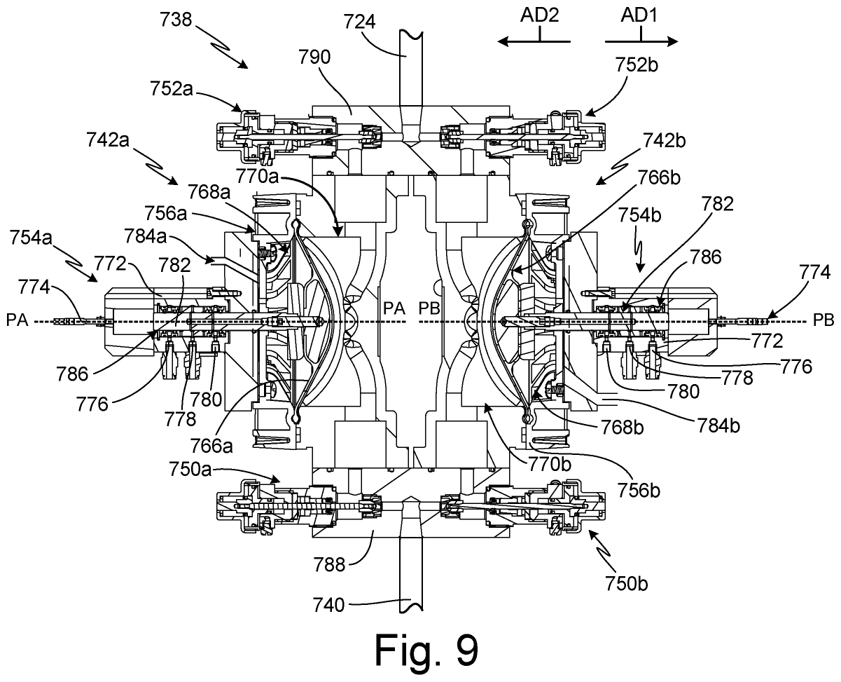

FIG. 9 is a cross-sectional view of supply assembly 738. Supply assembly 738 includes isolation pumps 742a, 742b, inlet manifold 788, and outlet manifold 790. Isolation pumps 742a, 742b respectively include fill valves 750a, 750b; dispense valves 752a, 752b; status sensors 754a, 754b; pump housings 756a, 756b; fluid displacement members 766a, 766b; pressure chambers 768a, 768b; pumping chambers 770a, 770b; and working fluid ports 784a, 784b. Each status sensor 754a, 754b includes sensor housing 772, displacement sensor 774, pressure port 776, pilot port 778, vent port 780, and sensor shaft 782. Isolation pump assembly 738 is configured to provide a continuous liquid flow. For example, isolation pump assembly 738 can provide a continuous flow of charged liquid for spraying.

Isolation pumps 742a, 742b are operated in tandem to provide the continuous liquid flow. Isolation pumps 742a, 742b are mounted between inlet manifold 788 and outlet manifold 790. Inlet manifold 788 is configured to receive liquid from an upstream source, such as feed pump 732, and provide the liquid to isolation pumps 742a, 742b. Outlet manifold 790 is configured to receive liquid from isolation pumps 742a, 742b and provide the liquid to a downstream line, such as supply line 724.

Fill valves 750a, 750b control flow into isolation pumps 742a, 742b between inlet manifold 788 and pumping chambers 770a, 770b. Dispense valves 752a, 752b control flow out of isolation pumps 742a, 742b and between pumping chambers 770a, 770b and outlet manifold 790. Fill valves 750a, 750b and dispense valves 752a, 752b are actively controlled valves that can be controlled between respective open and closed states. In some examples, one or more of fill valves 750a, 750b and dispense valves 752a, 752b include pneumatic actuators. In some examples, one or more of fill valves 750a, 750b and dispense valves 752a, 752b are normally-closed valves that open in response to pneumatic pressure and close when the pressure is removed. It is understood, however, that fill valves 750a, 750b and dispense valves 752a, 752b can of any desired configuration suitable for actively controlling flow to and from pumping chambers 770a, 770b.

Each isolation pump 742a, 742b is configured to receive, store, and dispense a supply of liquid. Isolation pumps 742a, 742b receives and stores the liquid in pumping chambers 770a, 770b. Fluid displacement members 766a, 766b are disposed between and fluidly separate pressure chambers 768a, 768b and pumping chambers 770a, 770b. Isolation pumps 742a, 742b are shown in respective empty states, where the pumping chamber 770a, 770b is at a minimum volume and pressure chamber 768a, 768b is at a maximum volume. It is understood that during normal operation only one of isolation pumps 742a, 742b is in the empty state. Isolation pumps 742a, 742b are not simultaneously in the empty state. Fill valve 750a, 750b is disposed on an upstream side of pumping chamber 770a, 770b. Dispense valve 752a, 752b is disposed on a downstream side of pumping chamber 770a, 770b. Pumping chambers 770a, 770b form reservoirs for storing charged spray liquid to facilitate continuous downstream flow. Isolation pumps 742a, 742b can be considered to form supply reservoirs.

Fluid displacement member 766a is configured to reciprocate along a pump axis PA-PA. Fluid displacement member 766b is configured to reciprocate along pump axis PB-PB. Axes PA-PA and PB-PB can be coaxial with each other. Axes PA-PA and PB-PB can be parallel. It is understood that axes PA-PA and PB-PB can be at any desired orientation relative each other. In the example shown, fluid displacement member 766a displaces towards fluid displacement member 766b during a dispense from isolation pump 742a and fluid displacement member 766a displaces away from fluid displacement member 766b during a refill of isolation pump 742a. Fluid displacement member 766a displaces in opposite axial directions relative to fluid displacement member 766b during respective dispense and refill strokes. Fluid displacement member 766a displaces in first axial direction AD1 during a dispense and second axial direction AD2 during a fill. Fluid displacement member 766b displaces in first axial direction AD1 during a fill and second axial direction AD2 during a dispense. It is understood that fluid displacement members 766a, 766b can be configured in any desired manner. For example, fluid displacement members 766a, 766b can displace in a common axial direction or in directions extending along transverse axes during both the dispense and fill strokes.

Fluid displacement member 766a, 766b is a diaphragm in the example shown. The diaphragm is captured between by pump housing 756a, 756b. It is understood, however, that fluid displacement member 766a, 766b can be of any configuration suitable for pumping charged fluid to electrostatic sprayers 726. For example, fluid displacement member 766a, 766b can be a piston, among other options.

Status sensors 754a, 754b are substantially similar to status sensor 754 (best seen in FIG. 8). Status sensors 754a, 754b are respectively configured to provide information regarding the status of isolation pumps 742a, 742b. Status sensors 754a, 754b are configured to provide information regarding the status of isolation pumps 742a, 742b. For example, status sensors 754a, 754b can indicate when the isolation pump requires refill, when the isolation pump has been refilled, the volume of liquid remaining, among other options. The volume of liquid remaining in pumping chamber 770a, 770b can be determined based on the signals from status sensor 754a, 754b. Status sensor 754a, 754b is configured to generate signals based on the position of fluid displacement member 766a, 766b. Status sensor 754a, 754b can generate signals based on the position of sensor shaft 782a, 782b.

Status sensors 754a, 754b can generate signals pneumatically and/or fiber optically. Sensor shaft 782 extends rearward from fluid displacement member 766a, 766b and into bore 786 disposed in sensor housing 772. Sensor shaft 782 is connected to fluid displacement member 766a, 766b such that sensor shaft 782 shifts axially with fluid displacement member 766a, 766b.

Sensor shaft 782 can pneumatically connect pressure port 776 and pilot port 778 when isolation pump 742a, 742b is full. The connection causes a rise in pressure in the line connected to pilot port 778, indicating that isolation pump 742 is full. Sensor shaft 782 can pneumatically connect pilot port 778 and vent port 780 when isolation pump 742 is empty. The connection depressurizes the line connected to pilot port 778, indicating that isolation pump 742a, 742b requires refill. Fill valves 750a, 750b and dispense valves 752a, 752b are controlled between open and closed states based on the signals generated by status sensors 754a, 754b. The working fluid supply to each pressure chamber 768a, 768b is also controlled based on the status of its isolation pump 742a, 742b. Displacement sensor 774 can be a fiber optic linear transducer configured to sense displacement of sensor shaft 782. The data from displacement sensor 774 can indicate the volume of liquid in pumping chamber 770a, 770b. The data from displacement sensor 774 can further indicate that isolation pump 742a, 742b is operating correctly. For example, the data from displacement sensor 774 can confirm that sensor shaft 782 is displacing when isolation pump 742a, 742b is in one of the refill state and dispense state and can confirm that sensor shaft 782 remains stationary when isolation pump 742a, 742b is in the primed state.

During operation, one of isolation pumps 742a, 742b drives charged fluid to electrostatic sprayers 726 while the other isolation pump 742a, 742b refills and is primed to begin pumping. A dispense cycle of isolation pump assembly 738 is discussed by way of example. Initially, isolation pump 742a is primed and isolation pump 742b is completing a dispense. Fill valve 750a, dispense valve 752a, and fill valve 750b are closed. Dispense valve 752b is open. Isolation pump 742a is in a primed state and isolation pump 742b is in a dispense state.

Status sensor 754b indicates when isolation pump 742b requires refill. The refill signal generated by status sensor 754b causes dispense valve 752a to open, dispense valve 752b to close, and fill valve 750b to open. The refill signal connects a vent line to working fluid port 784b to vent working fluid from pressure chamber 768b. The working fluid pressure in pressure chamber 768a of the primed isolation pump 742a drives liquid downstream through dispense valve 752a and to electrostatic sprayer 726. Pressure in inlet line 736 drives liquid through fill valve 750b and into pumping chamber 770b. Fill valve 750a is closed, fill valve 750b is open, dispense valve 752a is closed, and dispense valve 752b is open. Isolation pump 742a is in a dispense state and isolation pump 742b is in a refill state.

The upstream pressure drives liquid into pumping chamber 770b, expanding pumping chamber 770b and driving fluid displacement member 766b and sensor shaft 782 in second axial direction The pump full signal causes fill valve 750b to shift to a closed state and connects a working fluid source to pressure chamber 768b. Fill valves 750a, 750b and dispense valve 752b are closed while dispense valve 752a remains open. The working fluid charges pressure chamber 768b, thereby priming isolation pump 742b. Isolation pump 742b is in a primed state and isolation pump 742a is in a dispense state.

Isolation pump 742a continues to pump fluid to electrostatic sprayers until status sensor 754a generates a refill signal. The refill signal causes dispense valve 752b to open, dispense valve 752a to close, and fill valve 750a to open. The refill signal further causes pressure chamber 768a to connect to an exhaust=The pressure exerted by the working fluid in pressure chamber 768b of the primed isolation pump 742b drives the liquid downstream from pressure chamber 768b to electrostatic sprayers 726. The upstream pressure in inlet line 736 drives liquid into pumping chamber 770a. Fill valve 750a is open, fill valve 750b is closed, dispense valve 752a is closed, and dispense valve 752b is open. Isolation pump 742a is in a refill state and isolation pump 742b is in a dispense state.

The upstream pressure causes pumping chamber 770a to fill with liquid. Status sensor 754a generates a pump full signal to end the fill cycle for isolation pump 742a. The pump full signal causes fill valve 750a to shift to a closed state and connects a working fluid source to pressure chamber 768a. The working fluid charges pressure chamber 768a, thereby priming isolation pump 742a. Isolation pump 742a is primed to dispense the liquid when isolation pump 742b empties. Fill valves 750a, 750b and dispense valve 752a are closed while dispense valve 752b remains open. Isolation pump 742a is in a primed state and isolation pump 742b is in a dispense state. Isolation pump 742b continues to dispense liquid until status sensor 754b generates a refill signal.

Isolation pumps 742a, 742b continue to alternatingly fill and dispense to provide a continuous flow of charged liquid. Isolation pumps 742a, 742b are controlled based on the status signals generated by status sensors 754a, 754b. One of isolation pumps 742a, 742b is dispensing liquid while the other is refilling and priming Electrostatic spray system 710 is configured such that isolation pumps 742a, 742b have a greater fill rate than dispense rate. The flow rate generated by feed pump 732 is greater than the flow rate generated by isolation pumps 742a, 742b. Isolation pumps 742a, 742b are configured to proceed through the refill state and enter the primed state more quickly than the isolation pump 742a, 742b can proceed through the dispense state. Isolation pumps 742a, 742b fill more quickly than isolations pumps 742a, 742b dispense.

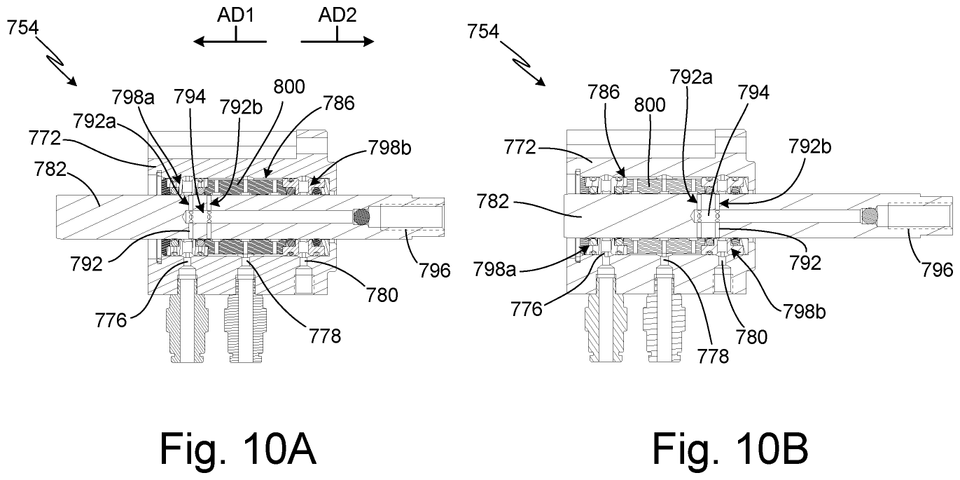

FIG. 10A is a cross-sectional view showing a pneumatic portion of status sensor 754 in a pump full state. FIG. 10B is a cross-sectional view showing a pneumatic portion of status sensor 754 in a refill state. FIGS. 10A and 10B will be discussed together. Status sensor 754 includes sensor housing 772; sensor shaft 782 having radial ports 792 forming a first array 792a and second array 792b, axial path 794, connecting portion 796; seal assemblies 798a, 798b; and spacer 800. Pilot port 778, pressure port 776, vent port 780, and axial bore 786 are formed in sensor housing 772.

Seal assembly 798a, spacer 800, and seal assembly 798b are disposed in axial bore 786. Pressure port 776 extends through sensor housing 772 and is aligned with seal assembly 798a. Seal assembly 798a seals against sensor shaft 782 and sensor housing 772 and defines a pressure chamber containing the pressurized air provided through pressure port 776. Spacer 800 is disposed axially between seal assembly 798a and seal assembly 798b. Spacer 800 includes radial pathways and can be circumferentially spaced from the inner wall of axial bore 786 to facilitate quick flow of fluid to and from pilot port 778. Seal assembly 798b is disposed within axial bore 786 on an opposite site of spacer 800 from seal assembly 798a. Vent port 780 extends through sensor housing 772 and is aligned with seal assembly 798b. Seal assembly 798b seals against sensor shaft 782 and sensor housing 772 and defines an exhaust chamber. Seal assemblies 798a, 798b prevent air from flowing to or from pressure port 776 except through sensor shaft 782.

Radial ports 792 extend radially through sensor shaft 782. In the example shown, radial ports 792 form two arrays of openings disposed about sensor shaft 782. Axial path 794 is disposed in sensor shaft 782 and fluidly connects the first array of radial ports 792a with the second array of radial ports 792b. Connecting portion 796 is configured to fix sensor shaft 782 to a fluid displacement member 766. For example, connecting portion 796 can include a threaded bore configured to receive a threaded connector. In some examples, a connector can be integrally formed with sensor shaft 782. It is understood that sensor shaft 782 can be connected to the fluid displacement member 766 in any desired manner Axial path 794 is fluidly isolated from connecting portion 796.

During operation, status sensor 754 pneumatically generates pump full and refill signals. In the pump full position (FIG. 10A), the pneumatic pathway through sensor shaft 782 connects pilot port 778 and pressure port 776. The pilot air flows through the array of radial ports 792a disposed within the pressure chamber defined by sealing assembly 738a, through axial path 794, through the second array of radial ports 792b, and through spacer 800 to pilot port 778. The pressure in the pilot line connected to pilot port 778 signals that the pump is in the pump full state.

Sensor shaft 782 displaces in the second axial direction AD2 as the pump outputs liquid. Sensor shaft 782 transitions from the position shown in FIG. 10A to the position shown in FIG. 10B. As sensor shaft 782 shifts, both arrays of radial ports 792 are disposed within spacer 800 such that the pneumatic pathway through sensor shaft 782 is fluidly connected to pilot port 778. As such, the pressurized air within the pilot line is captured and the pilot line remains pressurized until sensor shaft 782 reaches the position shown in FIG. 10B.

The pressure is vented from the pilot line when sensor shaft 782 reaches the position shown in FIG. 10B. The first array of radial ports 792a is disposed in spacer 800 and fluidly connected to pilot port 778. The second array of radial ports 792b is disposed within the exhaust chamber defined by seal assembly 798b. The pressurized fluid is vented from pilot line, through the first array of radial ports 792a, through axial path 794, through the second array of radial ports 792b, and out through vent port 780. Venting the pressure from the pilot line signals that the pump is in a refill state. The depressurization can cause the pump to enter a refill state. The pressurization can cause the pump to enter a primed state.

The pump is refilled based on the refill signal. Sensor shaft 782 displaces in first axial direction AD1 as the pump fills. Sensor shaft 782 fluidly connects pressure port 776 and pilot port 778 when sensor shaft 782 reaches the position shown in FIG. 10A. Pressurizing the pilot line indicates that the pump is full. The pressurization can cause the pump to end the refill and enter a primed state.

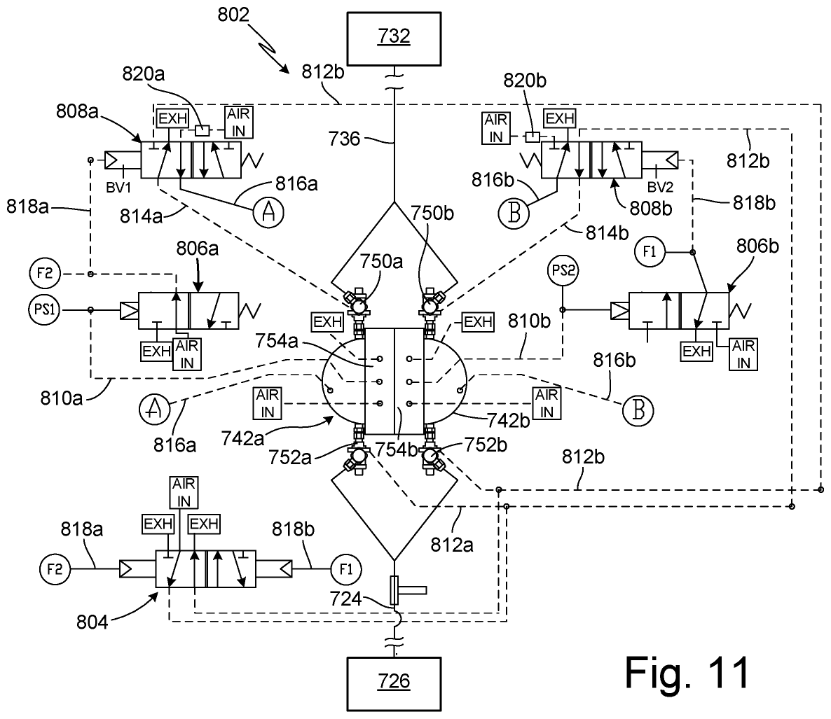

FIG. 11 is a schematic diagram of pneumatic control circuit 802 for isolation pumps 742a, 742b. Isolation pumps 742a, 742b can be configured to autonomously operate such that one isolation pump 742a, 742b is continuously connected to provide liquid to electrostatic sprayers. Isolation pumps 742a, 742b; feed pump 732; electrostatic sprayers 726, inlet line 736, and supply line 724 are shown in FIG. 11. Fill valves 750a, 750b; dispense valves 752a, 752b; and status sensors 754a, 754b of isolation pumps 742a, 742b are shown. Pneumatic circuit 802 includes control valve 804, status valves 806a, 806b; blocker valves 808a, 808b; pilot lines 810a, 810b; dispense lines 812a, 812b; fill lines 814a, 814b; pump lines 816a, 816b; and control lines 818a, 818b.

Pneumatic circuit 802 controls the opening and closing of fill valves 750a, 750b and dispense valves 752a, 752b. Pneumatic circuit 802 controls opening and closing to provide a continuous flow of charged liquid to electrostatic sprayers 726. Pneumatic circuit 802 forms part of the circuitry of control module 716. Pneumatic circuit 802 can control operation of isolation pumps 742a, 742b independent of other inputs. In the example shown, fill valves 750a, 750b and dispense valves 752a, 752b are normally closed valves. Fill valves 750a, 750b and dispense valves 752a, 752b are actuated to open states by providing pneumatic pressure to the respective valve and actuated to closed states by venting the pneumatic pressure. It is understood however, that fill valves 750a, 750b and dispense valves 752a, 752b can be of any configuration suitable for being actively controlled between the open and closed states while in a charged environment.

Pilot lines 810a, 810b extend from status sensors 754a, 754b to status valves 806a, 806b.

Pilot lines 810a, 810b are connected to status sensors 754a, 754b to be pressurized and depressurized based on the position of a control valve of status sensors 754a, 754b. Status sensors 754a, 754b are configured to maintain the pressure in pilot lines 810a, 810b until isolation pump 742a, 742b requires refill. In FIG. 11, status valve 806a is shown in the pressure state and status sensor 754b is shown in the exhaust state. Pilot line 810a is pressurized and pilot line 810b is depressurized.

Pilot lines 810a, 810b are connected to pressure sensors PS1, PS2. Control module 716 can control transitions between the supply and fill states based on the signals from pressure sensors PS1, PS2. As such, control module 716 can base the state change at least in part on the status signals from status sensors 754a, 754b. For example, control module 716 will initiate a refill for feed pump 732 based on the status signal from the status sensor 754 of feed pump 732 refill. Control module 716 can be configured to initiate the state change based on pressure sensors PS1, PS2 indicating that both pilot lines 810a, 810b are pressurized. If one of pilot lines 810a, 810b is not pressurized, then its associated isolation pump 742a, 742b is refilling and control module 816 can wait to initiate the refill of feed pump 732 until the isolation pump refill is complete. Feed pump 732 drains as isolation pumps 742a, 742b fill such that the status sensor 754 of feed pump 732 will typically indicate that refill is required when one of isolation pumps 742a, 742b is in the refill state and refilling. Control module 716 bases the state transition on the status of isolation pumps 742a, 742b and feed pump 732 to locate the refill of feed pump as early in the dispense process of the dispensing isolation pump 742a, 742b as possible. Control module 716 can be configured to initiate a transition from the supply state to the fill state based on neither isolation pump 742a, 742b being in the refill state. Control module 716 can be configured to initiate a transition from the supply state to the fill state based on both isolation pumps 742a, 742b being in one of the dispense state and the primed state.

Status valves 806a, 806b are pneumatically actuated valves configured to be actuated between a pressure state and an exhaust state. In the pressure state, status valves 806a, 806b connect a pneumatic source with control lines 818a, 818b to pressurize control lines 818a, 818b. In the exhaust state, status valves 806a, 806b connect control lines 818a, 818b with an exhaust to vent control lines 818a, 818b. Pressurizing pilot line 810a, 810b causes status valve 806a, 806b to shift to the pressure state. Venting pilot line 810a, 810b causes status valve 806a, 806b to shift to the exhaust state. Status valve 806a is shown in the pressure state and status valve 806b is shown in the exhaust state.

Control line 818a extends from status valve 806a to a pilot PB1 of blocker valve 808a and to a pilot F2 of control valve 804. Control line 818b extends from status valve 806b to a pilot PB2 of blocker valve 808b and to pilot F1 of control valve 804. Pressurizing control line 818a, 818b causing blocker valve 808a, 808b to shift to a drive state. Venting control line 818a, 818b causes blocker valve 808a, 808b to shift to a fill state. Pump lines 816a, 816b extend from blocker valve 808a, 808b to working fluid ports 784a, 784b of isolation pumps 742a, 742b. Pump lines 816a, 816b provide flowpaths for working fluid to flow to and exhaust from the pressure chambers 768a, 768b of isolation pumps 742a, 742b. An air regulator 820a, 820b can be disposed between the working fluid source and pump lines 816a, 816b. Air regulators 820a, 820b control the working fluid pressure and can control flow rate and spraying by electrostatic sprayers 820a, 820b. Fill lines 814a, 814b extend from blocker valves 808a, 808b to fill valves 750a, 750b. Fill lines 814a, 814b provide flowpaths for actuating fluid to flow to and exhaust from fill valves 750a, 750b.

In the drive state, blocker valve 808a connects a working fluid source to pump line 816a, blocks dispense line 812b, and connects fill line 814a to an exhaust. In the drive state, blocker valve 808b connects a working fluid source to pump line 816b, blocks dispense line 812a, and connects fill line 814b to an exhaust. Pump line 816a, 816b and pressure chamber 768a, 768b are pressurized and fill line 814a, 814b is depressurized. In the fill state, blocker valve 808a connects pump line 816a to the exhaust, blocks the working fluid source, and connects fill line 814a to dispense line 812b. In the fill state, blocker valve 808b connects pump line 816b to the exhaust, blocks the working fluid source, and connects fill line 814b to dispense line 812a. Pump line 816a, 816b and pressure chamber 768a, 768b are depressurized and fill line 814a, 814b is pressurized to actuate fill valve 750a, 750b to the open state. Blocker valve 808a is shown in the drive state and blocker valve 808b is shown in the fill state.

Pressurizing control line 818a, 818b provides pilot pressure to pilots F1, F2. Pilots F1, F2 act on opposite axial ends of a valve member, such as a shuttle. The pressure is balanced when each of control lines 818a, 818b are pressurized. Control valve 804 is actuated when one of control lines 818a, 818b is vented. Pressure at pilot F1 biases control valve 804 to a first dispense state and pressure at pilot F2 biases control valve 804 to a second dispense state. In the second dispense state, control valve 804 connects an air source to dispense line 812a to pressurize dispense line 812a and connects an exhaust to dispense line 812b to vent dispense line 812b. In the first dispense state, control valve 804 connects an air source to dispense line 812b to pressurize dispense line 812b and connects and exhaust to dispense line 812a to vent dispense line 812a. Control valve 804 is shown in the second dispense position.

Dispense line 812a extends from control valve 804 to dispense valve 752a and to a port of blocker valve 808b. Dispense line 812a provides actuating air to and from dispense valve 752a to actuate dispense valve 752a between the open and closed states. Blocker valve 808b fluidly connects dispense line 812a and fill line 814b with blocker valve 808b in the fill state. Dispense line 812a pressurizes fill line 814b to actuate fill valve 750b to the open state. Blocker valve 808b closes the port when in the dispense state. Dispense line 812b extends from control valve 804 to dispense valve 752b and to a port of blocker valve 808a. Dispense line 812b provides actuating air to and from dispense valve 752b to actuate dispense valve 752a between the open and closed states. Blocker valve 808a fluidly connects dispense line 812b and fill line 814a with blocker valve 808a in the fill state. Dispense line 812b pressurizes fill line 814a to actuate fill valve 750a to the open state. Blocker valve 808a closes the port when in the dispense state.

An example of a module dispense is discussed in more detail. In the example shown, isolation pump 742b has just completed a dispense state and status sensor 754b has generated a refill signal. Dispense valve 752b is initially open while dispense valve 752a and fill valves 750a, 750b are initially closed. Isolation pump 742a is in a primed state and isolation pump 742b is finishing the dispense state. Status sensor 754b vents pressure from pilot line 810b to initiate a refill of isolation pump 742b. The pressure venting from pilot line 810b causes status valve 806b to shift to the exhaust state. With status valve 806b in the exhaust state, control line 818b is fluidly connected to exhaust through status valve 806b and control line 818b is depressurized. The system shifts to the state shown in FIG. 11.

The pressure is removed from pilot F1 and from the pilot PB2 of blocker valve 808b. Control valve 804 shifts to the second state, which is shown in FIG. 11, when pressure is removed from pilot F1. Control valve 804 fluidly connects dispense line 812a with the air source and fluidly connects dispense line 812b with exhaust. Dispense line 812a is pressurized and dispense line 812b is depressurized. Dispense line 812a is pressurized to actuate dispense valve 752a to an open state. With dispense valve 752a open, the working fluid provided through blocker valve 808a and pump line 816a drives the liquid downstream out of isolation pump 742a. The pressure venting from dispense line 812b causes dispense valve 752b to actuate to a closed state.

Venting pressure from control line 818b removes pressure from the pilot PB2 of blocker valve 808b. Blocker valve 808b shifts to the fill state, connecting pump line 816b to an exhaust, blocking the working fluid source, and connecting fill line 814b to dispense line 812a. Fill line 814b is pressurized, actuating fill valve 750b to an open state. Fill valve 750a is closed, fill valve 750b is open, dispense valve 752b is closed, and dispense valve 752a is open. Isolation pump 742a is in the dispense state and isolation pump 742b is in the refill state.

The pressure in inlet line 736 upstream of isolation pumps 742a, 742b drives liquid through fill valve 750b and into isolation pump 742b. The liquid flowing into isolation pump 742b exhausts the working fluid through pump line 816b. Isolation pump 742b fills until status sensor 754b generates a pump full signal. Isolation pump 742b reaching a full state causes status sensor 754b to fluidly connect pilot air with pilot line 810b, pressurizing pilot line 810b. Pressurizing pilot line 810b actuates status valve 806b to the pressure state. Status valve 806b fluidly connects control line 818b with an air source and control line 818b is pressurized.

Pilot F1 and pilot BV2 of blocker valve 808b are pressurized. The pilot pressure at F1 balances with the pilot pressure at F2. The valve element of control valve 804 remains in the second state until pressure is removed from pilot F2. The pilot pressure to BV2 causes blocker valve 808b to actuate from the fill state to the drive state. With blocker valve 808b in the drive state, pump line 816b is connected to the working fluid source, fill valve 750b is connected to exhaust, and dispense line 812a is blocked. Venting fill line 814b returns fill valve 750b to the closed state. The working fluid source provides working fluid to isolation pump 742b to prime isolation pump 742b. Fill valves 750a, 750b are closed, dispense valve 752a is open, and dispense valve 752b is closed. Isolation pump 742a is in the dispense state and isolation pump 742b is in the primed state. Isolation pump 742b has a fill rate greater than the dispense rate of isolation pump 742a. Isolation pump 742b completes a refill and transitions to the primed state prior to isolation pump 742a completing a dispense and requiring refill.

Isolation pump 742a continues to dispense liquid until status sensor 754a indicates that isolation pump 742a requires refill. Status sensor 754a vents pilot line 810a. Pilot line 810a venting causes status valve 806a to shift to the exhaust state. Control line 818a is connected to exhaust and vents through status valve 806.

Venting control line 818a removes pilot pressure from pilot F2 and from the pilot BV1 of blocker valve 808a. With the pilot pressure at pilot F2 removed, the pilot pressure at pilot F1 causes the valve element of control valve 804 to shift to the first dispense state. Dispense line 812b is pressurized, causing dispense valve 752b to shift in an open state. Isolation pump 742b enters the dispense state and drives fluid to electrostatic sprayer 726. Dispense line 812a is connected to exhaust and vents. Dispense valve 752a shifts to a closed state.

Venting pressure from control line 818a removes pressure from the pilot PB2 of blocker valve 808a. Blocker valve 808a shifts to the fill state, connecting pump line 816a to an exhaust, blocking the working fluid source, and connecting fill line 814a to dispense line 812b. Fill line 814a is pressurized, actuating fill valve 750a to an open state. Fill valve 750b is closed, fill valve 750a is open, dispense valve 752a is closed, and dispense valve 752b is open. Isolation pump 742b is in the dispense state and isolation pump 742a is in the refill state.

The pressure in inlet line 736 upstream of isolation pumps 742a, 742b drives liquid through fill valve 750a and into isolation pump 742a. The liquid flowing into isolation pump 742a exhausts the working fluid through pump line 816a. Isolation pump 742a fills until status sensor 754a generates a pump full signal. Isolation pump 742a reaching a full state causes status sensor 754a to fluidly connect pilot air with pilot line 810a, pressurizing pilot line 810a. Pressurizing pilot line 810a actuates status valve 806a to the pressure state. Status valve 806a fluidly connects control line 818a with an air source and control line 818a is pressurized.

Pilot F2 and pilot BV1 of blocker valve 808a are pressurized. The pilot pressure at F2 balances with the pilot pressure at F1. The valve element of control valve 804 remains in the first dispense state until pressure is removed from pilot F1. The pilot pressure to BV1 causes blocker valve 808a to actuate from the fill state to the drive state. With blocker valve 808a in the drive state, pump line 816a is connected to the working fluid source, fill valve 750a is connected to exhaust, and dispense line 812b is blocked. Venting fill line 814a returns fill valve 750a to the closed state. The working fluid source provides working fluid to isolation pump 742a to prime isolation pump 742a. Fill valves 750a, 750b are closed, dispense valve 752b is open, and dispense valve 752a is closed. Isolation pump 742b is in the dispense state and isolation pump 742a is in the primed state. Isolation pump 742a has a fill rate greater than the dispense rate of isolation pump 742b. Isolation pump 742a completes a refill and transitions to the primed state prior to isolation pump 742b completing a dispense and requiring refill.

Isolation pump 742b continues to dispense liquid until status sensor 754b indicates that isolation pump 742b requires refill. Status sensor 754b vents pilot line 810b, initiating another fill cycle for isolation pump 742b and another dispense cycle for isolation pump 742a.

Pneumatic circuit 802 facilitates autonomous operation of isolation pumps 742a, 742b to provide a continuous flow of charged liquid. Pneumatic circuit 802 facilitates automatic transitions between the dispense state, fill state, and primed state for each of isolation pumps 742a, 742b. Pneumatic circuit 802 causes the emptied one of isolation pumps 742a, 742b to automatically proceed through a refill based on the isolation pump 742a, 742b reaching the end of a dispense cycle. The other one of isolation pumps 742a, 742b transitions from the primed state to the dispense state based on the first isolation pump 742a, 742b completing the dispense cycle. One of isolation pumps 742a, 742b is always in the dispense state. Pneumatic circuit 802 provides automatic continuous spray operations, requiring less user expertise, training, and input. Pneumatic circuit 802 saves time and costs and provides more efficient spraying by automatically switching to ensure a continuous spray.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A liquid supply system configured to provide a continuous supply of charged liquid to a downstream location and receive a supply of liquid from a grounded liquid source, the liquid supply system comprising:
a feed module configured to store a supply of liquid;
a supply module configured to receive the liquid from the feed module;
wherein the supply module is configured to output a continuous flow of charged liquid;
wherein the liquid supply system is configured to transition between a fill state and a supply state;
wherein the feed module is electrically connected to a grounded liquid source and electrically isolated from the supply module with the liquid supply system is in the fill state;
and wherein the feed module is electrically connected to the supply module and electrically isolated from the grounded liquid source with the liquid supply system in the supply state.

2. The liquid supply system of claim 1, wherein:
the feed module comprises:
a storage tank;
an inlet line extending from a supply valve to the storage tank;
a feed valve configured to control liquid flow from the storage tank; and
a first status sensor configured to generate information regarding a liquid level in the storage tank;
the supply module comprises:
a supply tank; and
a second status sensor configured to generate information regarding a liquid level in the supply tank;
a feed line extends from the feed valve to the storage tank; and
the liquid supply system includes control circuitry configured to initiate a fill cycle, opening the feed valve to fill supply tank, based on the information from the second status sensor, and further configured to initiate a refill cycle by transitioning the liquid supply system to the fill state based on the information from the first status sensor.

3. The liquid supply system of claim 2, wherein at least one of the first status sensor and the second status sensor includes a fiber optic sensor.

4. The liquid supply system of claim 2, further comprising:
a vent connected to the inlet line, wherein the vent is controllable between a vent open state and a closed state;
a first pneumatic line extending from a first solenoid to the supply valve; and
a second pneumatic line extending from a second solenoid to the feed valve and to the vent;
wherein the supply valve, the feed valve, and the vent are pneumatically actuated.

5. The liquid supply system of claim 1, further comprising:
an inlet line extending from a supply valve to a feed reservoir of the feed module;
wherein a first air gap is formed in the inlet line between the feed reservoir and the supply valve with the liquid supply system in the fill state, and wherein a second air gap is formed in the fill line with the liquid supply system in the supply state;
wherein the first air gap electrically isolates charged liquid in the feed module from grounded liquid at the supply valve and the second air gap electrically isolates charged liquid in the supply module from grounded liquid in the feed module.

6. The liquid supply system of claim 1, further comprising:
a first gap controller disposed between a feed reservoir of the feed module and the liquid source, wherein the first gap controller is configured to generate a first air gap between the feed reservoir and the liquid source when in the supply state.

7. The liquid supply system of claim 6, wherein the first gap controller is configured to displace a first component relative a second component to break a fluid connection and form the first air gap between the first component and the second component.

8. The liquid supply system of claim 6, wherein the first gap controller is configured draw liquid from a reservoir line that provides liquid to a storage tank of the feed module to form the first air gap within the reservoir line.

9. The liquid supply system of claim 6, further comprising:
a second gap controller disposed between the feed reservoir and a supply reservoir of the supply module, wherein the second gap controller is configured to generate a second air gap between the feed reservoir and the supply reservoir when in the fill state.

10. The liquid supply system of claim 1, wherein the supply module further comprises:
a first isolation pump configured to drive charged liquid downstream from the supply module; and
a second isolation pump configured to drive charged liquid downstream from the supply module.

11. The liquid supply system of claim 10, wherein:
the first isolation pump includes a first fill valve and a first dispense valve;
the first fill valve is an actively controlled valve; and
the first dispense valve is an actively controlled valve.

12. The liquid supply system of claim 11, wherein the supply module further comprises:
a first supply side and a second supply side configured to alternatingly drive charged liquid downstream from the supply module;
wherein the first supply side comprises:
the first isolation pump;
a first fill line extending from an upstream source to the first fill valve;
a first vent valve fluidly connected to the first fill line;
a first feed line extending from the first dispense valve to a first spray valve;
a first gap controller fluidly connected to the first fill line at a location upstream of the first isolation pump;
a second gap controller fluidly connected to the first feed line at a location upstream of the first spray valve; and
a second vent valve fluidly connected to the first feed line;
wherein the second supply side comprises:
the second isolation pump;
a second fill line extending from the upstream source to the second fill valve;
a third vent valve fluidly connected to the second fill line;
a second feed line extending from the second dispense valve to a second spray valve;
a third gap controller fluidly connected to the second fill line at a location upstream of the second isolation pump;
a fourth gap controller fluidly connected to the second feed line at a location upstream of the second spray valve; and
a fourth vent valve fluidly connected to the first feed line.

13. The liquid supply system of claim 10, wherein the first isolation pump is configured to store and dispense a first supply of charged liquid, and the second isolation pump is configured to store and dispense a second supply of charged liquid.

14. The liquid supply system of claim 13, wherein at least one isolation pump of the first isolation pump and the second isolation pump is in a dispense state such that the dispense valve of the at least one isolation pump is open.

15. The liquid supply system of claim 10, wherein each of the first isolation pump and the second isolation pump are pneumatically driven pumps.

16. The liquid supply system of claim 1, further comprising:
control circuitry configured to:
initiate a first transition from the supply state to the fill state based on status information generated by a first status sensor indicating a that a feed refill is required, the first status sensor associated with a feed reservoir of the feed module; and
initiate a second transition from the fill state to the supply state based on the status information indicating that the feed refill is complete.

17. An electrostatic spray system comprising:
the electrically grounded liquid source;
an electrostatic sprayer configured emit a charged liquid spray;
the liquid supply system of claim 1, configured to transfer liquid from the liquid source to the electrostatic spray gun to provide a continuous flow of liquid at the electrostatic spray gun.

18. (canceled)

19. A method of providing a continuous liquid supply for electrostatic spraying, the method comprising:
transitioning a liquid supply system from a supply state to a fill state based on a first signal generated by a status sensor associated with a feed reservoir of the feed module;
filling the feed reservoir with liquid from the liquid source;
transitioning from the fill state to the supply state based on a second signal generated by the status sensor;
providing liquid to the supply reservoir from the feed reservoir while in the supply state; and
providing charged liquid downstream from the supply reservoir both while in the fill state and the supply state
wherein transitioning from the supply state to the fill state includes:
generating a downstream air gap between the feed reservoir, and a supply reservoir of a supply module, thereby breaking a conduction path therebetween and stopping liquid flow therebetween; and
removing an upstream air gap between the feed reservoir and the grounded liquid source, forming a conduction path therebetween and allowing liquid flow therebetween; and
wherein transitioning from the fill state to the supply state includes:
generating the upstream air gap between the feed reservoir and the liquid source, thereby breaking the conduction path therebetween and stopping liquid flow therebetween; and
removing the downstream air gap between the feed reservoir and the supply reservoir, thereby forming a conduction path therebetween and allowing liquid flow therebetween.

20. The method of claim 19, wherein:
the step of removing the upstream air gap includes opening a supply valve of the feed module to allow liquid to flow into the feed reservoir from the liquid source; and
the step of generating the upstream air gap includes closing the supply valve;
the step of removing the downstream air gap includes opening a feed valve to allow liquid flow from the feed reservoir to the supply reservoir; and
the step of generating the downstream air gap includes closing the feed valve.

21. The method of claim 19, wherein the step of providing charged liquid downstream from the supply reservoir both while in the fill state and the supply state includes:
driving a first supply of charged liquid downstream with a first isolation pump while refilling a second isolation pump with a second supply of charged liquid;
driving the second supply of charged liquid downstream with the second isolation pump while refilling the first isolation pump.
